(19) United States
(12) Patent Application Publication
(10) Pub. No.: US 2024/0386197 A1
(43) Pub. Date: Nov. 21, 2024

(54) SYSTEM AND METHOD FOR ENHANCED MODEL INTERACTION INTEGRATION WITHIN A WEBSITE BUILDING SYSTEM

(71) Applicant: WIX.COM LTD., Tel Aviv (IL)

(72) Inventors: Meir Perez, Modi'in (IL); Yaara Asaf, Givatayim (IL); Yuval Nissan, Tel Aviv (IL); Oz Golan, Gan Yavne (IL); Eliahu Brosh, Ramat Hasharon (IL); Oded Haim Nachshon, Ramat Gan (IL); Batya Antebi, Tel Aviv (IL)

(21) Appl. No.: 18/665,423

(22) Filed: May 15, 2024

Related U.S. Application Data
(60) Provisional application No. 63/502,306, filed on May 15, 2023.

(51) Int. Cl. G06F 40/186; G06F 3/0482; G06F 3/0484; G06F 9/54

(52) U.S. Cl. CPC G06F 40/186; G06F 3/0482; G06F 3/0484; G06F 9/547

(57) ABSTRACT

Embodiments provide for integrating enhanced model interaction within a website building system. Models leveraged according to embodiments may include trained generative artificial intelligence models that are leveraged to customize structure and content within a website building system. Improved generation of composite prompts leads to improved generation of customized structure and content within the website building system.

### CROSS-REFERENCE TO RELATED APPLICATIONS

The present application claims priority to U.S. Provisional Application Ser. No. 63/502,306, titled “SYSTEM AND METHOD FOR INTELLIGENT WEBSITE CREATION AND EDITING,” filed May 15, 2023, the entire contents of which are incorporated herein by reference.

### TECHNOLOGICAL FIELD

The present application is directed generally to visual editing technologies and, more particularly, to a system, apparatus, method, and computer program product for enhanced integration of model interaction within a website building system.

### BACKGROUND

Various platforms may offer capabilities associated with generation of visual content. However, integrating model interaction with the generation of such visual content is computationally complex and unpredictable. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Embodiments relate to integrating enhanced model interaction within a website building system. Models leveraged according to embodiments may include trained generative artificial intelligence models that are leveraged to customize structure and content within a website building system. Improved generation of composite prompts leads to improved generation of customized structure and content within the website building system.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1 illustrates an example system architecture within which embodiments of the present disclosure may operate;

FIGS. 2A and 2B depict example operations associated with model interaction integration in accordance with some example embodiments described herein;

FIGS. 3A, 3B, 3C, 3D, 3E, and 3F depict example user interfaces associated with model interaction integration in accordance with some example embodiments described herein;

FIGS. 4A and 4B depict example operations associated with model interaction integration in accordance with some example embodiments described herein;

FIGS. 5A, 5B, 5C, 5D, and 5E depict example user interfaces associated with model interaction integration in accordance with some example embodiments described herein;

FIGS. 6A and 6B depict example operations associated with model interaction integration in accordance with some example embodiments described herein;

FIGS. 7A, 7B, 7C, 7D, 7E, 7F, 7G, 7H, 7I, 7J, and 7K depict example user interfaces associated with model interaction integration in accordance with some example embodiments described herein;

FIGS. 8A and 8B depict example operations associated with model interaction integration in accordance with some example embodiments described herein;

FIG. 9 illustrates an example system architecture within which embodiments of the present disclosure may operate;

FIGS. 10A and 10B depict example operations associated with model interaction integration in accordance with some example embodiments described herein;

FIG. 11 illustrates a block diagram of an example system that may be specially configured within which embodiments of the present disclosure may operate;

FIG. 12 illustrates a schematic block diagram of example components of an example website building system in accordance with some example embodiments described herein;

FIG. 13 illustrates a schematic block diagram of example repositories of an example content management system of website building system in accordance with some example embodiments described herein;

FIG. 14 is a schematic block diagram of example modules for use in an example server apparatus in accordance with some example embodiments described herein; and

FIG. 15 is a schematic block diagram of example modules for use in an example client apparatus in accordance with some example embodiments described herein.

### DETAILED DESCRIPTION

One or more example embodiments now will be more fully hereinafter described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments may be practiced without these specific details (and without applying to any particular networked environment or standard). It should be understood that some, but not all embodiments are shown and described herein. Indeed, the embodiments may be embodied in many different forms, and accordingly, this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

Example embodiments of the present disclosure may proceed to integrate model interaction in a number of ways. Accordingly, various processes in accordance with the present disclosure are described herein. Each method or process described herein may include any number of operational blocks defining the process and/or a portion thereof. It should be appreciated that in some embodiments the various processes and/or sub-processes described herein may be combined in any manner, such that the embodiment is configured to perform one or more aspects of the various processes in combination, in parallel and/or serially. In some embodiments, at least one additional and/or at least one alternative operation is performed in one or more of the described processes, and/or at least one operation is removed from one or more of the described processes.

Additionally, optional operations may be depicted in the processes utilizing dashed (or “broken”) lines. In this regard, it should be appreciated that the processes described herein are examples only and the scope of the disclosure is not limited to the exact operations depicted and described, and the depicted and described operations should not limit the scope and spirit of the embodiments described herein and covered in the appended claims.

### Overview

Embodiments herein are directed to integration of large language models (LLM) and/or generative artificial intelligence (AI) models or technologies into a website building system (WBS) platform. Integration of LLMs and generative AI models or technologies into various platforms is technologically challenging, including integrating such technologies into a WBS platform. Challenges associated with such integrations include prompt engineering-designing inputs for AI tools that will produce desired outputs. Embodiments herein provide advances in prompt engineering, which aid in fine-tuning a generic LLM or generative AI model for website (e.g., content and other structural components) creation.

Embodiments herein leverage a large corpus of data including historical website editing interactions associated with an editing user to generate prompt data objects for input to a trained model so that the trained model returns the desired output for the editing user with little or no refining interaction (e.g., subsequent, refined prompts) required on the part of the editing user. In doing so, embodiments herein create an case-of-use experience for an editing user while creating high-quality content for a website in less amount of time than would be required without the prompt generation described herein. Moreover, embodiments herein leverage the structural and other historical editing data, as well as end user (e.g., viewer) interaction data (e.g., which provide insights into the use and success of relevant website layouts and designs), to intelligently generate multi-component prompts.

Embodiments herein employ data minimization so that prohibitive levels of data do not cause bottlenecks when training the models used herein.

Embodiments herein overcome drawbacks associated with manual or existing website building technologies by providing for instant, automated mapping between an existing or old website building component or structure (e.g., layout, spacing, text constraints) and a new website building component or structure, even if the old and new structures are not identical or even substantially similar. Such features eliminate the need for manual content migration and decision making, saving computing and other resources. For example, migrating content from an existing website building component or structure having a first format or first structural constraints to a new website building component or structure having a second format or second structural constraints may require manual or, even if automated, multiple digital interactions with the content and the components to make sure the content renders properly in the new component according to the second format or second structural constraints. Such interactions may include deletions, resizing, and the like. Embodiments herein eliminate such iterations of interactions and wasting of computing and other resources.

Embodiments herein further integrate interaction with generative AI models or technologies during the process of building a website using a WBS such that an editing user can be interactively guided while making changes to a website's structure and content. The interactive guiding process involves the generative AI model continuing to adapt and create in response to interactions with the editing user in real-time. In some examples, interactive guidance may include fully personalized assistance provided to an editing user, tailored to their specific content. The interactive guidance is dynamically generated.

Embodiments herein leverage generative AI models (and other AI models) to streamline for an editing user the process of experimenting with various layouts, designs, or website building components by reducing the time it takes for an editing user to generate, review, and decide to incorporate a new component into a website. That is, the editing user may want to sample how a component or structure would render with existing content of the website; embodiments herein provide for fast, seamless opportunities for such sampling.

Embodiments herein provide for a resulting website that is unique and customized specifically for an editing user, leveraging generative AI models (and other models) to quickly sift through a large number of permutations (that would not otherwise be brute-force or manually viewable in a reasonable amount of time such that the editing user's content would still remain relevant, fresh, or viable) and provide a focused, tailored, online presence.

Embodiments herein provide for a WBS with structures that are not tied to particular categories (e.g., business types), leading to greater flexibility in the design of a website using the WBS. This reduces the number of predefined components (e.g., sections) to a few classes, eliminating the need for extensive mapping to specific categories (e.g., business types).

Embodiments herein integrate a generative AI-powered engine for generation and curation of content for inclusion in websites assembled using the WBS herein. The integration of such an engine provides for the aforementioned improvements as well as eliminates the need for time-consuming content curation and processing tasks.

### Example Architecture and Embodiments

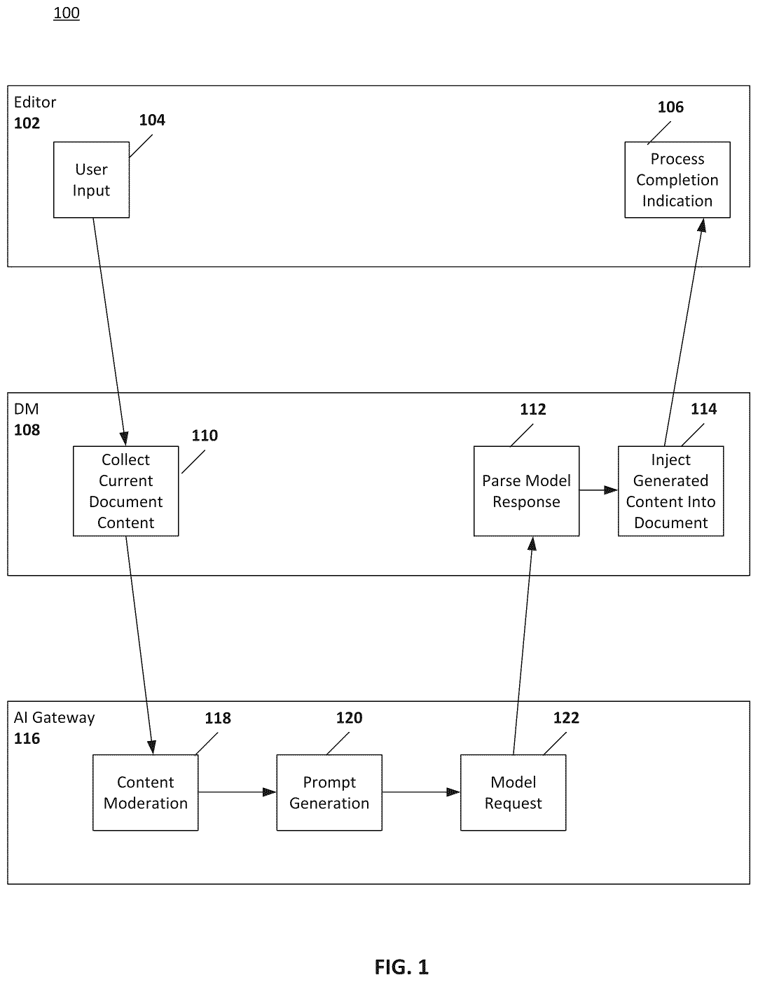

FIG. 1 illustrates an example system architecture 100 within which embodiments of the present disclosure may operate. In FIG. 1, an editor 102 of a website building system (WBS) is renderable to enable visual interaction with a client computing entity accessed by an editing user associated with an editing user identifier. The editor 102 is renderable such that the editing user may interact with various components (e.g., screens, panels, interface elements, and the like) associated with a website building system. In some embodiments, the editor 102 is accessible via a browser, or is an application or app executable via the client computing entity. The editor 102 includes one or more interface elements 104 for receiving user input from the editing user. The user input may include details about a new or existing website, such as business name, business type and free text (such as natural language input) describing the site.

Also shown in FIG. 1, system architecture 100 includes an editor infrastructure referred to as a document management (DM) component 108. The DM component 108 is a client component that loads with the editor 102 and is a component where content of a website being assembled using the WBS is stored. The DM component 108 is configured to create an outline 110 or map data structure (e.g., collect current document content and generate an outline or mapping based on the same) of a website or a website building component (e.g., a template), and the outline or map data structure may be used as part of a prompt data object. The outline comprises the content of the website or website building component, after cleanup and heuristics have been applied. That is, the outline or map data structure includes a map of a template's structure (e.g., logical positionings of text elements, images, buttons, other components of the template, and the like) and temporary content and/or a map of a website's structure. The map data structure may comprise a name (or other ID) of one or more sections or components of the template or website and well as current values (e.g., also referred to as “temporary content,” content currently in sections of the template). Component or sections of templates or one or more websites of the WBS may be associated with a natural language description of the purpose of the component as part of the corresponding template or website. In the case of a website, pages (or other subunit) of the website may also be associated with a natural language description of the purpose (or other aspect(s)) of the webpage.

Also shown in FIG. 1, system architecture 100 includes an AI gateway 116 (e.g., which may or may not be serverless) that generates and stores prompts in the back end and can send requests to an AI engine vendor (not shown). The AI gateway 116 may also provide content moderation 118 by scanning inputs and removing prohibited content (e.g., offensive or other defined prohibited types of content). The AI gateway may also provide prompt generation 120 by generating prompts (e.g., prompt data objects) based on data gathered from the user inputs as well as the outline or map data structure generated 110 using the DM component 108.

The AI gateway 116 may send the generated prompts to an AI system (e.g., send requests to a model) 122, along with predefined (or configurable or learned) parameters required for the request associated with the generated prompts. Examples of such parameters include a maximum number of tokens, temperature (i.e., a degree of randomness in token selection), format, and others.

In some embodiments, in addition to or as part of the generated prompts, one or more template options or website options are provided as input to the AI system (e.g., an LLM or other trained model), including the template, the sections (or components) of the template, website options, and a natural language description of sections (e.g., a purpose of the section, what the section describes or represents, or the like) or as an option or as another parameter. In some embodiments, the natural language description of sections or options can be generated manually or using machine learning (e.g., possibly using a separate model). In some embodiments, the options (e.g., templates, webpages, and sections/section descriptions) are input to a model as part of the generated prompts, along with a natural language name and type of business associated with the intended website being assembled using the WBS and the template (where applicable).

Shown in FIG. 1, the DM component 108 may receive and parse 112 a response from the AI model or service that was generated based on the provided prompt and request. The DM component 108 may receive the response from the AI model or service as a string, and then validate and clean the response before it can be further used for the website creation or editing process.

In some embodiments where a template is being personalized, the response from the AI model may be an output map data structure (e.g., another outline) and/or other electronic structure/file (e.g., a JSON) with the same format as the input map data structure that was generated based on the initial template—the AI model returns the output in the same format because part of the generated prompts included instructions to return output in the same format.

In some embodiments, a quality assurance sequence of operations may be employed to confirm the output from the model is valid and approved. Such operations may serve to check the output map data structure, sanitize it, and/or update it based on heuristics or a (potentially separate) QA AI model. The operations may include (1) verifying that the output map data structure is in the correct requested format (e.g., in the event that the AI model returns an output map data structure or JSON that is invalid or in an incorrect format); (2) verifying that the relevant input fields in the input map data structure are present in the output map data structure (e.g., in the event that the AI model returns an output map data structure with changed format that eliminates one or more fields); (3) verifying that values (e.g., content in sections of the template as a result of the output map data structure) are not considerably longer than those that were previously in the template (e.g., the generated prompts instruct the AI model to maintain output content for sections of the template at roughly the same length as the input content, but in some instances the AI model returns larger strings; in such cases, different content may be applied to one or more fields/sections of the output map data structure or output template). A substantially smaller string may also be undesirable, and may be similarly handled.

Another quality assurance operation may include reattempting a request (e.g., resubmitting generated prompts and some or all of the data included above as inputs to the AI model) or part of a request. In some embodiments, a request may be modified (e.g., prompts, descriptions, etc.) based on a review of the output map data structure and content, or may include instructions directing the AI model to generate response which is different than the previous response (e.g., in its entirety, or for specific areas in the response).

In some embodiments, the output map data structure is used to map generated content to components/fields of the template so that the template can be updated with the generated content. That is, the temporary content in the template is replaced with content generated by the AI model according to the prompts/request.

In some embodiments, the output map data structure is used to map generated content to various components/pages of a website.

The generated content can include text and/or images. For an image field, a first prompt may build a textual description for one or more images, and then an API call to an image generation service may be created and transmitted for the image field—the textual description resulting from the first prompt is the input for the API call so that an appropriate or desired image is returned as a result of the API call.

For example, shown in FIG. 1, the DM component 108 may inject 114 content generated based on the output or response from the AI model into the desired website building component (e.g., template, section, or the like).

Subsequently, an indication of a completion of the process 106 is rendered via the editor 102 for the editing user to observe via a display device. That is, the updated website building component (e.g., template) or website is rendered via a user interface via the display device for observation by the editing user.

To generate the prompts described above and herein, data associated with a user profile (e.g., a profile of an editing user) may be used to personalize the outcome, such as basic parameters (geography, time using the system, expertise level, other sites created by the editing user, etc.), suggested personality traits of the editing user, its users-of-user (UoU) traits, interactions of a WBS vendor support team with the user, statistics associated with how the editing user creates and/or edits her websites, user status (anonymous, guest, registered, premium, . . . ), user profile/attributes such as age, gender, e-mail or domain, the geographical location of the editing user (as detected via IP address, GPS etc.), the system use history for the editing user (e.g., editing user registered for over X years, users used advanced feature X, user logged in more than X times last month, . . . ), environmental parameters of the user (e.g., browser, operating system etc.), website related parameters (e.g., websites having >X pages, website using specific templates, pages which have another component Y beside the tested component Y), specific website hints as well as third party application (TPA)/AppStore related parameters (e.g., limit to new third party application purchasers, limit to existing third party application users, purchase history, installed third party applications, method used to locate a third party application in AppStore). As described herein, the system may use the actual user profile information, or use condition(s) based on the user profile information so as to provide a preliminary classification (e.g., divide the users into novice or experienced classes based on period of system use).

Working with existing generative AI (GAI) engines, a typical use case involves providing a prompt to the GAI engine and receiving a single text response or image from the GAI engine (where the GAI engine generated the response based on or in response to the prompt). Embodiments herein overcome challenges associated with, and improve upon, generation of prompts for GAI engines by generating a composite prompt. A composite prompt may include multiple prompts, where prompts of the multiple prompts may be for one or more components, directives, template elements, additional component information, and more.

Embodiments herein train a GAI engine using training data adapted to a format used in later or subsequent query prompts. The system may apply such training to an external AI engine or to a layered internal AI engine based on a pre-trained foundation model. Thus, for example, a prompt generation module may provide information related to the structure of a webpage (e.g., “generate a text for a text component of ‘product description’ based on X Y Z, and this text component is part of the ‘outdoor recreation’ section of the website.”). The AI engine (e.g., GAI engine) takes notice of the provided information-both during training and later during result generation—and provides better responses than had a sequence of individual prompts been employed.

Moreover, typical GAI engine use cases are based on providing human-readable text to the AI engine-both during training and when generating the prompts. Various embodiments of the present disclosure eliminate such constraints and use additional or alternative data formats. For example, various embodiments of the present disclosure may provide data (for training or prompts): (1) which uses a format more oriented toward data description (such as XML, JSON, or YAML), (2) which uses sections of WBS internal representation of the pages' component hierarchy, and/or (3) which includes the transformation of the data into a different format.

As described herein, various embodiments of the present disclosure use GAI engines to generate text (and other) content for insertion into WBS templates and components. However, unlike conventional use of GAI text engines, in the case of generating content for WBS applications, it is highly beneficial to generate text whose size matches the space available in the relevant template component area. Various embodiments of the present disclosure resolve this by providing the GAI engine with a limit on the number of words or characters to generate. Such a limit may be calculated based on the size of the target component. That is, various embodiments account for such constraints when generating prompts to provide to a GAI engine.

In some instances, however, a GAI engine may not be able to compensate or account for different character widths in different fonts, as it may not have the full text rendering information. In these cases, embodiments herein advantageously may generate prompts such that multiple alternatives (at different lengths limits)—sequentially or in parallel-result.

Various embodiments of the present disclosure may also offer the editing user to regenerate the text content of a specific component if the component has been resized substantially due to dynamic layout or responsive editing. This regeneration is achieved using a prompt based on the current text (“rephrase the text XYZ for the template slot A in X words or less”). Such AI-based rephrasing may be used in addition to various techniques used in dynamic layout-based editing.

Various embodiments of the present disclosure use expanded prompt generation to create multi-component prompts to provide to a GAI engine. In such examples, the order of the components' descriptions within the prompt may be significant for the generated output. That is, for better output, the order of descriptions of components may be an important factor. This may be important, for example, if the components contain multiple parts which together form a sequence or continuum (e.g., rather than a list of unrelated elements). In some examples, the use of internal component order may be appropriate, and such internal order may also reflect the generated document object model (“DOM”) order. However, for some embodiments, the order in which the components are stored inside the WBS's database/repository(ies) may not be the correct order to use. This is because the order in which the components are stored may be random or based on the order in which the components were created and could be unrelated to the logical order (also known as reading order).

Various embodiments of the present disclosure may overcome the aforementioned challenges by using a logical ordering determiner. Such an ordering determiner (also referred to as an orderer) may review the definition (and possibly the existing content) in the template or other component set and determine a logical order. Such ordering may be determined based on the component properties stored in the WBS database (and without rendering). Alternatively, the system may perform server-side rendering or other headless rendering to create a DOM structure that can be evaluated to determine the logical component order (which may be different from the DOM order itself).

For example, in various embodiments, an environment within which embodiments herein operate may be front-end (e.g., in client-side rendering), back-end (e.g., in server-side rendering), or a combination thereof. One or more website interface rendering modules may form part of server-side software executed by a server. While various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

In various embodiments, the environment may be a browser window, thread, or any server-side technology used to one or more parts of a web page. In a further example, it is contemplated by this disclosure that some or all of the functionality of website interface rendering may optionally be performed by a client-side software application running on one or more client devices and the disclosure is not limited to the specifically identified arrangement of software executed herein. For example, when rendering on the server-side, an environment may be operating on the device, platform, or software used for rendering the page content (HTML, CSS or otherwise) to be sent to the browser (or another user agent). Moreover, in some embodiments, a server providing one or more execution environments may be performed on a separate server.

Example Operations Associated with Model Powered Template Adaptation

Embodiments herein relate to leveraging a trained ML model (e.g., a trained generative AI (GAI) model) to adapt a website building component, such as a template, to a specific website editing user. Editing users are able to browse (e.g., rendered via a graphical user interface) a catalog (e.g., a visually rendered plurality) of website building components (templates) available from the WBS and start creating a website from one of those website building components (e.g., templates). In some embodiments, a template constitutes a full website (e.g., comprising one or more webpages and multiple website building components) built by a designer (e.g., a third-party user other than the website editing user), including placeholder designs and placeholder content (e.g., representing a company that does not actually exist; also referred to herein as “temporary content”). After selecting a website editing component (e.g., a template), the editing user usually must proceed through a lengthy process of replacing some or all of the temporary or placeholder content of the website building component (e.g., template) to fit her own need (e.g., business), which includes generation of content (and generation of content may be difficult, tedious, and/or time consuming for the editing user to do on her own).

Embodiments herein solve for the aforementioned challenges of content creation and template adaptation by generating content and completing sections of a template based on minimal natural language input provided by the user. That is, in a first stage, as soon as a new website is opened from a template, the editing user is prompted for additional information, such as a business name and business type (e.g., also referred to herein as content selections), and the user is prompted to enter text (such as natural language that describes the business and what is unique about it). It will be appreciated that information from or about the editing user can also be gathered based on previous website editing sessions and/or previous website editing interactions performed by the editing user as well as other places in the user registration or the site creation funnel, or from interactions the user may have had as a website viewer (rather than a creator).

Embodiments herein then generate and replace some or all of the temporary or placeholder content on a website building component (e.g., via the template) (such as text, images, video content, fonts, colors, etc.) with content that matches the natural language description. The end result is a website or website building component with customized content for the editing user as opposed to a website or website building component with default content (which may include boilerplate elements such as “Lorem Ipsum” text or stock images or videos).

Embodiments herein achieve the aforementioned objectives by leveraging existing content of a website under assembly to train a GAI engine to understand the role of content fields. That is, fields of a website building component may be associated with a field description, which may be a natural language description of the purpose of the field (or of sets of fields). The fields and corresponding field descriptions are provided to the GAI engine. As a result, the trained GAI engine can generate the appropriate requested content according to the content field roles and description in the same format as a selected template. In this manner, the content changes, but the overall layout does not. The system may still perform localized layout changes due to differences between the size of various injected content (e.g., text length) based on technologies involving dynamic layout or responsive editing. The trained GAI engine can also decide how to break content across multiple fields to tell a single story, which is also learned from the original template.

It will be appreciated that, while the description herein makes reference to the creation of a full website (and the relevant templates), embodiments herein are applicable for the creation of a partial website, website building components, sections of a website, pages, sections of pages, the creation of a set of websites (coordinated with each other or not), without limitation and without departing from the scope of the present disclosure.

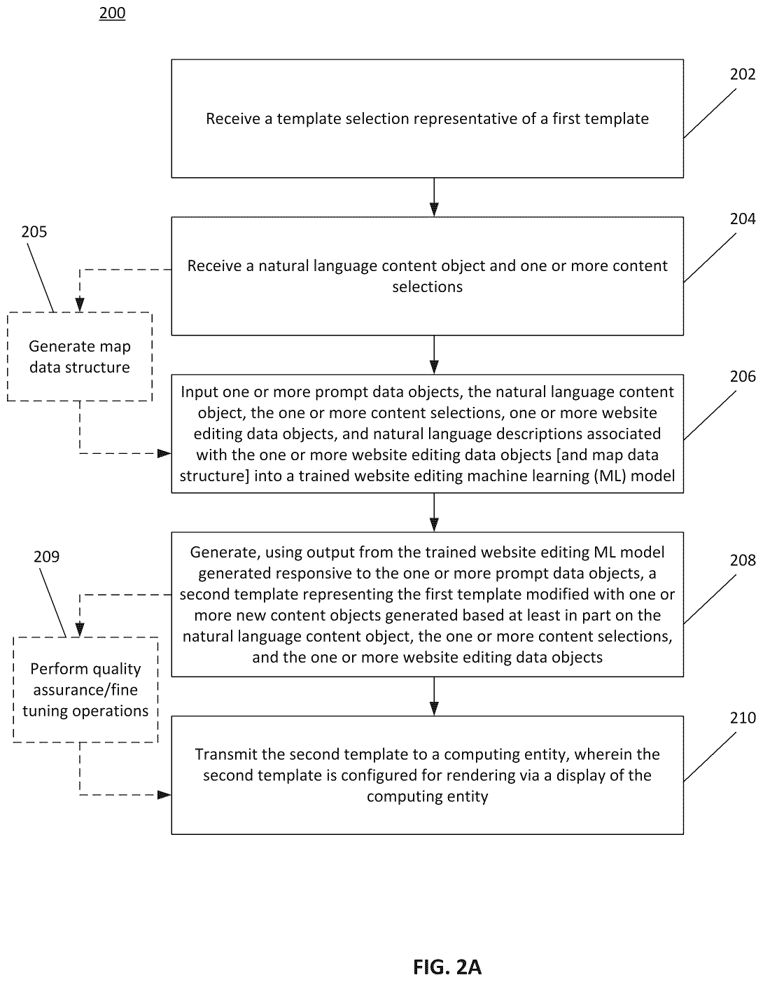

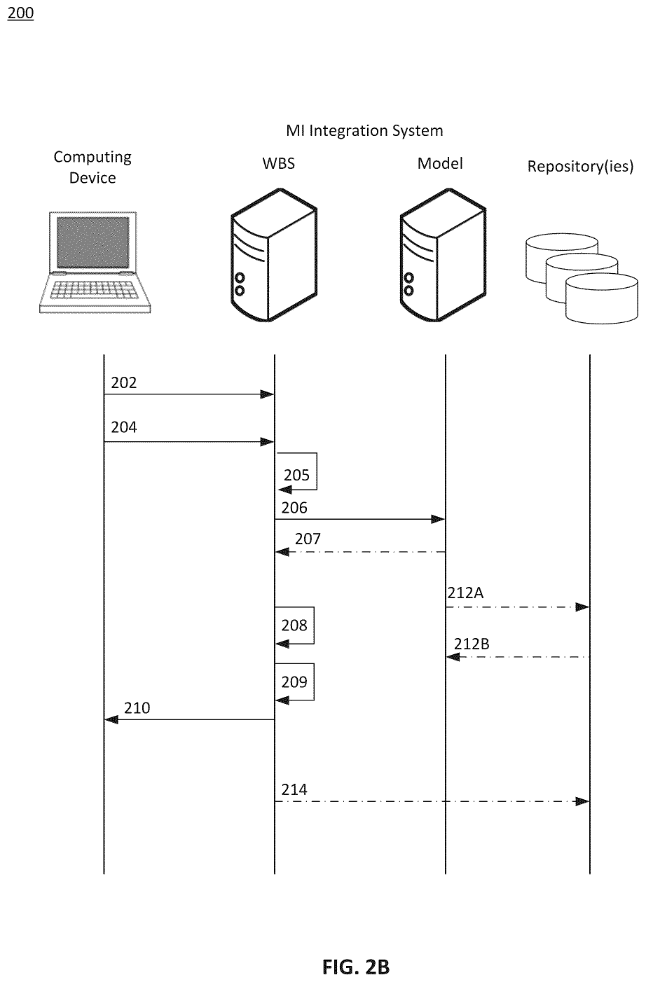

FIGS. 2A and 2B depict example operations associated with model interaction integration in accordance with some example embodiments described herein. The operations illustrated in FIGS. 2A and 2B may, for example, by performed by an MI integration server 1812, which may include means, such as memory 2102, processor 2104, input/output module 2106, communications module 2108, MI integration module 2110, and/or the like, which are collectively configured for model interaction integration. The operations may further be performed by one or more client devices 1808A-N, which may include means, such as memory 2202, processor 2204, input/output module 2206, communications module 2208, and/or the like.

In some embodiments, shown in FIGS. 2A and 2B, at step/operation 202, the process 200 includes receiving a template selection representative of a first template. The template selection may be received via a template selection interface element that is integrated into a website building system. The website building system may be accessed using a client computing entity associated with an editing user identifier.

In some embodiments, shown in FIGS. 2A and 2B, at step/operation 204, the process 200 includes receiving a natural language content object (e.g., a description of what the editing user would like for content, a description of what is unique about the business or purpose of the template or website under assembly by the editing user using the WBS) and one or more content selections (e.g., a business name and a business type). The natural language content object and one or more content selections may be received via one or more model interaction (MI) interface elements integrated into the website building system. The website building system may be accessed using a client computing entity associated with an editing user identifier. The one or more content selections may be provided by way of selections of options from drop down menu elements, via free text input fields (e.g., for receiving natural language input), or a combination of such input mechanisms. The natural language content object may be received via one or more free text input fields. The natural language content object may be processed prior to being included with one or more prompt data objects. The one or more MI interface elements may comprise an overlay, a frame, or a pop-up interface element.

In some embodiments, at step/operation 203, the process 200 includes generating an outline or map data structure of a website building component (e.g., a template), and the outline or map data structure may be used as part of or in addition to a prompt data object. The outline or map data structure includes a map of the template's structure (e.g., logical positionings of paragraphs, buttons, other components of the template, and the like) and temporary content. The map data structure may comprise names of sections or components of the template and current values of sections (e.g., also referred to as “temporary content,” content currently in sections of the template). In some embodiments, the outline or map data structure does not contain anything other than content (no layout, styles, and so forth) but maintains the logical positioning of components of the template. This is accomplished by creating the map data structure with the names of sections, and in a key per content field, with the current value (e.g., temporary content) after some cleaning.

One or more components or sections of the template may be associated with a natural language description of the purpose of the component as part of the corresponding template. In some embodiments, the fields or sections of a template as well as the descriptions of the fields or sections are input as part of or in addition to one or more prompt data objects to a trained website editing machine learning (ML) model.

In some embodiments, shown in FIGS. 2A and 2B, at step/operation 206, the process 200 includes inputting, to a trained website editing machine learning (ML) model (e.g., a GAI model), one or more prompt data objects, the natural language content object, the one or more content selections, fields or sections of the template, and descriptions of the fields or sections of the template. The one or more prompt data objects may be generated as described herein based on inputs received from the editing user, user profile information associated with the editing user, known structural data associated with the website, template, and/or components of the website, one or more website editing data objects associated with one or more websites assembled using one or more website building repositories of the WBS, and the like.

In some embodiments, the map data structure generated in step 205 is also input to the trained website editing ML model in addition to or as part of the one or more prompt data objects. The one or more prompt data objects signal to the trained website editing ML model (e.g., GAI model) what the format of the map data structure is, what to do with the fields, and provide examples. Without the present innovations, such a prompt would require several iterations to create and perfect.

In some embodiments, the trained website editing ML model comprises one or more of a large language model (LLM) or generative AI (GAI) model and trained using one or more of a corpus of website editing data (e.g., including websites built using the WBS) or a corpus of historical website editing interaction data associated with a plurality of editing user identifiers (as well as data from other sources as mentioned above).

In some embodiments, shown in FIGS. 2A and 2B, at step/operation 208, the process 200 includes generating, using output (e.g., an output map data structure and new content) received (207) from the trained website editing ML model, a second template representing the first template modified with one or more new content objects. The output from the trained website editing ML model is generated responsive to the one or more prompt data objects and other input provided as part of or in addition to the one or more prompt data objects. The output from the trained website editing ML model may be in the form of an outline or output map data structure and/or a JSON in the same format as the outline or input map data structure that was provided with the one or more prompt data objects.

In some embodiments, the process 200 includes performing 209 quality assurance or fine-tuning operations as described above.

In some embodiments, content can be images as well. For those fields the first prompt will build a textual description for the images. A second API call to an image generation service (e.g., or an image or other search service) will be sent per image field where the prompt that returned from the first call is the input for the image generation call.

In some embodiments, shown in FIGS. 2A and 2B, at step/operation 210, the process 200 includes transmitting the second template to the client computing entity. The second template is configured for rendering via a display device of the client computing entity. The second template represents the selected template with the temporary content replaced with content output by the trained website editing ML model.

In embodiments, data associated with the interactions between the editing user and the WBS are stored 214 in one or more repositories. Further, the trained website editing ML model may be initially trained and continuously retrained using data retrieved (212A, 212B) from the one or more repositories.

While embodiments herein are described with reference to receiving the natural language content object and the one or more content selections from a client computing entity, the natural language content object and the one or more content selections may be received via an application programming interface (API).

The following example shows a typical payload created to be sent or provided to the GAI engine. The items below may be sent whether at once, or in a dialog-like manner to the engine. It will be appreciated that all of the items may be sent, but in some instances not all of the items below are sent.

An example prompt (using a GAI model API):
system: You are a creative writer that writes website content for a specific business type and fits text content into a JSON format. \nThe input will include a business name, business type, additional information and an outline JSON. The outline JSON contains keys with names of sections in a page, and each section contains keys of content for that page that are either titles, paragraphs or button fields. The values are either an example of a content that could fit the field, or a description of what the field could contain which starts with \ “I'm a paragraph\”, which should be replaced. \n You will go over each string value of the outline JSON and replace it with a text that fits the business type and business name where necessary. The text should attempt to capture as much of the additional information as possible within the limits of the space given. \n You should not leave any obviously placeholder content such as \ “Edit me\”, \ “I'm a paragraph\” and such. \nThe output should be a JSON in an identical structure to the input outline JSON. All keys need to remain as is, only the values of content properties should be changed to apply to the input business name, business type and additional information. Keep the length of texts per content field as close to the original text as possible, but avoid reusing the same text.\nContent that is UPPER CASE should remain UPPER CASE and overall content length should be similar to the example provided. \nDo not mix up paragraphs with titles.
example user input: business name-Old Records
business type-Music Store
additional information—At Old Records, we sell unique albums that are found nowhere else.
outline-<an example outline>
example assistant response: <a response outline matching the example>

An example outline that is mentioned above has the following form:

```
{
  “outline”: {
    “intro”: {
      “title”: “Maya\nNelson”,
      “title_2”: “PROJECT MANAGER”,
      “title_3”: “Hello”,
      “title_4”: “Here&#39;s who I am&nbsp;&amp; what I do”,
      “button”: “RESUME”,
      “button_2”: “PROJECTS”,
      “paragraph”: “I&#39;m a paragraph. Click here to add your own text and edit me.
It&rsquo;s easy. Just click &ldquo;Edit Text&rdquo; or double click me to add your own content
and make changes to the font. \n\n&nbsp;\n\nI&rsquo;m a great place for you to tell a story and
let your users know a little more about you.”
    },
    “header”: {
      “title_5”: “Maya&nbsp;Nelson”,
      “title_6”: “PROJECT MANAGER”
    “footer”: {
    },
      “title_7”: “ © 2035 by Maya Nelson. \nPowered and secured by Wix”,
      “title_8”: “Call”,
      “title_9”: “123-456-7890”,
      “title_10”: “Write”,
      “title_11”: “info@mysite.com”,
      “title_12”: “Follow”
    }
  },
  “idMap”: {
    “title”: “comp-k0med568”,
    “title_2”: “comp-k0med56k”,
    “title_3”: “comp-k0med55k”,
    “title_4”: “comp-k0mefjfr”,
    “button”: “comp-k0med55p”,
    “button_2”: “comp-k0med55t”,
    “paragraph”: “comp-k0med55w”,
    “intro”: “comp-lhnpge36”,
    “title_5”: “comp-k0kr12fe”,
    “title_6”: “comp-k0kr2gq3”,
    “header”: “SITE_HEADER”,
    “title_7”: “comp-k2398tck”,
    “title_8”: “comp-k0kuqn3x”,
    “title_9”: “comp-k0kupecu”,
    “title_10”: “comp-k0kuuwv2”,
    “title_11”: “comp-k0kuuwvk”,
    “title_12”: “comp-k0kuvsds”,
    “footer”: “SITE_FOOTER”
  }
}
```

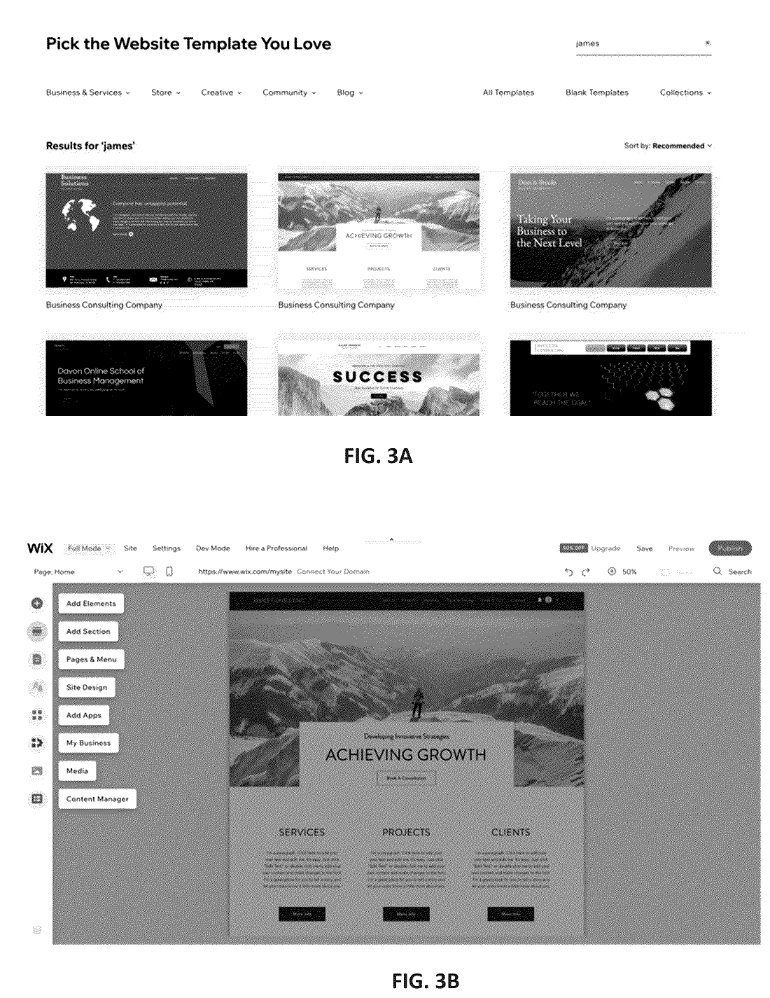

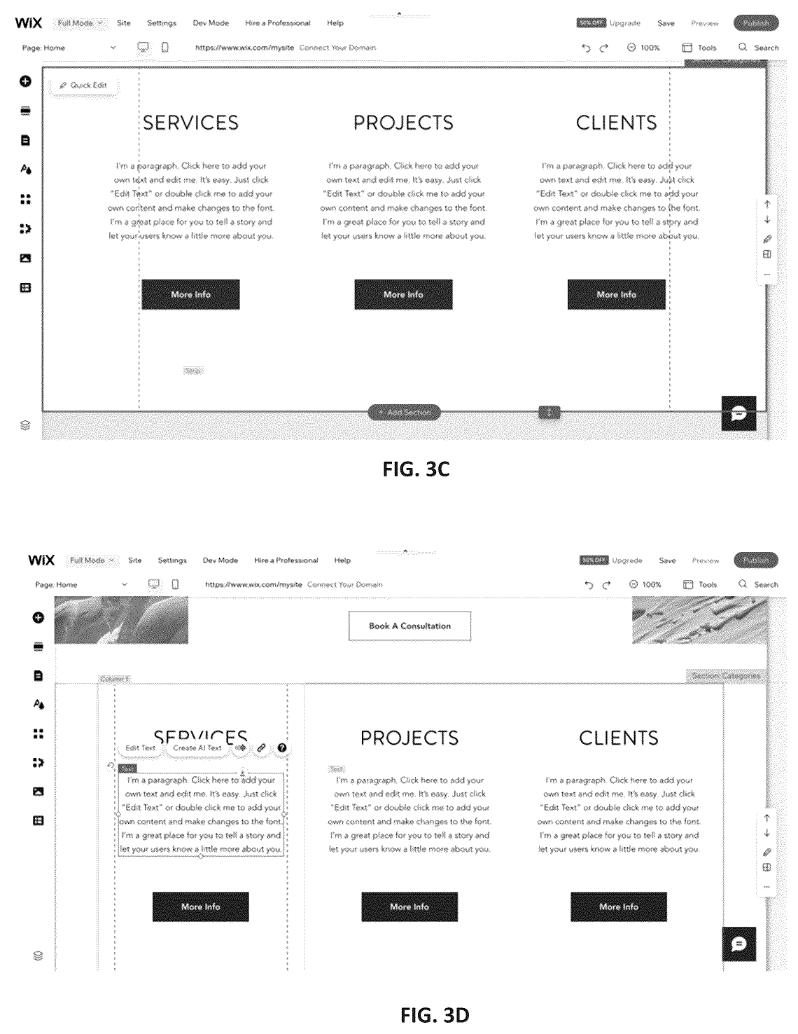

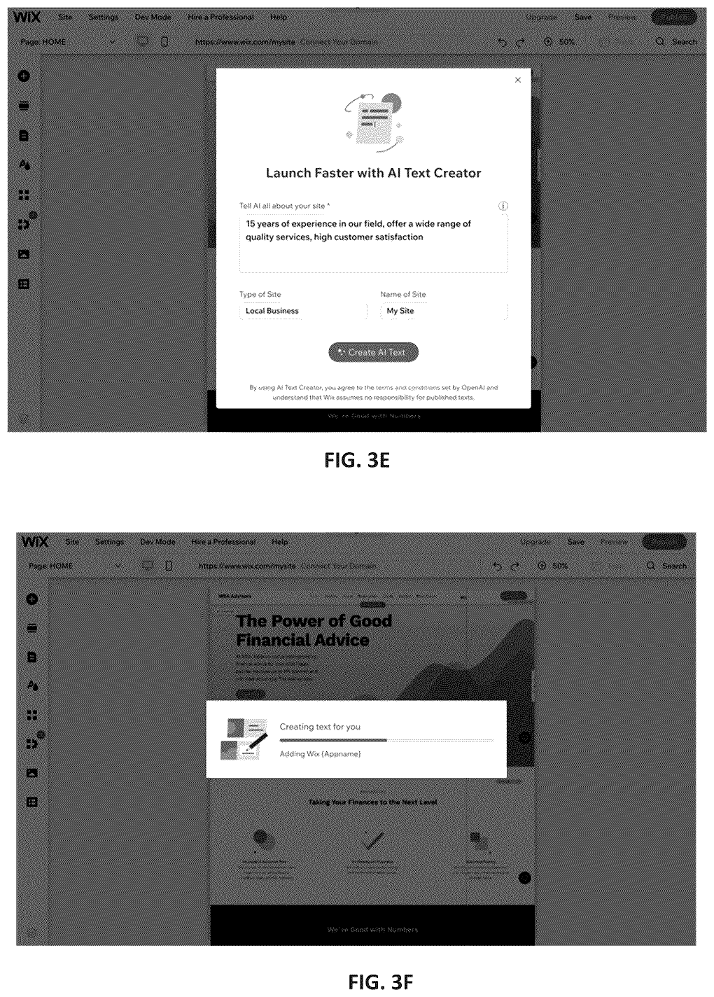

FIGS. 3A, 3B, 3C, 3D, 3E, and 3F depict example user interfaces associated with model interaction integration in accordance with some example embodiments described herein.

FIG. 3A depicts an example user interface whereby several templates are rendered and available for selection by an editing user for a website the editing user is assembling using the WBS. FIG. 3B depicts an example user interface whereby the editing user has selected, via interacting with the user interface, a template for possible inclusion in the website. FIG. 3C depicts an example user interface whereby the editing user is editing the template. FIG. 3D depicts an example user interface whereby the editing user is editing a text section within the template. An interface element in FIG. 3D with the display text of “Create AI Text” is selectable by the editing user. FIG. 3E depicts an example user interface that is presented after the editing user has selected the interface element “Create AI Text” to access a model to generate content for inclusion in the template. Shown in FIG. 3E, the editing user may provide a natural language data object by typing natural language into a text input field (“Tell AI all about your site”), and may provide one or more content selections (e.g., “Type of Site” and “Name of Site”). FIG. 3F depicts an example user interface where the editing user is informed that the AI model is generating content using the specified parameters, which occurs as a result of the editing user having selected “Create AI Text” as shown in FIG. 3E. Subsequently, a new template is created using the output from the AI model/engine. It will be appreciated that, while the example user interfaces depicted in FIGS. 3A-3F may display an option to “Create AI Text” for a single field, embodiments herein encompass displaying an option to “Create AI Text” for one or more fields of a template using the input from the editing user as well as the structure of the selected template as described above.

Advantages provided by the presently described model-powered template (e.g., or other website building component) adaptation include faster creation of text or other content for inclusion in websites, elimination of special tagging or preparation of a template before applying AI to generate the content or text, faster creation of a final website, among others.

Example Operations Associated with Model Powered Website Customization

Embodiments herein relate to leveraging a trained ML model (e.g., trained GAI model) to customize a website specific to an editing user. While some editing users prefer to begin the process of assembling an entire website using a WBS visual editor, including browsing a catalog of options to find something to their liking, others may prefer a guided approach where the editing user is presented with questions and options. Based on the answers to the questions and options, embodiments herein leverage a trained ML model to generate a unique customized website for the editing user. Model-powered website customization may involve similar operations as described with respect to model-powered template adaptation, although the editing user does not select a template in advance.

In embodiments, an editing user is prompted to provide one or more content selections (e.g., a business name, business type) and a natural language description (e.g., a free text description of the business), but the editing user is not prompted to nor required to select a template. Based on the minimal input from the editing user, and other known data as described above and herein, a fully customized website, including structure, themes, and content, is generated in stages.

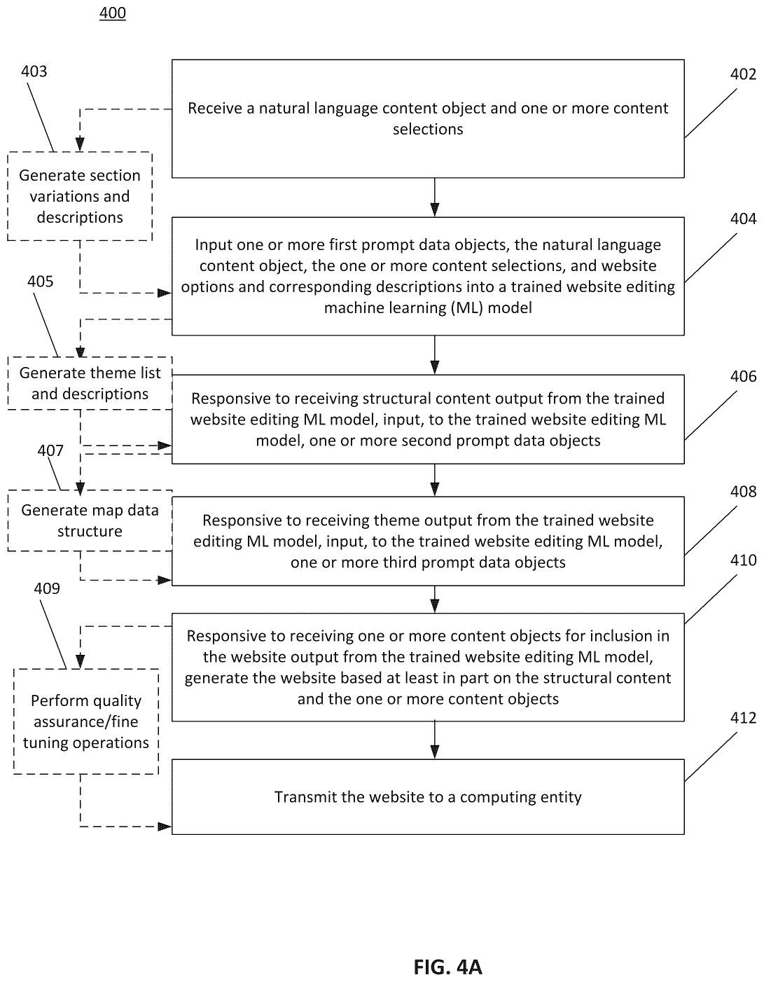

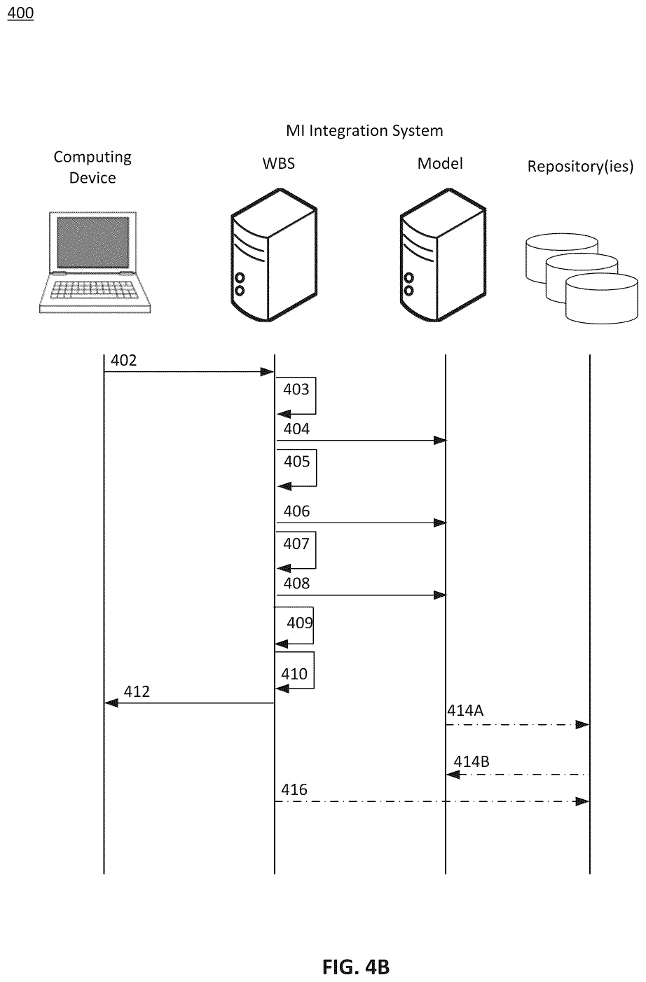

FIGS. 4A and 4B depict example operations associated with model interaction integration in accordance with some example embodiments described herein. The operations illustrated in FIGS. 4A and 4B may, for example, be performed by an MI integration server 1812, which may include means, such as memory 2102, processor 2104, input/output module 2106, communications module 2108, MI integration module 2110, and/or the like, which are collectively configured for model interaction integration. The operations may further be performed by one or more client devices 1808A-N, which may include means, such as memory 2202, processor 2204, input/output module 2206, communications module 2208, and/or the like.

In some embodiments, shown in FIGS. 4A and 4B, at step/operation 402, the process 400 includes receiving a natural language content object and one or more content selections. The natural language content object and the one or more content selections may be received via one or more model interaction (MI) interface elements integrated into the WBS. The WBS may be accessed using a client computing entity associated with an editing user identifier. The one or more MI interface elements may include input fields or menus as described above.

In some embodiments, at step/operation 403 (which may or may not be performed in a specific order relative to the other operations of process 400), several variations of sections are generated (e.g., a combination of sections may be a webpage, and a combination of webpages may be a website). The variations of the sections may be pre-built or generated on the fly. The section may be associated with a section description, which may be a natural language description of the section and the purpose of or benefits associated with the section. The section may have a different layout that may be appropriate for different types of content or subjects. The technical benefit of transforming sections into natural language descriptions is a GAI model or LLM can be used to generate a website despite only being able to recognize language and not the format of the section.

In some embodiments, shown in FIGS. 4A and 4B, at step/operation 404, the process 400 includes inputting, to a trained website editing machine learning (ML) model, one or more first prompt data objects, the natural language content object, and the one or more content selections. The input to the trained website editing ML model may also include a list of available sections and their corresponding section descriptions, either as part of or in addition to the first prompt data objects. The trained website editing ML model is configured to output, responsive to the one or more first prompt data objects, structural content for inclusion in a website under assembly using the website building system. For example, the trained website editing ML model is configured to output a list of sections appropriate for webpages of the website to be assembled.

In some embodiments, at step/operation 405 (which may or may not be performed in a specific order relative to the other operations of process 400), a list of themes is compiled, along with natural language descriptions (theme descriptions) of when a theme should be used. The list of themes can be pre-built or built on the fly. A theme is a collection of colors, fonts, and other style values that can be applied on every or most websites assembled using the WBS and completely (or somewhat, in certain instances) change the look and feel of a website.

In some embodiments, shown in FIGS. 4A and 4B, at step/operation 406, the process 400 includes, responsive to receiving the structural content, inputting, to a trained website editing machine learning (ML) model, one or more second prompt data objects, the natural language content object, and the one or more content selections. The input to the trained website editing ML model may also include the list of one or more available themes and their corresponding theme descriptions, either as part of or in addition to the second prompt data objects. The trained website editing ML model is configured to output, responsive to the one or more second prompt data objects, theme content for inclusion in the website under assembly. That is, with the structure and layout set (according to the structural content output from the trained website editing ML model in operation 404), the trained website editing ML model is configured to output a theme that is most appropriate for the website.

In some embodiments, shown in FIGS. 4A and 4B, at step/operation 408, the process 400 includes, responsive to receiving the theme content, inputting, to a trained website editing machine learning (ML) model, one or more third prompt data objects. The input to the trained website editing ML model may include a map data structure (generated at step/operation 407) defining the structure of the website and may also include components of the website and their corresponding natural language descriptions (e.g., similar to the process described with reference to FIGS. 1, 2A, and 2B). The trained website editing ML model is configured to output 409, responsive to the one or more third prompt data objects, one or more content objects for inclusion in the website under assembly. The trained website editing ML model is configured to output content for the website, including text and images based on the structure (using pre-built sections), theme, and editing user input (e.g., business name, business type, natural language description).

In some embodiments, the process 400 includes performing 409 quality assurance or fine-tuning operations as described above with reference to FIGS. 1, 2A, 2B.

In some embodiments, shown in FIGS. 4A and 4B, at step/operation 410, the process 400 includes, responsive to receiving the one or more content objects, generating the website based at least in part on the structural content, the theme content, and the one or more content objects. That is, as a result of the outputs of the trained website editing ML model, there is enough information needed to build a website from scratch. A new (substantially) empty instance of a website is created, the selected pages and sections are injected into the empty instance, the theme is applied, and the content is injected. At this point, the website can be presented to the user for review and editing.

In some embodiments, shown in FIGS. 4A and 4B, at step/operation 410, the process 400 includes transmitting the website to the client computing entity. The website is configured for rendering via a display device of the client computing entity.

In embodiments, data associated with the interactions between the editing user and the WBS are stored 416 in one or more repositories. Further, the trained website editing ML model may be initially trained and continuously retrained using data retrieved (414A, 414B) from the one or more repositories.

While embodiments herein are described with reference to receiving the natural language content object and the one or more content selections from a client computing entity, the natural language content object and the one or more content selections may be received via an application programming interface (API).

An example prompt (using a GAI model API):
“You are a website builder. Given a business name, business type and additional information provided in the input, you will suggest which pages need to exist in the site, and for each page, you will provide the list of” sections that should be added. The list of possible sections and their use is <injected list of sections>
business type-<user provided business type>
business name-<user provided business name>
Additional information-<user provided additional information>

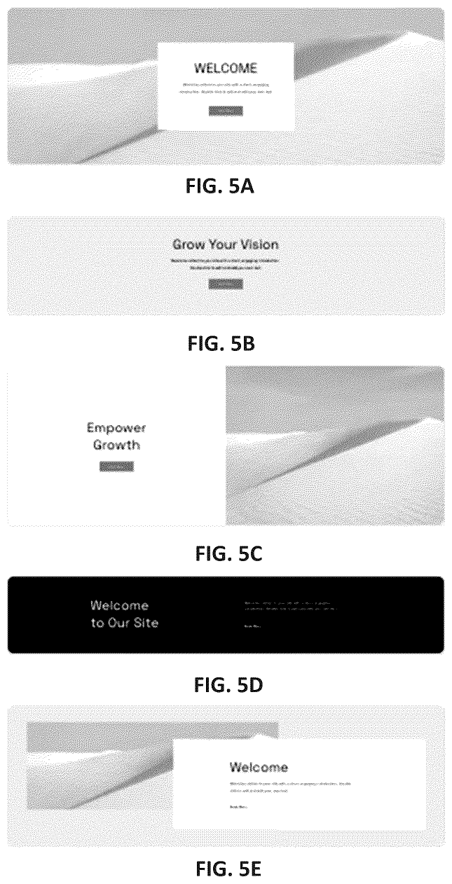

FIGS. 5A, 5B, 5C, 5D, and 5E depict example user interfaces associated with model interaction integration in accordance with some example embodiments described herein. That is, FIGS. 5A-5E depict examples of interfaces rendering pre-built sections of websites as described herein.

Table I below depicts examples of textual mappings per section, which includes values used for guiding the trained website editing ML model (e.g., AI engine, GAI engine) to select the best section for content.

TABLE I

| | |
|---|---|
| Welcome 01 | Title and short paragraph with background image, suitable for conveying a |
| | single topic short and to the point |
| Welcome 02 | Title and short paragraph with no visuals, suitable for conveying a single topic |
| | short and to the point |
| Welcome 05 | two columns of equal size in one column with only a Title and the other with |
| | image related to the title, useful for describing a subject without describing it |
| About 01 | Title and A paragraph with background image, suitable for conveying a single |
| | topic |
| About 02 | Title and short paragraph with no visuals, suitable for conveying a single topic |
| | short and to the point |
| About 03 | two columns, one column take two third of the size with a short Title short |
| | subtitle and paragraph the other column take a third of the size with image |
| | related to the text, useful for describing a single topic |
| Services 01 | Title and paragraph for high level description and list of 3 items with image |
| | title and paragraph for each one, suitable for describing a list of things with |
| | something common in between them |
| Services 03 | Title for high level description and list of 4 items with image short title and |
| | short subtitle for each one, suitable for describing a list of things with |
| | something common in between them |
| Services 05 | Title for high level description and list of 3 items with image title and |
| | paragraph for each one, a background image covering behind all of them, |
| | suitable for describing a list of things with something common in between them |

Table II below depicts examples of theme mapping.

TABLE II

| | |
|---|---|
| theme1 | Colorful and cheerful, light colors. |
| | Suitable for businesses with a positive vibe |
| theme2 | Darker colors, professional fonts. Suitable for |
| | businesses that should reflect professionalism |
| | and experience |

Advantages provided by the presently described model powered website customization include delivering a focused custom website to an editing user that is unique to the editing user. Moreover, embodiments herein remove the constraint of structure tied to a business type. Such constraints provide fewer possibilities for an editing user generating a website and require a high amount of curation to maintain (there need to be thousands of mappings between structure and business types). This approach reduces the number of predefined sections considerably to a few classes and does not require mapping to possible business types. Embodiments herein also eliminate the need for content curation, as the content is custom generated by the AI engine.

Example Operations Associated with Model Powered Structure & Content Supplementation

Embodiments herein relate to leveraging a trained ML model (e.g., trained GAI model) to supplement a website with structure and/or content. In some instances, an editing user may want to add structure (e.g., sections or webpages) to an existing website. A WBS may provide an option to select from existing template sections or pages and add content to them, however this requires that the editing user find a suitable structure to add rather than matching one based on his specific needs and requires that the editing user generate or write the content himself.

Embodiments herein overcome the aforementioned drawbacks and more by leveraging a trained ML model (e.g., trained GAI model) to aid with the editing process, such as to create sections, pages, media, and text and to adapt images to the text context. Embodiments recommend to the editing user the part (section, page, etc.) that seems the most appropriate to add (e.g., supplement the site with) in this context, based on output from the trained ML model. It will be appreciated that, while embodiments herein are described in terms of the creating, editing, and designing of a page section, an entire page, or a site, embodiments may also be used when creating other types of creations, such as site sections, page collection, section collection (one or more of which may not necessarily be contiguous), etc., without departing from the scope of the present disclosure.

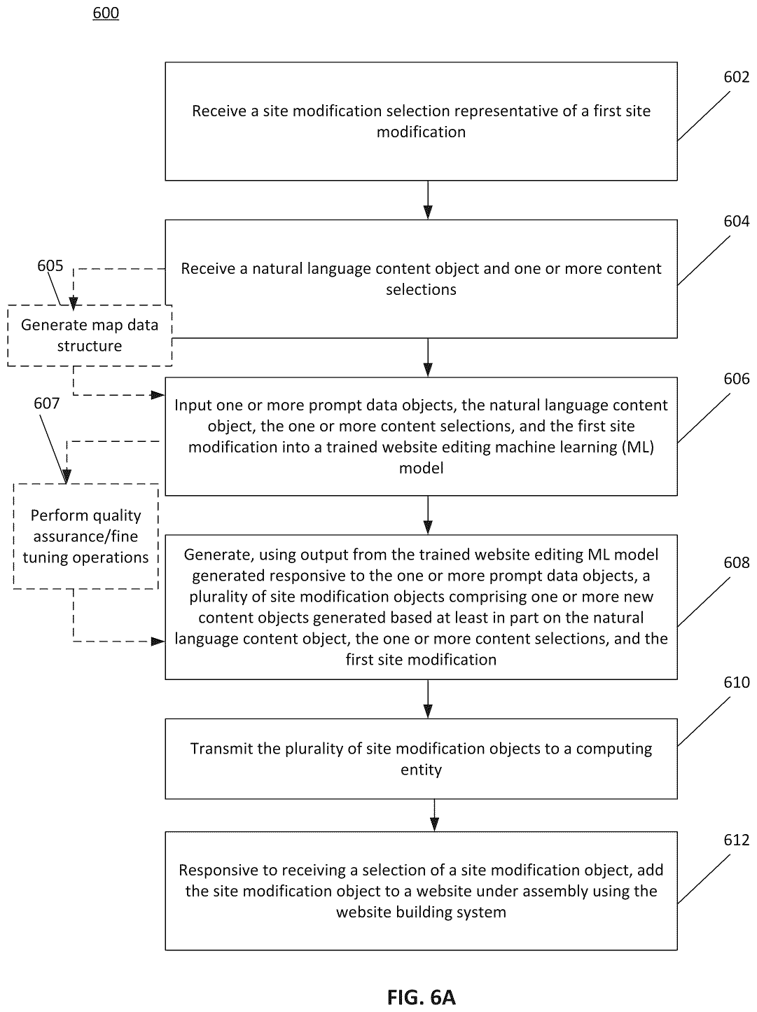

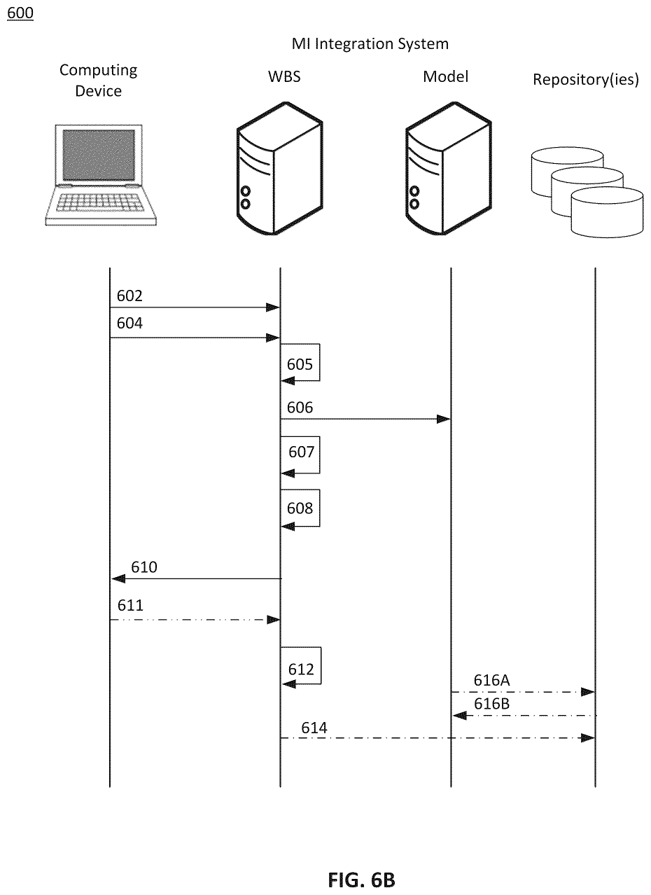

FIGS. 6A and 6B depict example operations associated with model interaction integration in accordance with some example embodiments described herein. The operations illustrated in FIGS. 6A and 6B may, for example, by performed by an MI integration server 1812, which may include means, such as memory 2102, processor 2104, input/output module 2106, communications module 2108, MI integration module 2110, and/or the like, which are collectively configured for model interaction integration. The operations may further be performed by one or more client devices 1808A-N, which may include means, such as memory 2202, processor 2204, input/output module 2206, communications module 2208, and/or the like.

In some embodiments, shown in FIGS. 6A and 6B, at step/operation 602, the process 600 includes receiving a site modification selection representative of a first site modification. The site modification selection may be received via a site modification interface element integrated into a website building system accessed using a client computing entity associated with an editing user identifier. The first site modification may be an indication that the editing user wants to add a page or section to an existing website. For example, the editing user is presented with an interface for adding a new section to a page (new or existing). In this interface, the user can provide a textual description of what the section he wants to add will be about.

In some embodiments, shown in FIGS. 6A and 6B, at step/operation 604, the process 600 includes receiving a natural language content object and one or more content selections. The natural language content object and the one or more content selections may be received via one or more model interaction (MI) interface elements integrated into the website building system. The natural language content object and one or more content selections may be received via input elements as described above.

In some embodiments, shown in FIGS. 6A and 6B, at step/operation 606, the process 600 includes inputting, to a trained website editing machine learning (ML) model, one or more prompt data objects, the natural language content object, the one or more content selections, and the first site modification. The input to the trained website editing ML model may include, in addition to or as part of the one or more prompt data objects, sections and section descriptions (generated at step/operation 605) in natural language (as described with reference to FIGS. 1, 2A, 2B).

The trained website editing ML model is configured to output, based on the one or more prompt data objects and other inputs received, a plurality of site modification objects. The plurality of site modification objects may comprise one or more new content objects generated based on the natural language content object, the one or more content selections, and the first site modification. The plurality of site modification objects and/or one or more new content objects may be generated based in part on the map data structure (generated at step/operation 605) representing the existing structure and content of the site. The map data structure may be generated as described above.

In some embodiments, shown in FIGS. 6A and 6B, at step/operation 608, the process 600 includes generating, using the output from the trained website editing ML model, the plurality of site modification objects.

In some embodiments, the process 600 includes performing 509 quality assurance or fine-tuning operations as described above.

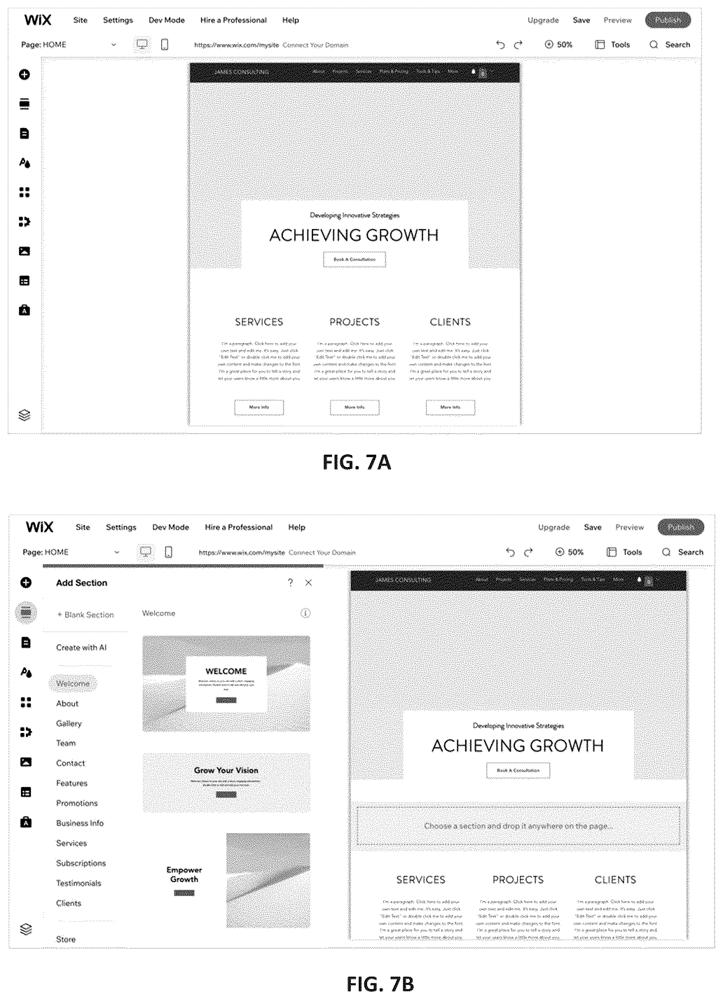

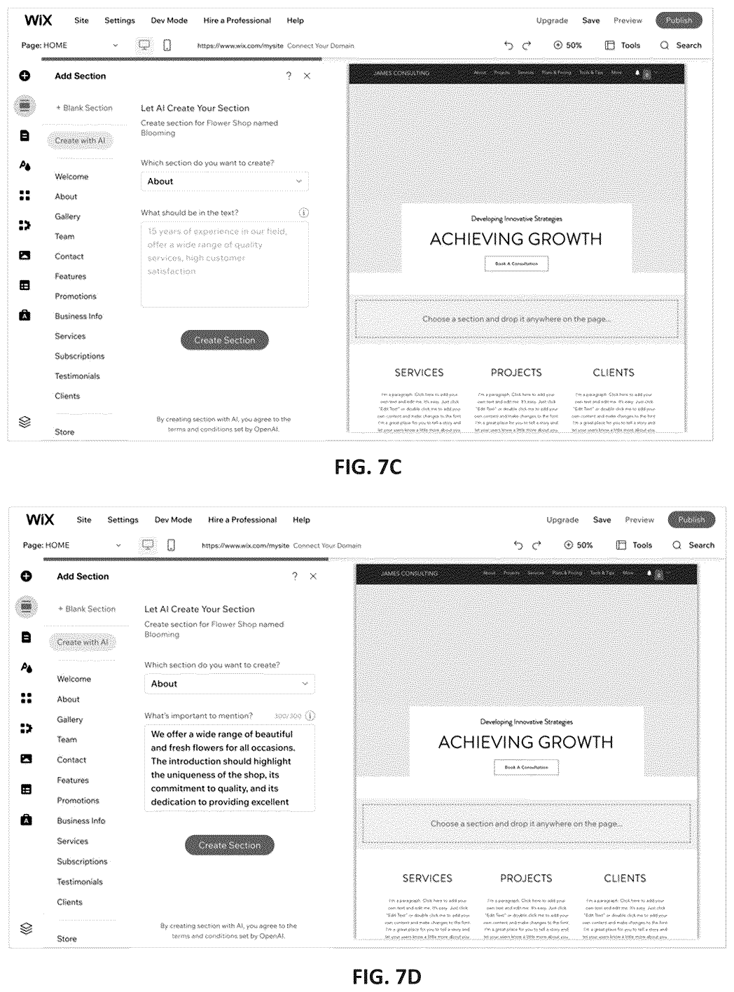

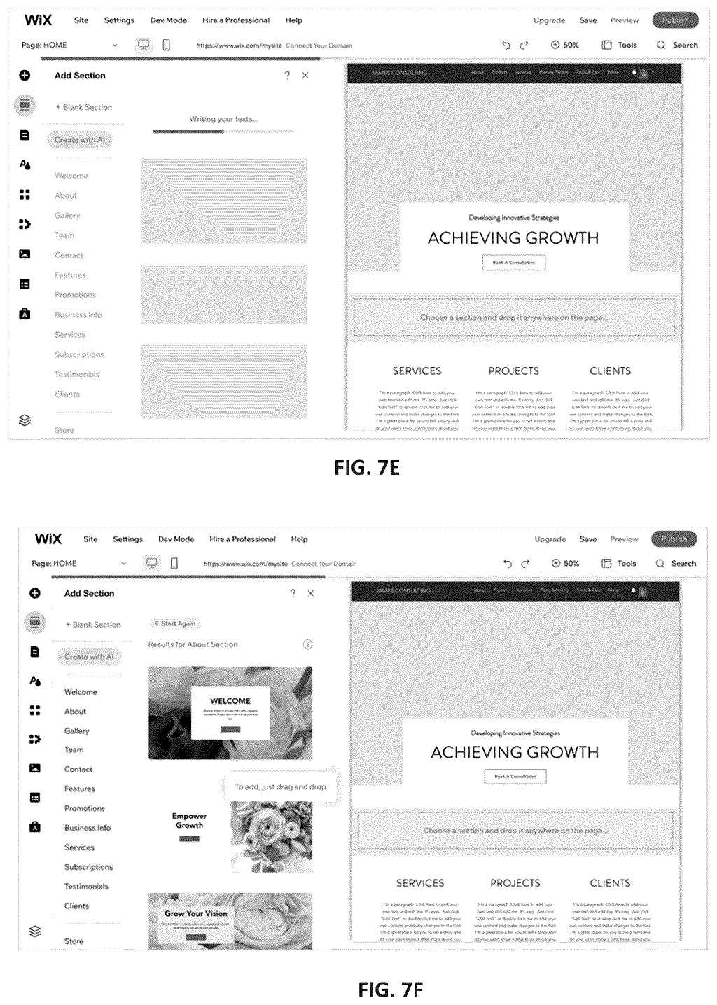

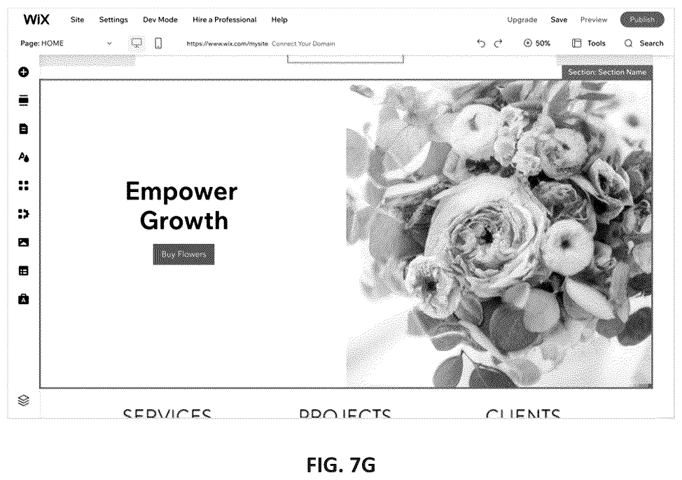

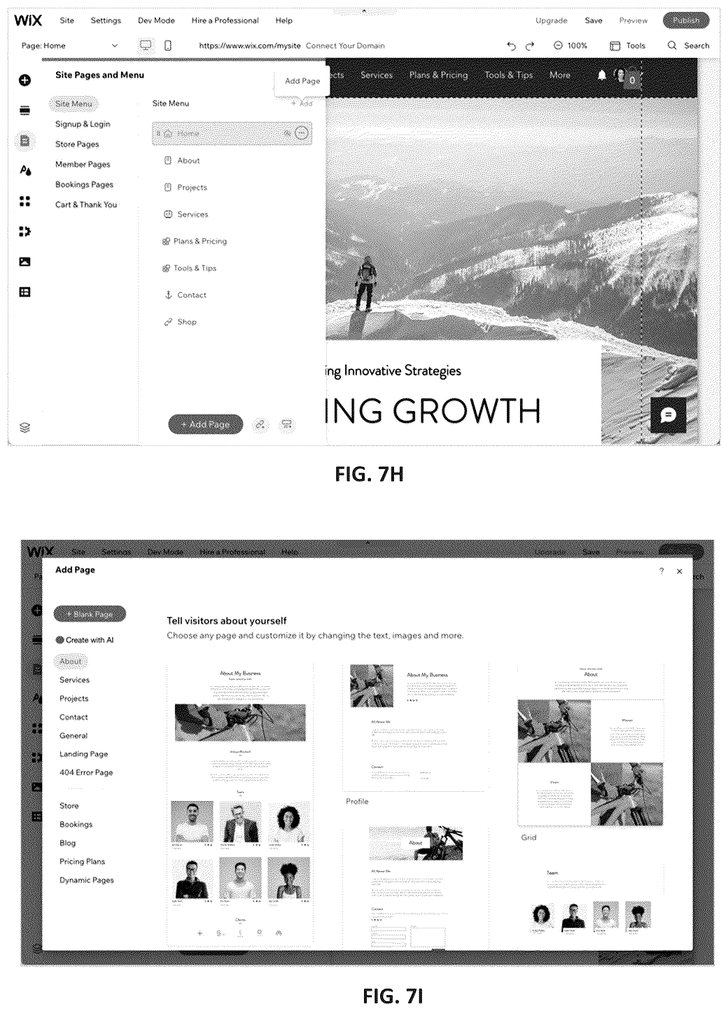

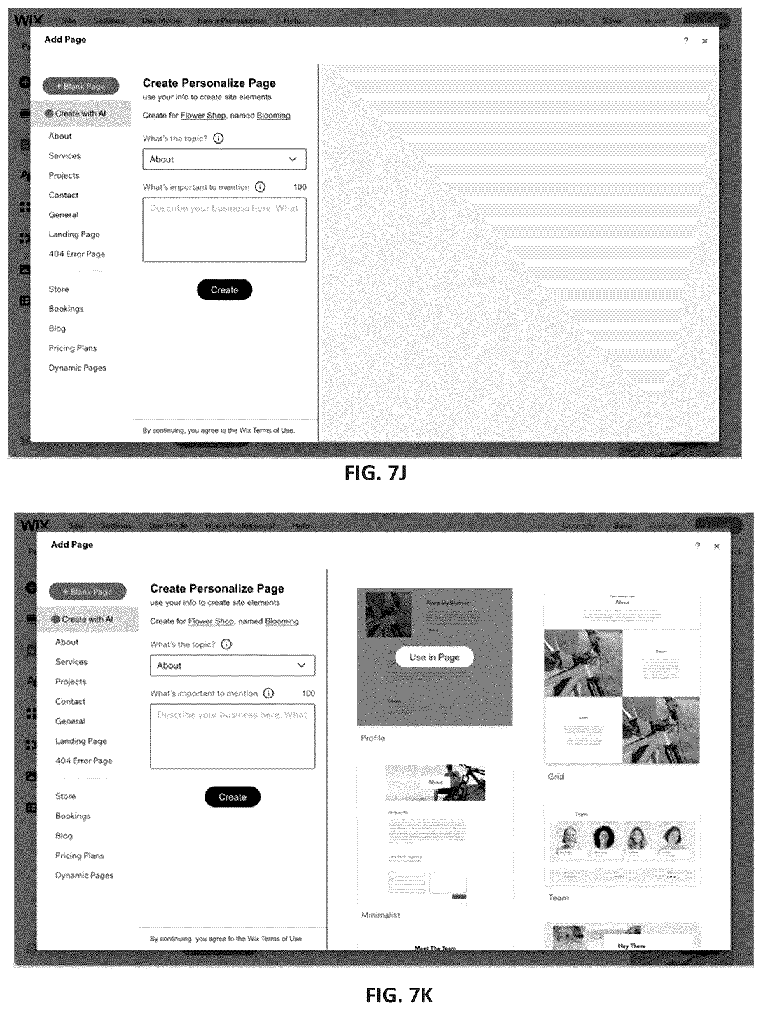

The editing user is then presented with options for the new section. He or she can choose to change the description or just regenerate the options, and when he or she sees an option he or she likes, clicking on it will add it to the site. That is, in some embodiments, shown in FIGS. 6A and 6B, at step/operation 610, the process 600 includes transmitting the plurality of site modification objects to the client computing entity. The plurality of site modification objects is configured for rendering via the display device of the client computing entity (see, e.g., FIGS. 7F to 7K).

In some embodiments, shown in FIGS. 6A and 6B, at step/operation 612, the process 600 includes, responsive to receiving 611 a selection of a site modification object (see, e.g., FIG. 7G), adding the site modification object to a website under assembly using the website building system and associated with the editing user identifier.

In embodiments, data associated with the interactions between the editing user and the WBS are stored 614 in one or more repositories. Further, the trained website editing ML model may be initially trained and continuously retrained using data retrieved (616A, 616B) from the one or more repositories.

It will be appreciated that, while embodiments herein are described with respect to interaction with a client computing entity, the site modification selection may be received via an application programming interface (API), the plurality of site modification objects may be transmitted via the API, and the selection of the site modification object may be received via the API.

FIGS. 7A, 7B, 7C, 7D, 7E, 7F, 7G, 7H, 7I, 7J, and 7K depict example user interfaces associated with model interaction integration in accordance with some example embodiments described herein.

FIG. 7A depicts an example user interface whereby a user has selected “Add Section.” FIG. 7B depicts an example user interface whereby a user has selected “Create with AI.” FIG. 7C depicts an example user interface whereby a user has selected to enter text. FIG. 7D depicts an example user interface whereby a user has selected a “Create Section” button or interface element. FIG. 7E depicts an example user interface where a user may observe that the system (e.g., the AI powering the system, process, or user interface) is working. FIG. 7F depicts an example user interface whereby several suggestions are presented. FIG. 7G depicts an example resulting user interface illustrating a section that was selected by the user from the interface depicted in FIG. 7F.

FIG. 7H depicts an example user interface whereby a user has selected “Add Page.” FIG. 7I depicts an example user interface whereby a user has selected “Create with AI.” FIG. 7J depicts an example user interface whereby a user has selected the topic, one or more important points, and then selected “create.” FIG. 7K depicts an example user interface whereby several suggestions are presented for selection by the user.

Example Operations Associated with Model Powered Layout & Design Replacement

Embodiments herein relate to leveraging a trained ML model (e.g., trained GAI model) to replace the layout and/or design of an existing website assembled using a WBS. An editing user may have already built and added content to parts of the website, and then may decide to change the layout or design. The editing user may want to choose a different layout/design from a template but would still want to keep the content of the website.

Embodiments herein provide for solutions to the aforementioned challenges by providing an editing user with an option to select a different section template (e.g., from the list of templates offered when a new section is inserted). The options for the sections can be derived either from the existing content or by providing a description if the editing user chooses to. Advantageously, according to embodiments herein, the current section and the target sections do not need to have the same structure, the same meaning, or the same content components. For example, the current section may have a title, a long paragraph, and an image, while the target section may have a title, subtitle, and two short paragraphs. Embodiments herein provide for seamless changing of layout and design without requiring the editing user to modify content to comply with structural or other constraints that may be different between the existing and target sections.

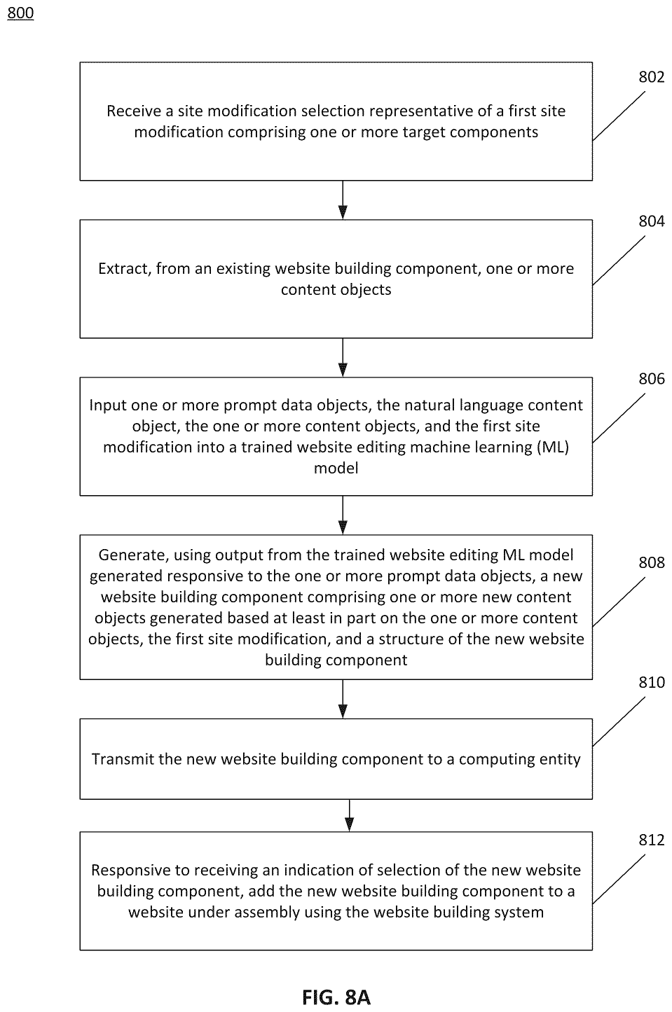

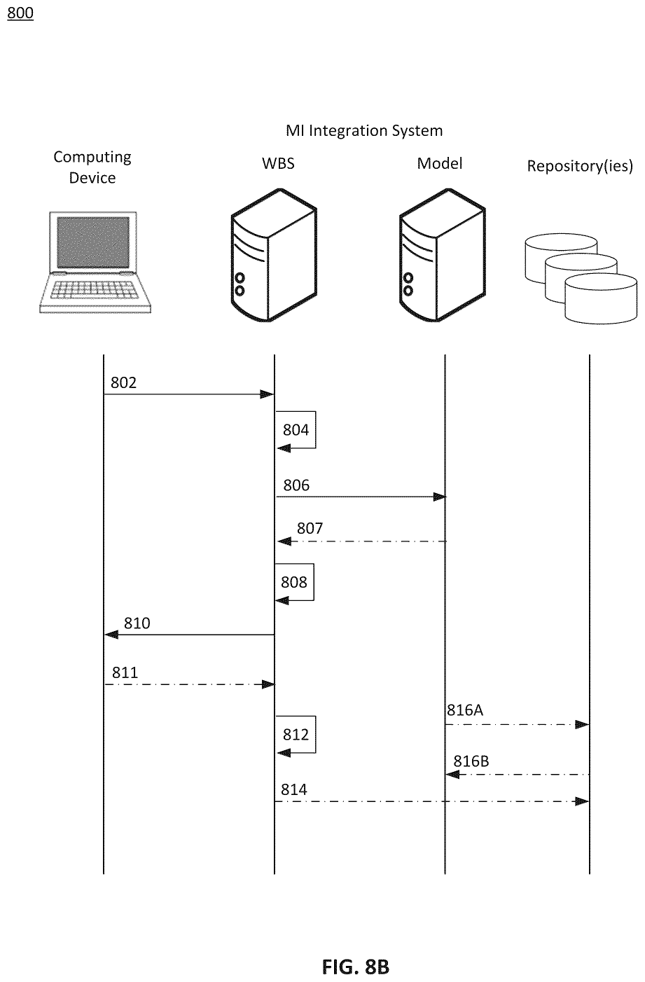

FIGS. 8A and 8B depict example operations associated with model interaction integration in accordance with some example embodiments described herein. The operations illustrated in FIGS. 8A and 8B may, for example, be performed by an MI integration server 1812, which may include means, such as memory 2102, processor 2104, input/output module 2106, communications module 2108, MI integration module 2110, and/or the like, which are collectively configured for model interaction integration. The operations may further be performed by one or more client devices 1808A-N, which may include means, such as memory 2202, processor 2204, input/output module 2206, communications module 2208, and/or the like.

In some embodiments, shown in FIGS. 8A and 8B, at step/operation 802, the process 800 includes receiving a site modification selection representative of a first site modification. The first site modification may include one or more target components. The site modification selection may be received via a site modification interface element integrated into a website building system accessed using a client computing entity associated with an editing user identifier. The one or more target components may be a new or replacement section that the editing user wants to use in place of an existing section.

In some embodiments, shown in FIGS. 8A and 8B, at step/operation 804, the process 800 includes extracting, from an existing website building component (e.g., template or section), one or more content objects. The one or more content objects may comprise natural language content and/or content selections and may represent content currently inserted in the existing section. Step/operation 804 may further include generating a map data structure (e.g., generated as described with reference to FIGS. 1, 2A, 2B above) of the target component (e.g., target section).

In some embodiments, shown in FIGS. 8A and 8B, at step/operation 806, the process 800 includes inputting, to a trained website editing machine learning (ML) model, one or more prompt data objects, the map data structure (e.g., of the target component) and one or more content objects. The input to the trained website editing ML model may also include sections and corresponding section descriptions (as described with reference to FIGS. 1, 2A, 2B above), either as part of or in addition to the one or more prompt data objects. The trained website editing ML model is configured to output 807 one or more new content objects in response to the one or more prompt data objects.

The one or more prompt data objects may include the target section's outline and the current section's content (all or some of it). The prompt instructs the trained website editing ML model (e.g., AI engine or GAI engine) to return a response in the same format as the target section, but by using the substance (e.g., content) of the current section rephrased into the new format.

In some embodiments, the process includes performing quality assurance operations as described above, prior to or after step/operation 808.

In some embodiments, shown in FIGS. 8A and 8B, at step/operation 808, the process 800 includes generating, using the output from the trained website editing ML model generated responsive to the one or more prompt data objects, a new website building component comprising the one or more new content objects. The new website building component is generated based at least in part on the one or more content objects, the first site modification, and a structure of the one or more target components.

In some embodiments, shown in FIGS. 8A and 8B, at step/operation 810, the process 800 includes transmitting the new website building component to the client computing entity. The new website building component is configured for rendering via the display device of the client computing entity.

In some embodiments, shown in FIGS. 8A and 8B, at step/operation 812, the process 800 includes, responsive to receiving 811 an indication of selection of the new website building component, add the new website building component to a website under assembly using the website building system and associated with the editing user identifier. That is, the current section is then removed and replaced with the new section.

In embodiments, data associated with the interactions between the editing user and the WBS are stored 814 in one or more repositories. Further, the trained website editing ML model may be initially trained and continuously retrained using data retrieved (816A, 816B) from the one or more repositories.

In some embodiments, a combination of replacement and copying over of content is supported. For example, the trained website editing ML model (e.g., AI engine or GAI engine) may support the creation of text elements but not images. In such examples, the newly generated text may be used, but pre-existing images may be copied or ported over (when possible or relevant). This may require mapping elements not provided to the ML model and modifying the returned section to place the images in the relevant places (e.g., using dynamic layout or responsive editing techniques). The system may also use a combination of multiple AI models configured to provide different outputs (e.g., text generation engine and image generation engine) and integrate the results.

In some embodiments, “add section” and “switch layout” may be combined to provide for a “switch section” functionality. In such an example, the editing user has a section in the website—and different sections are suggested or presented to the editing user instead based on the context of the existing section (content and layout). Those suggestions can look different and have different content.

It will be appreciated that the site modification selection may be received via an application programming interface (API), the new website building component may be transmitted via the API, and the selection of the new website building component may be received via the API.

Advantages provided by the presently described model powered layout and design replacement include the ability to map between an old or existing structure and a new one that may not be identical to the old or existing structure. The mapping provides for a reduction in time and computing resources when structures are replaced.

Example Operations Associated with Model Powered Stylistic Content Generation

Embodiments herein relate to leveraging a trained ML model (e.g., trained GAI model) to generate stylistically inspired content. Embodiments herein provide for generation of multiple aspects or components (e.g., layout, style, content, etc.) that make up the structure of a website where the generation is based on a user-defined style. In such embodiments, multiple aspect specifications may be received from an editing user, and specialized prompts are generated based on the user inputs so that website building components and/or content are generated in the appropriate style as requested by the editing user.

According to some embodiments, an editing user may want to create a website or one or more parts of it, using something else as an example. This can be another website, a page, a Word or PDF document, a picture, etc. The editing user may want the website or a part of it to be like another website document or image or another inspirational idea.

Embodiments herein provide a solution to such a challenge by accepting input from an editing user in any electronic format (e.g., image, sketch, document, whole website or part of it, URL, any graphic format, a movie, a 3D object, music, or the like). Features associated with the input are extracted and mapped into a new website (or website component or portion).

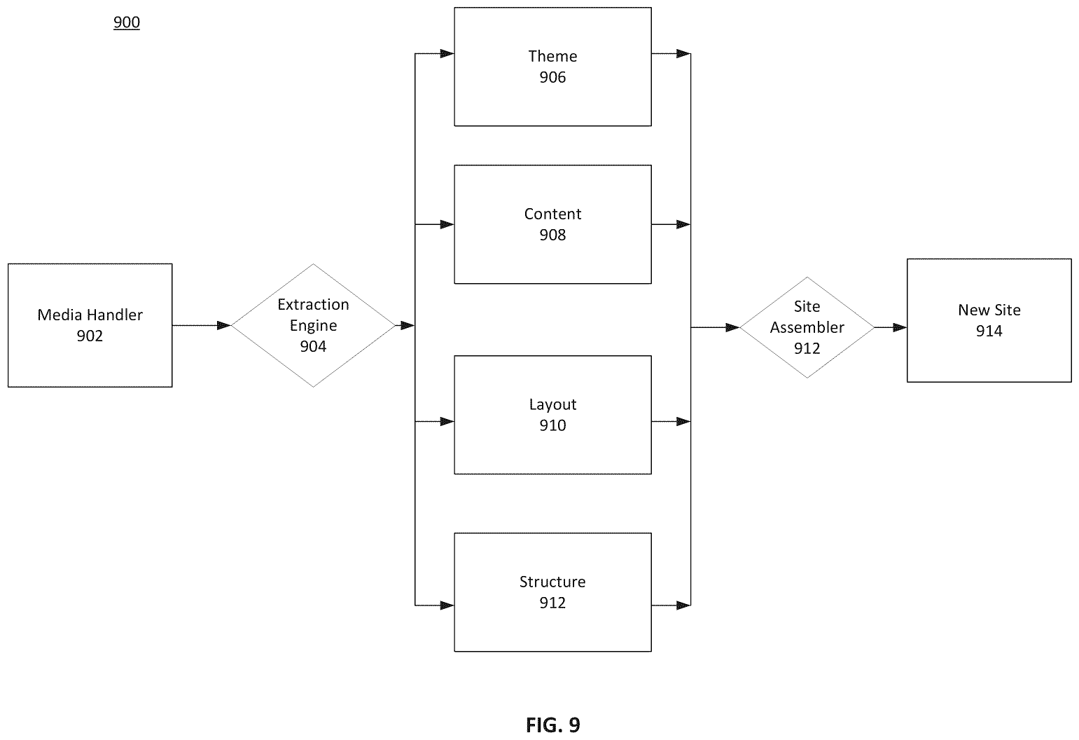

FIG. 9 illustrates an example system architecture 900 within which embodiments of the present disclosure may operate. Shown in FIG. 9, an example architecture 900 includes a media handler 902. The media handler 902 is a component that handles (e.g., reads, and verifies the integrity) of different input media files (e.g., images, videos, sketches, voice, documents, whole websites or part of it, a URL, any graphic format, a movie, a 3D object, music, etc.). The example architecture 900 further includes an extraction engine 904. The extraction engine 904 maps the features of the media instances to generic website components, by relating/mapping these features to the different website parts such as content 908, structure 912, layout 910, and theme 906 (e.g., examples of the different types of new websites that can be affected by the extraction engine 904). The example architecture 900 further includes a site assembler 912 that is configured to take as input the different features, sorted by the generic website parts, and create a new site, or changes an existing site, based on the features created by the extraction engine 904. The result is a new or updated website 914.

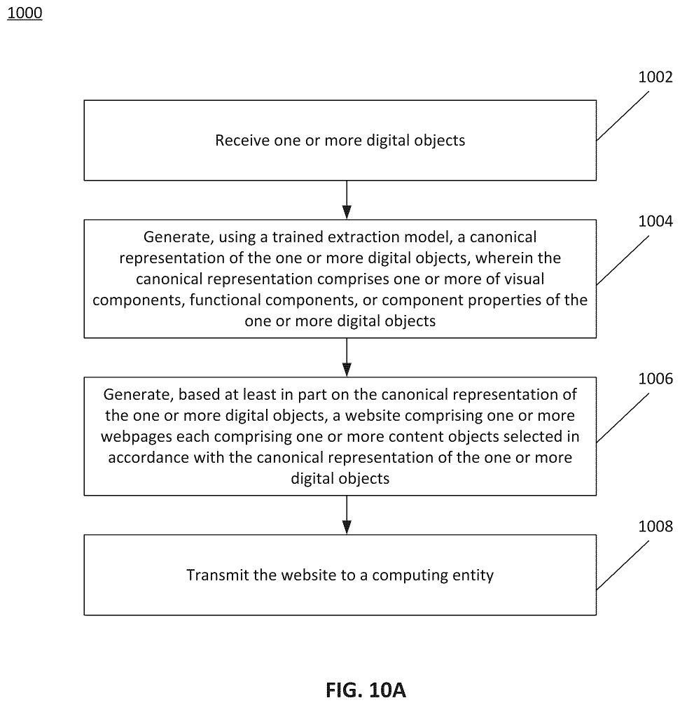

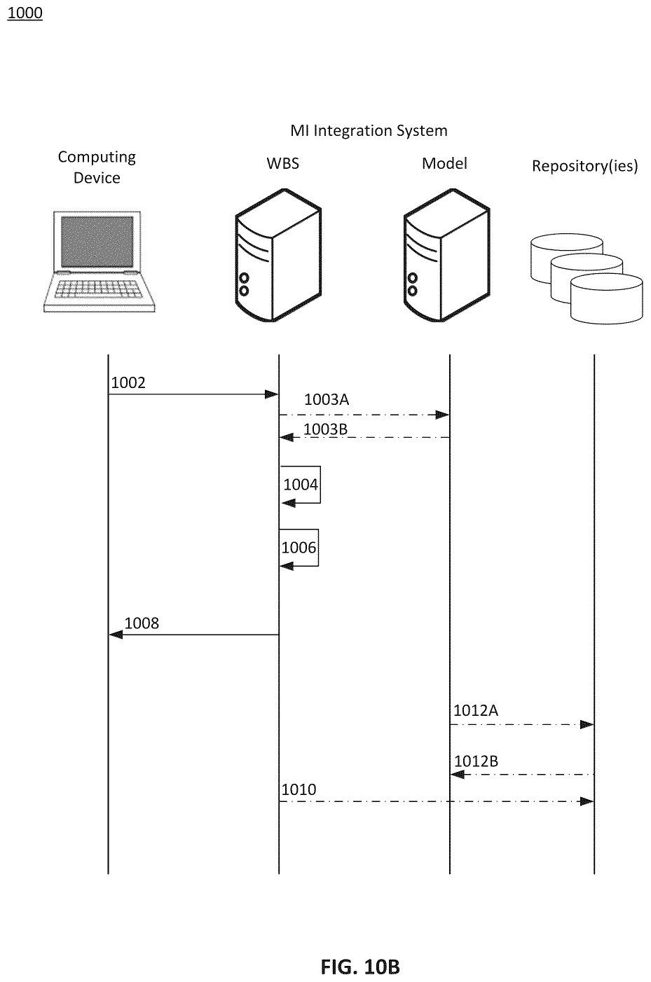

FIGS. 10A and 10B depict example operations associated with model interaction integration in accordance with some example embodiments described herein. The operations illustrated in FIGS. 10A and 10B may, for example, by performed by an MI integration server 1812, which may include means, such as memory 2102, processor 2104, input/output module 2106, communications module 2108, MI integration module 2110, and/or the like, which are collectively configured for model interaction integration. The operations may further be performed by one or more client devices 1808A-N, which may include means, such as memory 2202, processor 2204, input/output module 2206, communications module 2208, and/or the like.

In some embodiments, shown in FIGS. 10A and 10B, at step/operation 1002, the process 1000 includes receiving one or more digital objects. The one or more digital objects (e.g., file or document) may be received via one or more extraction engine interaction (EEI) interface elements integrated into a website building system accessed using a client computing entity associated with an editing user identifier. The one or more digital objects may be one or more media files (e.g., images, videos, sketches, voice, documents, whole websites or part of it, a URL, any graphic format, a movie, a 3D object, music, etc.). In some embodiments, the EEI interface elements are one of a frame within a webpage, an overlay, or a pop-up.

In some embodiments, shown in FIGS. 10A and 10B, at step/operation 1004, the process 1000 includes generating, using a trained extraction model (e.g., by interacting 1003A, 1003B with the trained extraction model), a canonical representation of the one or more digital objects. The canonical representation comprises one or more visual components, functional components, or component properties of the one or more digital objects.

In embodiments, using feature mapping and analysis algorithms, the trained extraction engine or model processes the input (e.g., the media files or the digital objects) to convert it into a standardized format-a canonical document. This document delineates visual and functional components of the input, such as images, buttons, titles, paragraphs, etc. It also defines the properties of these components, including position, size, and style, along with the associated content (e.g., the image or text itself), the hierarchical structure, and metadata like font types and color schemes. The canonical representation will present a synthesized version or versions of the different components. The canonical representation serves as a template (or templates) for extracting a set of features. These features encapsulate the design essence and functional requirements inferred from the input. The input to the trained extraction engine or model may include website components (e.g., content, structure, layout, theme) and corresponding natural language descriptions of the website components. In this way, the trained extraction engine or model can understand the structural format of the website components while remaining only able to understand natural language prompts.

To achieve the feature mapping and analysis, different approaches, such as multimodal large language models (LLMs) with vision capabilities, are employed to generate the canonical document. For example, a vision LLM may receive a screenshot of a website alongside its HTML code and be prompted to outline the intermediate canonical form. Alternatively, custom image understanding models may be used to extract visual components, their locations, and other properties, from an image. For text documents, rule-based converters analyze and reformat content into the target representation, or several versions of this representation.

In some embodiments, the trained extraction model comprises one or more of a large language model (LLM) or generative AI (GAI) model and is trained using a corpus of historical website editing interaction data associated with a plurality of editing user identifiers.

In some embodiments, shown in FIGS. 10A and 10B, at step/operation 1006, the process 1000 includes generating, based at least in part on the canonical representation of the one or more digital objects, a website comprising one or more webpages. The one or more webpages comprise one or more content objects selected in accordance with the canonical representation of the one or more digital objects. For example, the site assembler integrates the extracted features according to the specified website parts-such as content, structure, layout, and theme, utilizing the synthesized features as a reference. The system generates a new website or updates an existing one, reflecting the user's desired outcome based on their inspirational sources. Several versions of the new web site may be created correlating with the several versions created in the previous step. The number of final new site versions may differ from the original versions in the canonical format. Generating the website may involve using a trained website editing machine learning (ML) model as described above with respect to other embodiments herein, and may include the performance of quality assurance operations as described above.

In some embodiments, shown in FIGS. 10A and 10B, at step/operation 1008, the process 1000 includes transmitting the website to the client computing entity. The website is configured for rendering via a display device of the client computing entity. The end product is a fully functional website (or websites) that aligns with the user's vision and requirements, significantly reducing the development time and ensuring satisfactory results.

In embodiments, data associated with the interactions between the editing user and the WBS are stored 1010 in one or more repositories. Further, the trained extraction model may be initially trained and continuously retrained using data retrieved (1012A, 1012B) from the one or more repositories.

While embodiments herein depict the receipt of the one or more digital content objects from a client computing entity, the one or more digital objects may alternatively be received via an application programming interface (API).

It will be appreciated that, while embodiments herein are described with respect to transmitting interfaces to a client computing entity and receiving interface interactions from the client computing entity, such that implementations may be referred to client-side rendering implementations, embodiments herein apply to and support server-side rendering without departing from the scope of the present disclosure. Embodiments herein also apply to implementations involving a combination of client-side and server-side rendering. Thus, the referenced client computing entity may also include element performed on a server (including but not limited to cloud and server-farm instances and virtual servers or other execution instances).

### Example Terminology

The terms “generative artificial intelligence” or “generative AI” refer to an artificial intelligence (AI) or machine learning (ML) model that uses deep learning to create new content based on the data it was trained on. Generative AI models can process a variety of inputs and generate multiple types of output.

The terms “large language model” or “LLM” refer to an artificial intelligence (AI) or machine learning (ML) model that can recognize and generate text. Example LLMs can perform natural language processing (NLP). Example LLMs may employ deep learning.

The term “template selection interface element” refers to a visually rendered input field rendered in conjunction with a user interface, whereby electronic interaction with the template selection interface element enables selection of a desired template (e.g., a template selection).

The term “model interaction (MI) interface element” refers to a visually rendered input field rendered in conjunction with a user interface, whereby electronic interaction with the model interaction interface element enables interaction with one or more models (e.g., inputs received via the interface element may be provided to the one or more models).

The term “trained website editing machine learning (ML) model” refers to a machine learning model configured to generate output in response to prompts, where the outputs are specific to website editing and associated content generation. The trained website editing ML model may be a large language model (LLM) or generative AI (GAI) model and trained using a corpus of historical website editing interaction data associated with a plurality of editing user identifiers.

The term “prompt data object” refers to one or more items of data representing a prompt for inputting to a generative AI model or large language model.

The term “content outline” refers to a data structure containing content of a website or website component as well as logical positionings of components. In some embodiments, the outline includes a data structure with the names of sections, and in a key per content field, with the current value after some cleaning.

The term “structural content” refers to one or more items of data defining a structure of a website under assembly using a website building system.

The term “theme content” refers to one or more items of data defining a theme of a website under assembly using a website building system.

The term “site modification interface element” refers to a visually rendered input field rendered in conjunction with a user interface, whereby electronic interaction with the site modification interface element enables selection of a desired site modification (e.g., a site modification selection). A site modification may refer to a modification an editing user desires to effect associated with a website under assembly using a website building system. Options for site modifications that have been generated using embodiments herein may be referred to as site modification objects. Site modification objects may be configured to be rendered via display devices.

The term “target component” refers to a desired website building component that an editing user may have selected for inclusion in the editing user's website, but that may have a different structure than an existing component of the website.

The term “extraction engine interaction (EEI) interface element” refers to a visually rendered input field rendered in conjunction with a user interface, whereby electronic interaction with the model interaction interface element enables interaction with one or more extraction engines or models (e.g., inputs received via the interface element may be provided to the one or more models).

The term “digital objects” refers to digital files having characteristics that may be extracted to that they may serve the basis for one or more of structure, theme, content, or layout of a website assembled using a website building system. Examples of digital objects include text files, image files, video files, URLs, websites, portions of websites, audio files, or the like.

The term “trained extraction model” refers to a machine learning model configured to generate output responsive to one or more prompt data objects, where the output is based on features extracted from one or more digital objects. A trained extraction model may be a large language model (LLM) or generative AI (GAI) model and trained using a corpus of historical website editing interaction data associated with a plurality of editing user identifiers.

The term “canonical representation” refers to (one or more of visual components, functional components, or component properties of the one or more digital objects)

The terms “website building tools” or “website building components” refer to structural objects or electronic building blocks used to assemble a website in accordance with a website building system as described herein. By way of example, website building tools may include pages, sub-pages, containers, components, atomic components, content elements, layout elements, templates, layouts, layout rules, add-on applications, third-party applications, procedural code, application programming interfaces, and the like. It will be appreciated that, while reference is made herein to examples of website building components being templates, a website building component may be a button, text field, image, or the like, as opposed to a template (or other multi-component) object used for assembly of a website without departing from the scope of the present disclosure.

The terms “website editing historical interactions,” “editing historical interactions,” and “historical editing interactions” refer to electronic interactions performed by client computing devices associated with editing user identifiers in the course of assembling a website in accordance with a website building system as described herein. For example, such interactions may include editing or selections of content, logic, layout, templates, elements, attributes, and/or temporal aspects of the interactions including timing between edits or selections. By way of further example, such interactions may include electronic interactions (e.g., mouse clicks, touch screen selections, cursor hovers, cursor selections, and/or the like) with website building tools, and/or temporal aspects of the interactions including timing between the electronic interactions.

Website editing historical interactions may further refer to data related to a website structure, including data related to layout, components, themes, included verticals, component internal information (e.g., component parameters and attributes that have no immediate external expression), etc. Website editing historical interactions may further refer to data related to the creation of a website, including editing history, user profile and parameters (detailed herein), other sites by the same or related users, as well as the aforementioned interactions, etc. Website editing historical interactions may further refer to data related to site back-end and front-end, internal code elements, and the like, as well as data related to users of the website (e.g., end users or customers of the editing users) and their interactions with the site (including site business intelligence, details of transactions, etc.).

The term “editing user identifier” refers to one or more items of data by which an editing user (e.g., a user building or editing a website using a website building system in accordance with embodiments herein) may be uniquely identified. For example, an editing user identifier may comprise one or more of an email address, a social media handle, ASCII text, encryption keys, identification certificates, a pointer, an IP address, a URL, a MAC address, a memory address, an object signature, a HASH value, or other unique identifier, or combinations thereof.

The term “website identifier” refers to one or more items of data by which a website may be uniquely identified. For example, a website identifier may comprise one or more of ASCII text, encryption keys, identification certificates, a pointer, an IP address, a URL, a MAC address, a memory address, an object signature, a HASH value, or other unique identifier, or combinations thereof.

The term “end-user data” refers to electronic interaction data associated with a plurality of end-user identifiers accessing a plurality of websites assembled in accordance with a website building system as defined herein.

The term “end-user identifier” refers to one or more items of data by which an end-user (e.g., a user accessing or interacting with a website assembled using a website building system in accordance with embodiments herein) may be uniquely identified. For example, an end-user identifier may comprise one or more of an email address, a social media handle, ASCII text, encryption keys, identification certificates, a pointer, an IP address, a URL, a MAC address, a memory address, an object signature, a HASH value, or other unique identifier, or combinations thereof.

The term “electronic interaction data” refers to electronic interactions performed by client devices with electronic interfaces (e.g., websites). Electronic interaction data may include interactions with a touch screen, mouse clicks, cursor positions, cursor hoverings, and the like. Electronic interaction data may further be associated with metadata, such as timestamps at a time which the electronic interaction occurred, such that the electronic interaction data includes temporal aspects.

The term “prompt engineering” refers to the practice of designing inputs for AI tools that will cause the AI tools to produce desired results. Optimizing prompts for AI tools enables the efficient use of AI tools (e.g., LLMs or generative AI technologies) for a wide variety of use cases. With prompt engineering, text can be structured so that it can be interpreted and understood by a generative AI model.

The terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for input vectors in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, legitimacy prediction models, improper dispute prediction models, resource volume prediction models, and disputed network transaction prediction models as described above may make use of multiple ML engines, e.g., for analysis, recommendation generating, transformation, and other needs.

The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by an ML-based engine. Machine learning models are known in the art and are typically some form of neural network. The term refers to the ability of systems to recognize patterns on the basis of existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or auto-encoders) to generate definitions and elements.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example a rule-based system is a domain-specific expert system that uses rules to make deductions or choices. For example, an expert system might help a doctor choose the correct diagnosis based on a cluster of symptoms, or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: Neuro-symbolic systems; Neuro-fuzzy systems; Hybrid connectionist-symbolic models; Fuzzy expert systems; Connectionist expert systems; Evolutionary neural networks; Genetic fuzzy systems; Rough fuzzy hybridization; and/or Reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction and reasoning by analogy.

The terms “client device,” “computing device,” “user device,” “client computing entity” and the like may be used interchangeably to refer to computer hardware that is configured (either physically or by the execution of software) to access one or more of an application, service, or repository made available by a server and, among various other functions, is configured to directly, or indirectly, transmit and receive data. The server is often (but not always) on another computer system, in which case the client device accesses the service by way of a network.

Example client devices include, without limitation, smartphones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure. In some embodiments, a client device is associated with a user.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media.

Examples of non-transitory computer-readable media include a magnetic computer-readable medium (e.g., a floppy disk, hard disk, magnetic tape, or any other magnetic medium), an optical computer-readable medium (e.g., a compact disc read-only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “application,” “software application,” “app,” “product,” “service” or similar terms refer to a computer program or group of computer programs designed to perform coordinated functions, tasks, or activities for the benefit of a user or group of users. A software application may run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise website editing services, document editing services, word processors, spreadsheet applications, accounting applications, web browsers, email clients, media players, file viewers, collaborative document management services, videogames, audio-video conferencing, and photo/video editors.

In some embodiments, an application is a cloud product. When associated with a client device, such as a mobile device, communication with hardware and software modules executing outside of the application is typically provided via application programming interfaces (APIs) provided by the mobile device operating system.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of qualitative assessment or quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present disclosure and may be included in more than one embodiment of the present disclosure (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items. In some embodiments, a “set” may refer to a data structure or a construct having zero items such that it is an empty set.

The term “or” is used herein in both the alternative and conjunctive sense, unless otherwise indicated.

### Data Use, Privacy, and Training Data

It will be appreciated that use of data by systems and embodiments herein are subject to terms, rights, laws, and regulations. These may include rights, laws, and regulations related to privacy (such as EU GDPR or California's CCPA), IP rights (such as copyrights or publicity rights), other property rights, site terms and conditions, and the like. Embodiments herein may implement a specific (opt-in or opt-out) directive that allows users to specify that their website information (or parts thereof) would not be used in AI training input. Furthermore, the system may implement such a directive at various levels of granularity (e.g., as a simple binary decision for site information or allow the user to specify in detail what information to use and what not to use).

Embodiments may implement some degree of reciprocity in using such an AI exclusion directive. Thus, for example, the system may only allow users to benefit from training performed on certain types of data if they themselves enable this data to be gathered from their websites. Such granular inputs and outputs may be implemented through the layering of multiple AI models and combining the results provided by these models. Specific models would be trained with different relevant subsets or levels of input data.

Embodiments herein may manage the training access permission using a layered or “levels of access” model (similar to traditional security classification models, e.g., unclassified/classified/secret/top secret). The system may train different AI models to different classification levels.

In some cases, embodiments may employ a “vertical” instead of (or in addition to) a “horizontal” division of data and models (“data silo” rather than a “data layer”). For example, a large enterprise may have numerous websites and would like to have training data exchange between its various websites (so employees would benefit from the collected internal knowledge) without allowing some or all of their data to be used for AI model training (and thus risk its exposure). Various embodiments of the present disclosure may implement one or more AI models for such a data silo. These AI model(s) would be the model(s) trained using the segregated enterprise data.

In one embodiment, the system may support the use of plug-in (and separately trained) AI models, with their output integrated with the primary (or different layer) models. Various embodiments of the present disclosure may support separate hosting of such plug-in AI model and the code running it—for example, hosting provided by the enterprise whose data is included in the separate data silo. The system may manage the communication with this separate plug-in model via a well-defined channel (API, SPI, or otherwise). Thus, in such an embodiment, the enterprise can retain full control of its proprietary data-even when used as training data to an AI model.

A version of the method above may be implemented to help websites serve users of users (site visitors). Thus, a chatbot (for example) could be embedded into a users' website. This chatbot-if implemented in a clothing store website (for example), could reply to a query about the appropriate clothing combination for a given event or time of the year and respond by directing the user to given items in the store catalog. Such chatbot could communicate in a variety of input and output method including use of text and language, images, video, audio, or any biometric-type communication (e.g., motion detection, gaze detection, etc.).

The amount of data in some categories may be prohibitive for use in training data. This is especially true for use of end-user (site visitor) data, which is substantially higher in volume than per-user data (as a single website could have, for example, millions of users). Thus, for such categories of data, the system may use data minimization techniques and provide (as training input) data that is filtered, selected (according to given criteria), aggregated, or otherwise minimized in volume.

As noted above, when using actual website data to train AI models, there is a concern that the AI model will disclose some private or otherwise proprietary data. This is typically applicable to generative AI models but could apply to other models as well. The system may prevent such a PII disclosure by removing PII from the data at multiple stages (e.g., when the training data is prepared as well as using post-processing on generated AI engine output). The system may integrate multiple PII removal techniques based on the data type being handled. When removing PII, the system may replace the PII value with an alternative value. This way, the system may preserve website element relationships defined through common PII values. For example, an “our team” page may be related to multiple “team member” pages through reference to team member names. Removing the PII values (the names) altogether may break these site interconnections and thus prevent the AI engine from enriching its training. Thus, the system may replace PII values with an alternative value (which is consistent for a given PII value). The alternate value can be generated using hashing, encryption (including one-way encryption), random generation, a replacement value table, or other methods.

### Example Computing Systems, Methods, and Apparatuses of the Disclosure

Having set forth a series of definitions called-upon throughout this application, an example system architecture and example apparatus are described below for implementing example embodiments and features of the present disclosure.

Methods, apparatuses, systems, and computer program products of the present disclosure may be embodied by any of a variety of computing devices. For example, the method, apparatus, system, and computer program product of an example embodiment may be embodied by a networked device, such as a server or other network entity, configured to communicate with one or more devices, such as one or more client devices. Additionally, or alternatively, the computing device may include fixed computing devices, such as a personal computer or a computer workstation. Still, further, example embodiments may be embodied by any of a variety of mobile devices, such as a portable digital assistant (PDA), mobile telephone, smartphone, laptop computer, tablet computer, wearable, or any combination of the aforementioned devices.

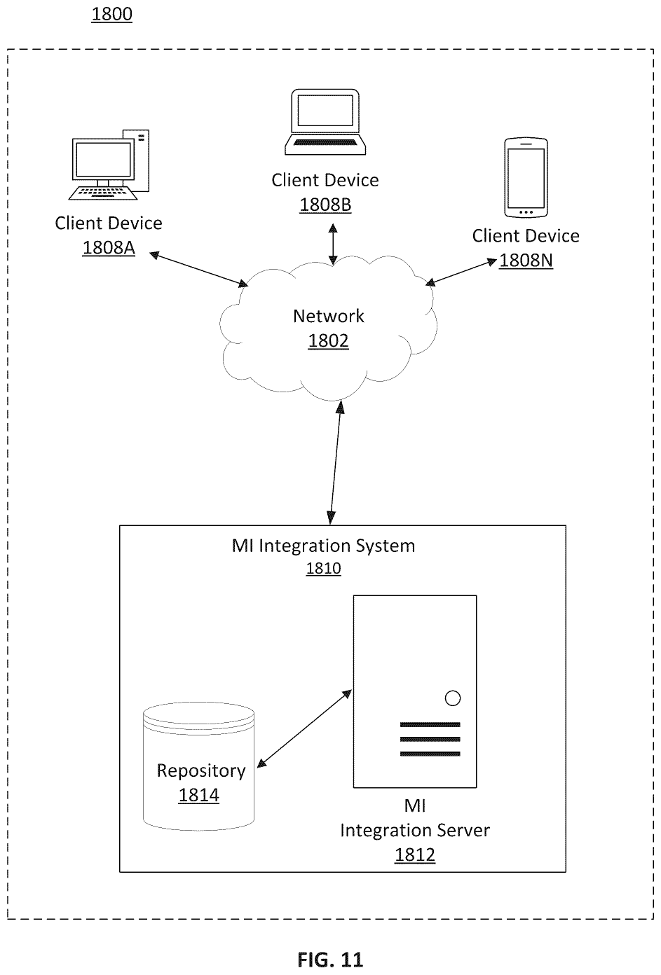

FIG. 11 illustrates a block diagram of an example system that may be specially configured within which embodiments of the present disclosure may operate. In this regard, FIG. 11 illustrates an overview of a computing system 1800 which may include one or more devices and sub-systems that are configured for performing some or all of the various operations and processes described herein. In some examples, such a system 1800 implements model interaction (MI) integration within a WBS via an MI integration system 1810 in accordance with some embodiments described herein.

The computing system 1800 is illustrated with an MI integration system 1810 communicably connected via a network 1802 to one or more client devices 1808A, 1808B, 1808N (referred to as “client devices 1808”; the depictions in FIG. 11 of “N” client devices are merely for illustration purposes). Said differently, users may access the MI integration system 1810 over at least one communications network 1802 using one or more of client devices 1808. In some embodiments, the client devices 1808A-N are embodied by one or more user-facing computing devices embodied in hardware, software, firmware, and/or a combination thereof, configured for performing some or all of the MI integration system functionality described herein. That is, the client devices 1808A-N may include circuitry, modules, networked processors, a suitable network server, and/or other types of processing device (e.g., a controller or computing device of the client device 1808). For example, in some embodiments, a client device 1808A-N is embodied by a personal computer, a desktop computer, a laptop computer, a computing terminal, a smartphone, a netbook, a tablet computer, a personal digital assistant, a wearable device, a smart home device, and/or other networked devices that may be used for any suitable purpose in addition to performing some or all of the MI integration system functionality described herein. In some example contexts, the client device 1808A-N is configured to execute one or more computing programs to perform the various functionality described herein. For example, the client device 1808A-N may execute a web-based application or applet (e.g., accessible via a website), a software application installed to the client device 1808A-N (e.g., an “app”), or other computer-coded instructions accessible to the client device 1808.

In some embodiments, the client devices 1808A-N may include various hardware, software, firmware, and/or the like for interfacing with the MI integration system 1810. Said differently, a client device 1808A-N may be configured to access the MI integration system 1810 and/or to render information provided by the MI integration system 1810 (e.g., via a software application executed on the client device 1808). According to some embodiments, the client device 1808A-N comprises a display for rendering various interfaces. For example, in some embodiments, the client device 1808A-N is configured to display such interface(s) on the display of the client device 1808A-N for viewing, editing, and/or otherwise interacting with at least a selected component, which may be provided by the MI integration system 1810.

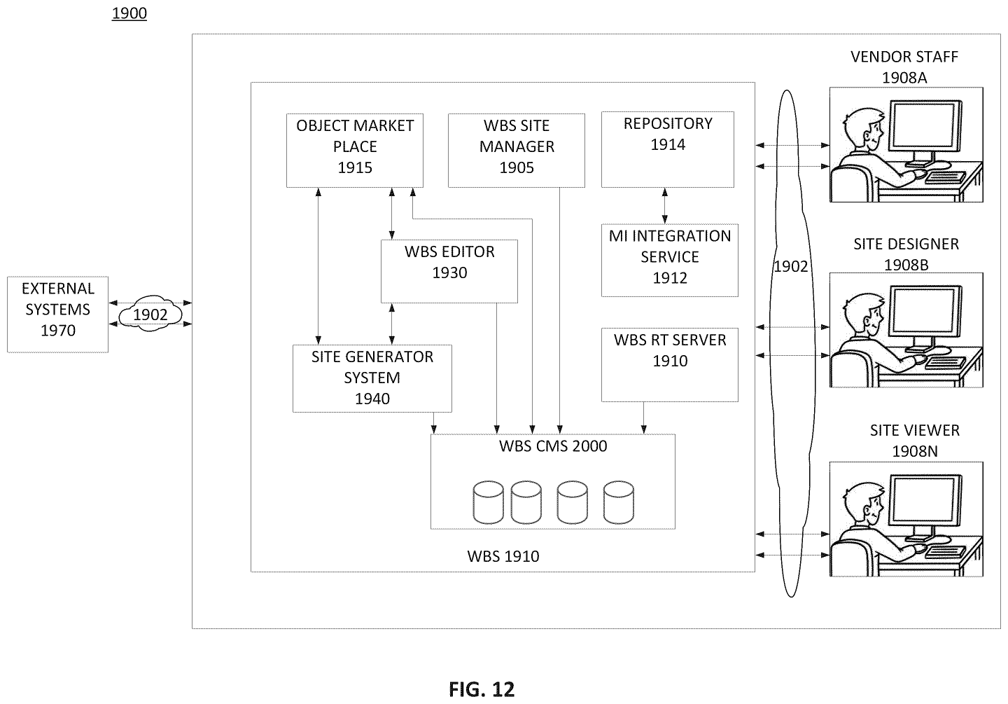

In some embodiments, the MI integration system 1810 includes one or more servers, such as MI integration server 1812. In some embodiments, the MI integration system 1810 comprises other servers and components, as described below with respect to the exemplary depicted embodiment of a website building system 1910 in FIG. 12.

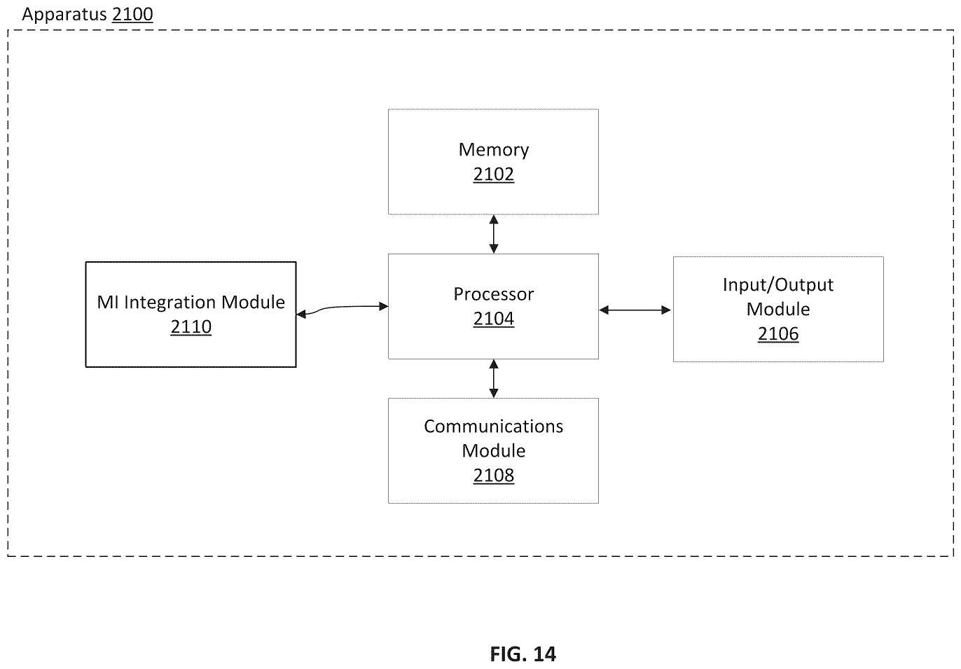

MI integration server 1812 may be any suitable network server and/or other type of processing device. In this regard, the MI integration server 1812 may be embodied by any of a variety of devices, for example, the MI integration server 1812 may be embodied as a computer or a plurality of computers. For example, MI integration server 1812 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least a portion of the components illustrated with respect to server apparatus 2100 in FIG. 14 and described in connection therewith. The MI integration server 1812 may, in some embodiments, comprise several servers or computing devices performing interconnected and/or distributed functions. Despite the many arrangements contemplated herein, MI integration server 1812 is shown and described herein as a single computing device to avoid unnecessarily overcomplicating the disclosure.

In some embodiments, the MI integration server 1812 is configured, via one or more software modules, hardware modules, or a combination thereof, to access communications network 1802 for communicating with one or more of the client devices 1808. Additionally or alternatively, the MI integration server 1812 is configured, via software, hardware, or a combination thereof, to is configured to execute any of a myriad of processes associated with the implementing MI integration. Said differently, MI integration server 1812 may include circuitry, modules, networked processors, or the like, configured to perform some or all of the MI integration functionality, as described herein. In this regard, for example, in some embodiments, the MI integration server 1812 receives and processes data. For example, the client devices 1808A-N and/or an application may communicate with the MI integration system 1810 (e.g., MI integration server 1812) via one or more application programming interfaces (APIs), web interfaces, web services, or the like.

In some embodiments, the MI integration system 1810 includes at least one repository, such as repository 1814. Such repository(ies) may be hosted by the MI integration server 1812 or otherwise hosted by devices in communication with the MI integration server 1812. As depicted, in some embodiments, the MI integration server 1812 is communicably coupled with the repository 1814. In some embodiments, the MI integration server 1812 may be located remotely from repository 1814. In this regard, in some embodiments, the MI integration server 1812 is directly coupled to repository 1814 within the MI integration system 1810.

Alternatively or additionally, in some embodiments, the MI integration server 1812 is wirelessly coupled to the repository 1814. In yet other embodiments, the repository 1814 is embodied as a sub-system(s) of the MI integration server 1812. That is, the MI integration server 1812 may comprise repository 1814. Alternatively or additionally, in some embodiments, the repository 1814 is embodied as a virtual repository executing on the MI integration server 1812.

The repository 1814 may be embodied by hardware, software, or a combination thereof, for storing, generating, and/or retrieving data and information utilized by the MI integration system 1810 for performing the operations described herein. The repository 1814, in some embodiments, may comprise an object repository, a structured repository, a semi-structured repository, or a non-structured repository. For example, repository 1814 may be stored by any suitable storage device configured to store some or all of the information described herein (e.g., memory 2102 of the MI integration server 1812 or a separate memory system separate from the MI integration server 1812, such as one or more database systems, backend data servers, network databases, cloud storage devices, or the like provided by another device (e.g., online application or 3rd party provider), such as a Network Attached Storage (NAS) device or devices, or as a separate database server or servers). Repository 1814 may comprise data received from the MI integration server 1812 (e.g., via a memory 2102 and/or processor(s) 1214) and/or a client device 1808, and the corresponding storage device may thus store this data. The repository 1814 may store various data in any of a myriad of manners, formats, tables, computing devices, and/or the like. For example, in some embodiments, the repository 1814 includes one or more sub-repositories that are configured to store specific data processed by the MI integration system 1810. Repository 1814 includes information accessed and stored by the MI integration server 1812 to facilitate the operations of the MI integration system 1810.

MI integration system 1810 (e.g., MI integration server 1812) may communicate with one or more client devices 1808A-N via communications network 1802. Communications network 1802 may include any one or more wired and/or wireless communication networks including, for example, a wired or wireless local area network (LAN), personal area network (PAN), metropolitan area network (MAN), wide area network (WAN), or the like, or combinations thereof, as well as any hardware, software and/or firmware required for implementing the one or more networks (e.g., network routers, switches, hubs, etc.). For example, communications network 1802 may include a cellular telephone, mobile broadband, long-term evolution (LTE), GSM/EDGE, UMTS/HSPA, IEEE 802.11, IEEE 802.16, IEEE 802.20, Wi-Fi, dial-up, and/or WiMAX network.

Furthermore, the communications network 1802 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the MI integration system 1810, such as JavaScript Object Notation (JSON) objects sent via a WebSocket channel. In some embodiments, the protocol is JSON over RPC, JSON over REST/HTTP, the like, or combinations thereof.

In some embodiments, the MI integration system 1810 is a standalone system. In other embodiments, the MI integration system 1810 is embedded inside a larger editing system. For example, in certain embodiments, the MI integration system 1810 is associated with a visual design system and further still, in some embodiments, the visual design system is one or more of a document building system, a website building system, or an application building system.

An example of an MI integration system (e.g., MI integration system 1810 as depicted in FIG. 11) is depicted in FIG. 12. In particular, FIG. 12 depicts a computing system 1900 including a website building system (“WBS”) 1910 as an example MI integration system for the creation and/or update of, for example, hierarchical websites.

A WBS 1910 may be online (e.g., applications are edited and stored on a server or server set), off-line, or partially online (with web sites being edited locally but uploaded to a central server for publishing). A WBS 1910 may be accessed by a variety of users via a network 1902, including designers, subscribers, subscribing users or site editors, and code editors, which are the users designing the web sites, as well as end users which are the “users of users” accessing the created web sites. Although end users may typically access the WBS 1910 in a read-only mode, a WBS (and web sites) may allow end users to perform changes to a web site, such as adding or editing data records, adding talkbacks to news articles, adding blog entries to blogs, and/or the like.

In some embodiments, a WBS 1910 may allow multiple levels of users and different permissions and capabilities may be associated with and/or assigned to various level. For example, users may register with the WBS 1910 (e.g., via the WBS server which manages the users, web sites, and access parameters of the end users).

With reference to FIG. 12, in addition to an MI integration service 1912, and a repository 1914, a WBS 1910 may comprise a WBS site manager 1905, an object marketplace 1915, a RT (runtime) server 1920, a WBS editor 1930, a site generation system 1940 and a WBS content management system 2000. WBS 1910 is depicted in communication with embodiments of the client devices 1808A-N which are depicted as being operated by WBS vendor staff 1908A, WBS site designer 1908B (e.g., a user), a site viewer 1908N (e.g., a user of a user), as well as external systems 1970. For example, WBS vendor staff 1908A may be an employee of the pertinent website building system vendor and may create and maintain various WBS elements such as templates, content/layout elements, and/or the like. In some embodiments, a site designer 1908B may use WBS 1910 to build his site for use by site viewers 1908N.

Additionally or alternatively, a site designer 1908B may be an external site designer or consultant, though the website building system vendor may employ site designers 1908B, for example for the creation of template sites for inclusion in the WBS 1910. In some embodiments, site viewers 1908N may only view the system. Additionally or alternatively, in some embodiments, site viewers 1908N may be allowed some form of site input or editing (e.g., talkback sending or blog article posting). In still further embodiments, WBS 1910 comprises a limited site generation system 1940 configured to allow a viewer 1908N to build (e.g., a user page) within a social networking site. It is contemplated by this disclosure that a site viewer 1908N may also include a site designer 1908B.

In some embodiments, WBS site manager 1905 is used by site designer 1908B to manage his created sites (e.g., to handle payment for the site hosting or set permissions for site access). In some embodiments, WBS RT (runtime) server 1920 handles run-time access by one or more (e.g., possibly numerous) site viewers 1908N. In some embodiments, such access is read-only, but in certain embodiments, such access involves interactions that may affect back-end data or front-end display (e.g., purchasing a product or posting a comment in a blog). In some embodiments, WBS RT server 1920 serves pages to site designers 1908B (e.g., when previewing the site, or as a front-end to WBS editor 1930).

In some embodiments, object marketplace 1915 allows trading of objects (e.g., as add-on applications, templates, and element types) between object vendors and site designers 1908B through WBS 1910. In some embodiments, WBS editor 1930 allows site designer 1908B to edit site pages (e.g., manually or automatically generated), such as editing content, logic, layout, attributes, and/or the like. For example, in some embodiments, WBS editor 1930 allows site designer 1908B to adapt a particular template and its elements according to her business or industry.

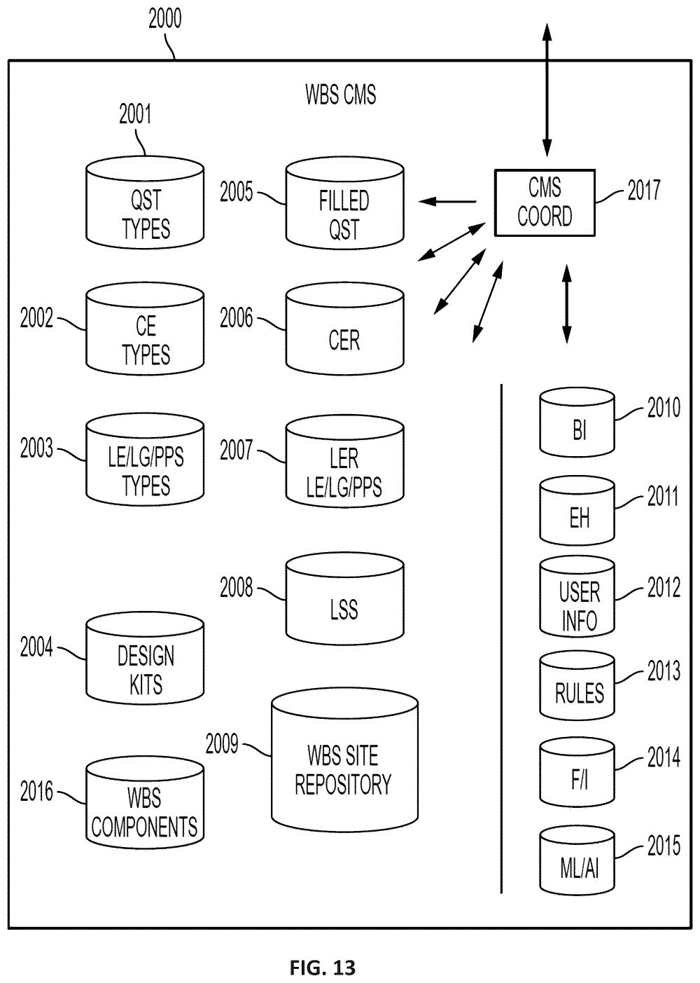

In some embodiments, site generation system 1940 creates the actual site based on the integration and analysis of information entered by site designer 1908B (e.g., via questionnaires), pre-specified and stored in content management system (CMS) 2000 together with information from external systems 1970 and internal information held within CMS 2000 that may be gleaned from the use of the WBS 1910 by other designers. Additionally or alternatively, CMS 2000 is held in centralized storage or locally by site designer 1908B. Example repositories of a CMS 2000 are described below with respect to FIG. 13.

With reference to FIG. 13, an example CMS 2000 is illustrated. The WBS 1910 may utilize a CMS 2000, comprising a series of repositories, stored over one or more servers or server farms, to support the creation of various websites. For example, CMS 2000 may include one or more of user information/profile repository 2012, WBS component repository 2016, WBS site repository 2009, business intelligence (BI) repository 2010, and editing history repository 2011. Additionally or alternatively, CMS 2000 may include one or more of questionnaire type repository 2001, content element (CE) type repository 2002, LE (layout element) type repository 2003, design kit repository 2004, filled questionnaires repository 2005, CER (content element repository) 2006, LER (layout element repository) 2007, layout selection store 2008, rules repository 2013, family/industry repository 2014, and ML/AI (machine learning/artificial intelligence) repository 2015. A CMS 2000 may also include a CMS coordinator 2017 to coordinate and control access to such one or more repositories.

It is contemplated by this disclosure that the WBS 1910 may be used to create and/or update hierarchical websites based on visual editing or automatic generation based on collected business knowledge, where collected business knowledge refers to the collection of relevant content to the web site being created which may be gleaned from, for example, external systems 670 or other sources. Further details regarding collected business knowledge are described in commonly-owned U.S. Pat. No. 10,073,923 which was filed May 29, 2017 as U.S. patent application Ser. No. 15/607,586, and is entitled “SYSTEM AND METHOD FOR THE CREATION AND UPDATE OF HIERARCHICAL WEBSITES BASED ON COLLECTED BUSINESS KNOWLEDGE,” which application is incorporated by reference herein in its entirety.

In some embodiments, WBS 1910 uses internal data architecture to store WBS-based sites. For example, this architecture may organize the handled sites' internal data and elements inside the WBS 1910. This architecture may be different from the external view of the site (as seen, for example, by the end-users) and may also be different from the way the corresponding HTML pages sent to the browser are organized. For example, in some embodiments, the internal data architecture contains additional properties for elements in the page (e.g., creator, creation time, access permissions, link to templates, SEO-related information, and/or the like) that are relevant for the editing and maintenance of the site in the WBS 1910 but are not externally visible to end-users (or even to some editing users). The internal version of the sites may be stored in a site repository as further detailed below.

In some embodiments, a WBS 1910 is used with applications. For example, a visual application is a website including pages, containers, and components. The pages are separately displayed and includes one or more components. In some embodiments, components include containers as well as atomic components. In some embodiments, the WBS 1910 supports hierarchical arrangements of components using atomic components (e.g., text, image, shape, video, and/or the like) as well as various types of container components which contain other components (e.g., regular containers, single-page containers, multi-page containers, gallery containers, and/or the like). The sub-pages contained inside a container component are referred to as mini-pages, some of which may contain multiple components. Some container components may display just one of the mini-pages at a time, while others may display multiple mini-pages simultaneously.

In some examples, pages may use templates—general page templates or component templates. In an exemplary embodiment, an application master page containing components replicated in some or all other regular pages is a template. In another exemplary embodiments, an application header/footer, which repeats on some or all pages, is a template. In some embodiments, templates may be used for the complete page or page sections. A WBS 1910 may provide inheritance between templates, pages or components, possibly including multi-level inheritance, multiple inheritance and diamond inheritance (e.g., A inherits from B and C, and both B and C inherit from D). In some embodiments, a WBS 1910 supports site templates.

In some embodiments, the visual arrangement of components inside a page is a layout. In some embodiments, a WBS 1910 supports dynamic layout processing whereby the editing of a given component (or other changes affecting it such as externally-driven content change) may affect other components. Further details regarding dynamic layout processing are described in commonly-owned U.S. Pat. No. 10,185,703, which was filed Feb. 20, 2013 as U.S. patent application Ser. No. 13/771,119, and is entitled “WEB SITE DESIGN SYSTEM INTEGRATING DYNAMIC LAYOUT AND DYNAMIC CONTENT,” which patent is incorporated by reference herein in its entirety.

In some embodiments, a WBS 1910 is extended using add-on applications, such as third-party applications and components, list applications, and WBS configurable applications. In certain embodiments, such add-on applications may be added and integrated into designed web sites. Such add-on applications may be purchased (or otherwise acquired) through a number of distribution mechanisms, such as being pre-included in the WBS design environment, from an application store (e.g., integrated into the WBS object marketplace 1915 or external) or directly from the third-party vendor. Such third-party applications may be hosted on the servers of the WBS vendor, the servers of the third-party application's vendor, and/or a 4th party server infrastructure.

In some embodiments, a WBS 1910 allows procedural code to be added to some or all of the entities (e.g., applications, pages, elements, components, and the like). Such code could be written in a standard language (such as JavaScript), an extended version of a standard language or a language proprietary to the specific WBS 1910. The executed code may reference APIs provided by the WBS 1910 itself or external providers. The code may also reference internal constructs and objects of the WBS 1910, such as pages, components and their attributes.

In some embodiments, the procedural code elements may be activated via event triggers which may be associated with user activities (e.g., mouse move or click, page transition and/or the like), activities associated with other users (e.g., an underlying database or a specific database record being updated by another user and/or the like), system events or other types of conditions. The activated code may be executed inside the WBS's client element (e.g., client devices 1808), the server platform, a combination of the two or a dynamically determined execution platform. Further details regarding activation of customized back-end functionality are described in commonly-owned U.S. Pat. No. 10,209,966, which was filed on Jul. 24, 2018 as U.S. patent application Ser. No. 16/044,461, and is entitled “CUSTOM BACK-END FUNCTIONALITY IN AN ONLINE WEBSITE BUILDING ENVIRONMENT,” which patent is incorporated by reference herein in its entirety.

FIG. 14 illustrates a block diagram of an example apparatus that may be specially configured in accordance with an example embodiment of the present disclosure. In some embodiments, MI integration system 1810 and/or MI integration server 1812 is embodied by one or more computing systems, such as the apparatus 2100 as depicted and described in FIG. 14.

FIG. 14 shows a schematic block diagram of example modules or circuitry, some or all of which may be included in server apparatus 2100. As illustrated in FIG. 14, in accordance with some example embodiments, the server apparatus 2100 may include various means, such as memory 2102, processor 2104, input/output module 2106, communications module 2108, and/or MI integration module 2110. The server apparatus 2100 may be configured, using one or more of the modules 2102-2110, to execute the operations regarding implementing MI integration functionality with respect to FIGS. 1-10B. Said differently, systems, methods, apparatuses, and/or computer program products as described herein are configured to transform or otherwise manipulate a general-purpose computer(s) so that it functions as a special-purpose computer to provide MI integration as described herein.

Although the use of the terms “module” and “circuitry” as used herein with respect to components 2102-2110 are described in some cases using functional language, it should be understood that the particular implementations necessarily include the use of particular hardware configured to perform the functions associated with the respective module or circuitry as described herein. It should also be understood that certain of these components 2102-2110 may include similar or common hardware. For example, two or more modules may both leverage use of the same processor, network interface, storage medium, or the like to perform their associated functions, such that duplicate hardware is not required for each module. It will be understood in this regard that some of the components or modules described in connection with the MI integration server 1812, for example, may be housed within this device, while other components or modules are housed within another of these devices, or by yet another device not expressly illustrated in FIG. 14. Said differently, in some embodiments, one or more external systems (such as a remote cloud computing and/or data storage system) may also be leveraged to provide at least some of the functionality discussed herein.

While the terms “module” and “circuitry” should be understood broadly to include hardware, in some embodiments, the terms “module” and “circuitry” also include software for configuring the hardware. That is, in some embodiments, each of the modules 2102-2110 may be embodied by hardware, software, or a combination thereof, for performing the operations described herein. In some embodiments, some of the modules 2102-2110 may be embodied entirely in hardware or entirely in software, while other modules are embodied by a combination of hardware and software. For example, in some embodiments, the terms “module” and “circuitry” may include processing circuitry, storage media, network interfaces, input/output devices, and the like. In some embodiments, other elements of the server apparatus 2100 may provide or supplement the functionality of a particular module or circuitry. For example, the processor 2104 may provide processing functionality, the memory 2102 may provide storage functionality, the communications module 2108 may provide network interface functionality, and the like.

In some embodiments, one or more of the modules 2102-2110 may share hardware, to eliminate duplicate hardware requirements. Additionally or alternatively, in some embodiments, one or more of the modules 2102-2110 may be combined, such that a single module includes means configured to perform the operations of two or more of the modules 2102-2110. Additionally or alternatively, one or more of the modules 2102-2110 may be embodied by two or more submodules.

In some embodiments, the processor 2104 (and/or co-processor or any other processing circuitry assisting or otherwise associated with the processor) may be in communication with the memory 2102 via a bus for passing information among components of, for example, MI integration server 1812. The memory 2102 is non-transitory and may include, for example, one or more volatile and/or non-volatile memories, or some combination thereof. In other words, for example, the memory 2102 may be an electronic storage device (e.g., a non-transitory computer readable storage medium). The memory 2102 may be configured to store information, data, content, applications, instructions, or the like, for enabling server apparatus 2100 (e.g., MI integration server 1812) to carry out various functions in accordance with example embodiments of the present disclosure.

Although illustrated in FIG. 14 as a single memory, memory 2102 may comprise a plurality of memory components. The plurality of memory components may be embodied on a single computing device or distributed across a plurality of computing devices. In various embodiments, memory 2102 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 2102 may be configured to store information, data, applications, instructions, or the like for enabling server apparatus 2100 to carry out various functions in accordance with example embodiments discussed herein. For example, in at least some embodiments, memory 2102 is configured to buffer data for processing by processor 2104. Additionally or alternatively, in at least some embodiments, memory 2102 is configured to store program instructions for execution by processor 2104. Memory 2102 may store information in the form of static and/or dynamic information. This stored information may be stored and/or used by the server apparatus 2100 (e.g., MI integration server 1812) during the course of performing its functionalities.

Processor 2104 may be embodied in a number of different ways and may, for example, include one or more processing devices configured to perform independently. Additionally, or alternatively, processor 2104 may include one or more processors configured in tandem via a bus to enable independent execution of instructions, pipelining, and/or multithreading. Processor 2104 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 14 as a single processor, in some embodiments, processor 804 comprises a plurality of processors. The plurality of processors may be embodied on a single computing device or may be distributed across a plurality of such devices collectively configured to function as MI integration server 1812. The plurality of processors may be in operative communication with each other and may be collectively configured to perform one or more functionalities of MI integration server 1812 as described herein.

In an example embodiment, processor 2104 is configured to execute instructions stored in the memory 2102 or otherwise accessible to processor 2104. Alternatively, or additionally, the processor 2104 may be configured to execute hard-coded functionality. As such, whether configured by hardware or software methods, or by a combination thereof, the processor 2104 may represent an entity (e.g., physically embodied in circuitry) capable of performing operations according to an embodiment of the present disclosure while configured accordingly. Alternatively, as another example, when the processor 2104 is embodied as an executor of software instructions, the instructions may specifically configure processor 2104 to perform one or more algorithms and/or operations described herein when the instructions are executed. For example, these instructions, when executed by processor 2104, may cause the server apparatus 2100 (e.g., MI integration server 1812) to perform one or more of the functionalities of system 1800 as described herein.

In some embodiments, the server apparatus 2100 further includes input/output module 2106 that may, in turn, be in communication with processor 2104 to provide an audible, visual, mechanical, or other output and/or, in some embodiments, to receive an indication of an input from a user, a client device 1808, or another source. In that sense, input/output module 2106 may include means for performing analog-to-digital and/or digital-to-analog data conversions. Input/output module 2106 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output module 2106 may comprise a user interface and may comprise a web user interface, a mobile application, a client device, a kiosk, or the like. The processor 2104 and/or user interface circuitry comprising the processor 2104 may be configured to control one or more functions of a display or one or more user interface elements through computer program instructions (e.g., software and/or firmware) stored on a memory accessible to the processor 2104 (e.g., memory 2102, and/or the like). In some embodiments, aspects of input/output module 2106 may be reduced as compared to embodiments where server apparatus 2100 may be implemented as an end-user machine or other type of device designed for complex user interactions. In some embodiments (like other components discussed herein), input/output module 2106 may even be eliminated from server apparatus 2100. Input/output module 2106 may be in communication with memory 2102, communications module 2108, and/or any other component(s), such as via a bus. Although more than one input/output module 2106 and/or other component may be included in server apparatus 2100, only one is shown in FIG. 14 to avoid overcomplicating the disclosure (e.g., like the other components discussed herein).

Communications module 2108, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with server apparatus 2100. In this regard, communications module 2108 may include, for example, a network interface for enabling communications with a wired or wireless communication network. For example, in some embodiments, communications module 2108 is configured to receive and/or transmit any data that may be stored by memory 2102 using any protocol that may be used for communications between computing devices. For example, communications module 2108 may include one or more network interface cards, antennae, transmitters, receivers, buses, switches, routers, modems, and supporting hardware and/or software, and/or firmware/software, or any other device suitable for enabling communications via a network. Additionally or alternatively, in some embodiments, communications module 2108 includes circuitry for interacting with the antenna(s) to cause transmission of signals via the antenna (e) or to handle receipt of signals received via the antenna (c). These signals may be transmitted by MI integration server 1812 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications module 2108 may additionally or alternatively be in communication with the memory 2102, input/output module 2106 and/or any other component of server apparatus 2100, such as via a bus.

In some embodiments, MI integration module 2110 is included in the server apparatus 2100 and configured to perform the functionality discussed herein related to MI integration. In some embodiments, MI integration module 2110 includes hardware, software, firmware, and/or a combination of such components, configured to support various aspects of such MI integration-related functionality, features, and/or services of the MI integration module 2110 as described herein.

It should be appreciated that, in some embodiments, MI integration module 2110 performs one or more of such exemplary actions in combination with another module of the server apparatus 2100, such as one or more of memory 2102, processor 2104, input/output module 2106, and communications module 2108. For example, in some embodiments, MI integration module 2110 utilizes processing circuitry, such as the processor 2104 and/or the like, to perform one or more of its corresponding operations. In a further example, some or all of the functionality of MI integration module 2110 may be performed by processor 2104 in some embodiments. In this regard, some or all of the example MI integration processes and algorithms discussed herein may be performed by at least one processor 2104 and/or MI integration module 2110. It should also be appreciated that, in some embodiments, MI integration module 2110 may include a separate processor, specially configured field programmable gate array (FPGA), or application specific integrated circuit (ASIC) to perform its corresponding functions.

Additionally or alternatively, in some embodiments, MI integration module 2110 utilizes memory 2102 to store collected information. For example, in some implementations, MI integration module 2110 includes hardware, software, firmware, and/or a combination thereof, that interacts with repository 1914 (as illustrated in FIG. 12) and/or memory 2102 to send, retrieve, update, and/or store data values embodied by and/or associated with the MI integration module 2110.

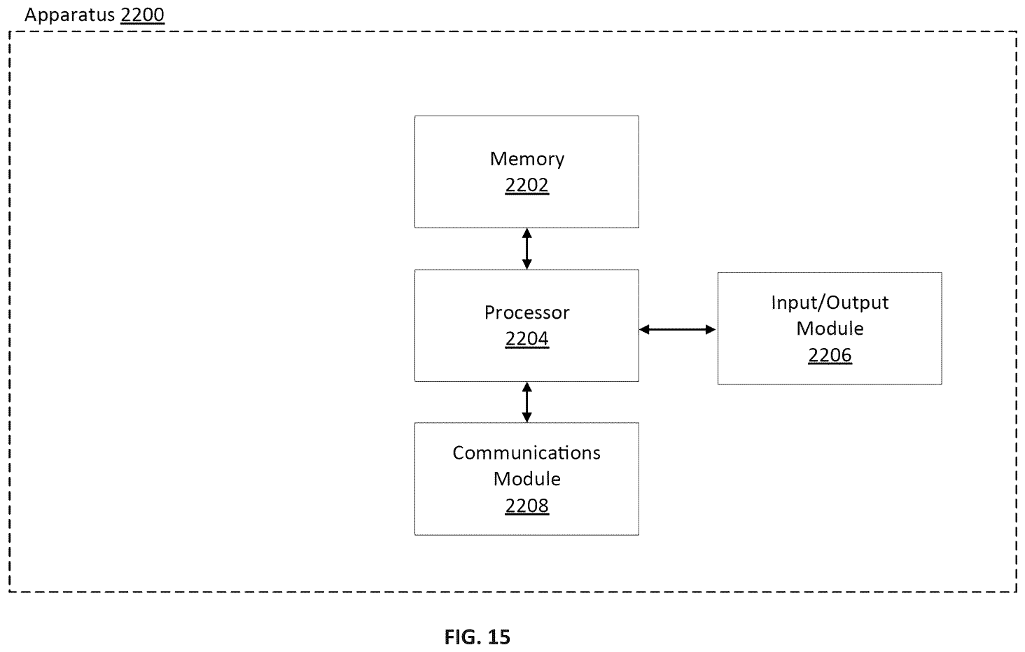

FIG. 15 illustrates a block diagram of an example client apparatus that may be specially configured in accordance with an example embodiment of the present disclosure. In some embodiments, the client device 1808A, 1808B, 1808N is embodied by one or more computing systems, such as the client apparatus 2200 as depicted and described in FIG. 15. The client apparatus 2200 includes a memory 2202, processor 2204, input/output module 2206, and communications module 2208. The client apparatus 2200 may be configured using one or more of the sets of circuitry to execute the operations described herein. The modules 2202-2208 may function similarly or identically to the similarly-named modules depicted and described with respect to the server apparatus 2100. For purposes of brevity, repeated disclosure with regard to the functionality of such similarly-named sets of circuitry is omitted herein.

In some embodiments, one or more of the modules 2202-2208 are combinable. Alternatively or additionally, in some embodiments, one or more of the modules perform some or all of the functionality described associated with another component. For example, in some embodiments, one or more of the modules 2202-2208 are combined into a single module embodied in hardware, software, firmware, and/or a combination thereof.

Thus, particular embodiments of the subject matter have been described. While this specification contains many specific implementation details, these should not be construed as limitations on the scope of any inventions or of what may be claimed, but rather as description of features specific to particular embodiments of particular inventions. Other embodiments are within the scope of the following claims. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Any operational step shown in broken lines in one or more flow diagrams illustrated herein are optional for purposes of the depicted embodiment.

In some cases, the actions recited in the claims may be performed in a different order and still achieve desirable results. In addition, the processes depicted in the accompanying figures do not necessarily require the particular order shown, or sequential order, to achieve desirable results unless described otherwise. In certain implementations, multitasking and parallel processing may be advantageous.

Accordingly, non-transitory computer-readable storage media may be configured to store firmware, one or more application programs, and/or other software, which include instructions and/or other computer-readable program code portions that may be executed to control processors of the components of server apparatus 2100 and/or client apparatus 2200 to implement various operations, including the examples shown herein. As such, a series of computer-readable program code portions may be embodied in one or more computer program products and may be used, with a device, database, and/or other programmable apparatus, to produce the machine-implemented processes discussed herein. It is also noted that all or some of the information discussed herein may be based on data that is received, generated and/or maintained by one or more components of the MI integration server 1812 and/or client device 1808. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of MI integration server 1812 and client device 1808.

The computing systems described herein may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with a client device or an admin user interacting with an admin device). Information/data generated at the client device may be received from the client device at the server.

The following example embodiments are provided, the numbering of which is not to be construed as designating levels of importance or relevance.

Example 1. An apparatus comprising one or more processors and at least one non-transitory computer-readable storage medium comprising instructions that, when executed by the one or more processors, cause the apparatus to receive, via a template selection interface element integrated into a website building system accessed using a client computing entity associated with an editing user identifier, a template selection representative of a first template; receive, via one or more model interaction (MI) interface elements integrated into the website building system accessed using the client computing entity associated with the editing user identifier, a natural language content object and one or more content selections; input, to a trained website editing machine learning (ML) model, one or more prompt data objects, the natural language content object, the one or more content selections, one or more website editing data objects, and corresponding descriptions of the one or more website editing data objects; generate, using output from the trained website editing ML model generated responsive to the one or more prompt data objects, a second template representing the first template modified with one or more new content objects generated based at least in part on the natural language content object, the one or more content selections, and the one or more website editing data objects; and transmit the second template to the client computing entity, wherein the second template is configured for rendering via a display device of the client computing entity.

Example 2. An apparatus according to the foregoing example, wherein the template selection is received via an application programming interface (API) and the second template is transmitted via the API.

Example 3. An apparatus according to any of the foregoing examples, wherein the one or more website editing data objects comprise one or more website building components.

Example 4. An apparatus according to any of the foregoing examples, wherein the natural language content object is processed prior to being included with the one or more prompt data objects.

Example 5. An apparatus according to any of the foregoing examples, wherein the one or more content selections comprise a business type and a business name.

Example 6. An apparatus according to any of the foregoing examples, wherein the one or more MI interface elements comprise an overlay, a frame, or a pop-up interface element within a website.

Example 7. An apparatus according to any of the foregoing examples, wherein the template selection interface element comprises a plurality of templates for selection.

Example 8. An apparatus according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 9. An apparatus according to any of the foregoing examples, wherein the one or more prompt data objects are generated based at least in part on a content outline associated with the website and comprising logical positioning of components within webpages of the website.

Example 10. An apparatus according to any of the foregoing examples, wherein the one or more new content objects comprise one or more of text or images.

Example 11. An apparatus according to any of the foregoing examples, wherein the images are received from an external image generation entity.

Example 12. An apparatus according to any of the foregoing examples, wherein the at least one non-transitory computer-readable storage medium comprises instructions that, when executed by the one or more processors, further cause the apparatus to: generate an input map data structure of the first template; and input the input map data structure to the trained website editing ML model.

Example 13. An apparatus according to any of the foregoing examples, wherein the one or more prompt data objects comprise a plurality of sections and a corresponding natural language description of sections of the plurality of sections.

Example 14. An apparatus according to any of the foregoing examples, wherein the at least one non-transitory computer-readable storage medium comprises instructions that, when executed by the one or more processors, further cause the apparatus to: perform quality assurance operations prior to transmitting the second template to the client computing entity.

Example 15. An apparatus according to any of the foregoing examples, wherein the quality assurance operations comprise confirming output from the trained website editing ML model conforms to a format in accordance with the first template.

Example 16. An apparatus according to any of the foregoing examples, wherein the quality assurance operations further comprise verifying content in sections of the first template meet one or more length thresholds.

Example 17. An apparatus according to any of the foregoing examples, wherein the quality assurance operations comprise generating one or more second prompt data objects to obtain corrected output from the trained website editing ML model.

Example 19. A least one non-transitory computer-readable storage medium comprising instructions that, when executed by one or more processors, cause the one or more processors to: receive, via a template selection interface element integrated into a website building system accessed using a client computing entity associated with an editing user identifier, a template selection representative of a first template; receive, via one or more model interaction (MI) interface elements integrated into the website building system accessed using the client computing entity associated with the editing user identifier, a natural language content object and one or more content selections; input, to a trained website editing machine learning (ML) model, one or more prompt data objects, the natural language content object, the one or more content selections, one or more website editing data objects, and corresponding descriptions of the one or more website editing data objects; generate, using output from the trained website editing ML model generated responsive to the one or more prompt data objects, a second template representing the first template modified with one or more new content objects generated based at least in part on the natural language content object, the one or more content selections, and the one or more website editing data objects; and transmit the second template to the client computing entity, wherein the second template is configured for rendering via a display device of the client computing entity.

Example 19. At least one non-transitory computer-readable storage medium according to the foregoing example, wherein the template selection is received via an application programming interface (API) and the second template is transmitted via the API.

Example 20. At least one non-transitory computer-readable storage medium according to any of the foregoing examples, wherein the one or more website editing data objects comprise one or more website building components.

Example 21. At least one non-transitory computer-readable storage medium according to any of the foregoing examples, wherein the natural language content object is processed prior to being included with the one or more prompt data objects.

Example 22. At least one non-transitory computer-readable storage medium according to any of the foregoing examples, wherein the one or more content selections comprise a business type and a business name.

Example 23. At least one non-transitory computer-readable storage medium according to any of the foregoing examples, wherein the one or more MI interface elements comprise an overlay, a frame, or a pop-up interface element within a website.

Example 24. At least one non-transitory computer-readable storage medium according to any of the foregoing examples, wherein the template selection interface element comprises a plurality of templates for selection.

Example 25. At least one non-transitory computer-readable storage medium according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 26. At least one non-transitory computer-readable storage medium according to any of the foregoing examples, wherein the one or more prompt data objects are generated based at least in part on a content outline associated with the website and comprising logical positioning of components within webpages of the website.

Example 27. At least one non-transitory computer-readable storage medium according to any of the foregoing examples, wherein the one or more new content objects comprise one or more of text or images.

Example 28. At least one non-transitory computer-readable storage medium according to any of the foregoing examples, wherein the images are received from an external image generation entity.

Example 29. At least one non-transitory computer-readable storage medium according to any of the foregoing examples, wherein the at least one non-transitory computer-readable storage medium comprises instructions that, when executed by the one or more processors, further cause the one or more processors to: generate an input map data structure of the first template; and input the input map data structure to the trained website editing ML model.

Example 30. At least one non-transitory computer-readable storage medium according to any of the foregoing examples, wherein the one or more prompt data objects comprise a plurality of sections and corresponding natural language descriptions of sections of the plurality of sections.

Example 31. At least one non-transitory computer-readable storage medium according to any of the foregoing examples, wherein the at least one non-transitory computer-readable storage medium comprises instructions that, when executed by the one or more processors, further cause the one or more processors to: perform quality assurance operations prior to transmitting the second template to the client computing entity.

Example 32. At least one non-transitory computer-readable storage medium according to any of the foregoing examples, wherein the quality assurance operations comprise confirming output from the trained website editing ML model conforms to a format in accordance with the first template.

Example 33. At least one non-transitory computer-readable storage medium according to any of the foregoing examples, wherein the quality assurance operations further comprise verifying content in sections of the first template meet one or more length thresholds.

Example 34. At least one non-transitory computer-readable storage medium according to any of the foregoing examples, wherein the quality assurance operations comprise generating one or more second prompt data objects to obtain corrected output from the trained website editing ML model.

Example 35. A computer-implemented method, comprising: receiving, via a template selection interface element integrated into a website building system accessed using a client computing entity associated with an editing user identifier, a template selection representative of a first template; receiving, via one or more model interaction (MI) interface elements integrated into the website building system accessed using the client computing entity associated with the editing user identifier, a natural language content object and one or more content selections; inputting, to a trained website editing machine learning (ML) model, one or more prompt data objects, the natural language content object, the one or more content selections, one or more website editing data objects, and corresponding descriptions of the one or more website editing data objects; generating, using output from the trained website editing ML model generated responsive to the one or more prompt data objects, a second template representing the first template modified with one or more new content objects generated based at least in part on the natural language content object, the one or more content selections, and the one or more website editing data objects; and transmitting the second template to the client computing entity, wherein the second template is configured for rendering via a display device of the client computing entity.

Example 36. A computer-implemented method according to the foregoing example, wherein the template selection is received via an application programming interface (API) and the second template is transmitted via the API.

Example 37. A computer-implemented method according to any of the foregoing examples, wherein the one or more website editing data objects comprise one or more website building components.

Example 38. A computer-implemented method according to any of the foregoing examples, wherein the natural language content object is processed prior to being included with the one or more prompt data objects.

Example 39. A computer-implemented method according to any of the foregoing examples, wherein the one or more content selections comprise a business type and a business name.

Example 40. A computer-implemented method according to any of the foregoing examples, wherein the one or more MI interface elements comprise an overlay, a frame, or a pop-up interface element within a website.

Example 41. A computer-implemented method according to any of the foregoing examples, wherein the template selection interface element comprises a plurality of templates for selection.

Example 42. A computer-implemented method according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 43. A computer-implemented method according to any of the foregoing examples, wherein the one or more prompt data objects are generated based at least in part on a content outline associated with the website and comprising logical positioning of components within webpages of the website.

Example 44. A computer-implemented method according to any of the foregoing examples, wherein the one or more new content objects comprise one or more of text or images.

Example 45. A computer-implemented method according to any of the foregoing examples, wherein the images are received from an external image generation entity.

Example 46. A computer-implemented method according to any of the foregoing examples, further comprising: generating an input map data structure of the first template; and inputting the input map data structure to the trained website editing ML model.

Example 47. A computer-implemented method according to any of the foregoing examples, wherein the one or more prompt data objects comprise a plurality of sections and corresponding natural language descriptions of sections of the plurality of sections.

Example 48. A computer-implemented method according to any of the foregoing examples, further comprising: performing quality assurance operations prior to transmitting the second template to the client computing entity.

Example 49. A computer-implemented method according to any of the foregoing examples, wherein the quality assurance operations comprise confirming output from the trained website editing ML model conforms to a format in accordance with the first template.

Example 50. A computer-implemented method according to any of the foregoing examples, wherein the quality assurance operations further comprise verifying content in sections of the first template meet one or more length thresholds.

Example 51. A computer-implemented method according to any of the foregoing examples, wherein the quality assurance operations comprise generating one or more second prompt data objects to obtain corrected output from the trained website editing ML model.

Example 52. An apparatus comprising one or more processors and at least one non-transitory computer-readable storage medium comprising instructions that, when executed by the one or more processors, cause the apparatus to: receive a template selection, a natural language content object, and one or more content selections; generate, based at least in part on the template selection and temporary content of the template selection, an input map data structure; input, to a trained website editing machine learning (ML) model, one or more prompt data objects, the input map data structure, and website editing data; obtain, from the trained website editing ML model, an output map data structure and one or more new content objects; perform one or more quality assurance operations based at least in part on the output map data structure and the one or more new content objects; generate a second template by replacing the temporary content of the template selection with the one or more new content objects; and transmit the second template to the client computing entity, wherein the second template is configured for rendering via a display device of the client computing entity.

Example 53. An apparatus according to the foregoing example, wherein generating the one or more new content objects comprises: generating, based at least in part on a first content prompt and using the trained website editing ML model, a text description of one or more images; generating, based at least in part on the text description, an API request configured for transmission to an external image generation entity; and receiving, from the external image generation entity, a new content object comprising one or more images.

Example 54. An apparatus according to any of the foregoing examples, wherein the quality assurance operations comprise confirming output from the trained website editing ML model conforms to a format in accordance with the template selection.

Example 55. An apparatus according to any of the foregoing examples, wherein the quality assurance operations further comprise verifying content in sections of the template selection meet one or more length thresholds.

Example 56. An apparatus according to any of the foregoing examples, wherein the quality assurance operations comprise generating one or more second prompt data objects to obtain corrected output from the trained website editing ML model.

Example 57. At least one non-transitory computer-readable storage medium comprising instructions that, when executed by one or more processors, cause the one or more processors to: receive a template selection, a natural language content object, and one or more content selections; generate, based at least in part on the template selection and temporary content of the template selection, an input map data structure; input, to a trained website editing machine learning (ML) model, one or more prompt data objects, the input map data structure, and website editing data; obtain, from the trained website editing ML model, an output map data structure and one or more new content objects; perform one or more quality assurance operations based at least in part on the output map data structure and the one or more new content objects; generate a second template by replacing the temporary content of the template selection with the one or more new content objects; and transmit the second template to the client computing entity, wherein the second template is configured for rendering via a display device of the client computing entity.

Example 58. At least one non-transitory computer-readable storage medium according to the foregoing example, wherein generating the one or more new content objects comprises: generating, based at least in part on a first content prompt and using the trained website editing ML model, a text description of one or more images; generating, based at least in part on the text description, an API request configured for transmission to an external image generation entity; and receiving, from the external image generation entity, a new content object comprising one or more images.

Example 59. At least one non-transitory computer-readable storage medium according to any of the foregoing examples, wherein the quality assurance operations comprise confirming output from the trained website editing ML model conforms to a format in accordance with the template selection.

Example 60. At least one non-transitory computer-readable storage medium according to any of the foregoing examples, wherein the quality assurance operations further comprise verifying content in sections of the template selection meet one or more length thresholds.

Example 61. At least one non-transitory computer-readable storage medium according to any of the foregoing examples, wherein the quality assurance operations comprise generating one or more second prompt data objects to obtain corrected output from the trained website editing ML model.

Example 62. A computer-implemented method, comprising: receiving a template selection, a natural language content object, and one or more content selections; generating, based at least in part on the template selection and temporary content of the template selection, an input map data structure; inputting, to a trained website editing machine learning (ML) model, one or more prompt data objects, the input map data structure, and website editing data; obtaining, from the trained website editing ML model, an output map data structure and one or more new content objects; performing one or more quality assurance operations based at least in part on the output map data structure and the one or more new content objects; generating a second template by replacing the temporary content of the template selection with the one or more new content objects; and transmitting the second template to the client computing entity, wherein the second template is configured for rendering via a display device of the client computing entity.

Example 63. A computer-implemented method according to the foregoing example, wherein generating the one or more new content objects comprises: generating, based at least in part on a first content prompt and using the trained website editing ML model, a text description of one or more images; generating, based at least in part on the text description, an API request configured for transmission to an external image generation entity; and receiving, from the external image generation entity, a new content object comprising one or more images.

Example 64. A computer-implemented method according to any of the foregoing examples, wherein the quality assurance operations comprise confirming output from the trained website editing ML model conforms to a format in accordance with the template selection.

Example 65. A computer-implemented method according to any of the foregoing examples, wherein the quality assurance operations further comprise verifying content in sections of the template selection meet one or more length thresholds.

Example 66. A computer-implemented method according to any of the foregoing examples, wherein the quality assurance operations comprise generating one or more second prompt data objects to obtain corrected output from the trained website editing ML model.

Example 67. An apparatus comprising one or more processors and at least one non-transitory computer-readable storage medium comprising instructions that, when executed by the one or more processors, cause the apparatus to: receive, via one or more model interaction (MI) interface elements integrated into a website building system accessed using a client computing entity associated with an editing user identifier, a natural language content object and one or more content selections; input, to a trained website editing machine learning (ML) model, one or more first prompt data objects, the natural language content object, and the one or more content selections, wherein the trained website editing ML model is configured to output, responsive to the one or more first prompt data objects, structural content for inclusion in a website under assembly using the website building system; responsive to receiving the structural content, input, to the trained website editing ML model, one or more second prompt data objects, wherein the trained website editing ML model is configured to output, responsive to the one or more second prompt data objects, theme content for inclusion in the website; responsive to receiving the theme content, input, to the trained website editing ML model, one or more third prompt data objects, wherein the trained website editing ML model is configured to output, responsive to the one or more third prompt data objects, one or more content objects for inclusion in the website; responsive to receiving the one or more content objects, generate the website based at least in part on the structural content and the one or more content objects; and transmit the website to the client computing entity, wherein the website is configured for rendering via a display device of the client computing entity.

Example 68. An apparatus according to the foregoing example, wherein the natural language content object and the one or more content selections are received via an application programming interface (API).

Example 69. An apparatus according to any of the foregoing examples, wherein the natural language content object is processed prior to being included with the one or more first prompt data objects.

Example 70. An apparatus according to any of the foregoing examples, wherein the one or more content selections comprise a business type and a business name.

Example 71. An apparatus according to any of the foregoing examples, wherein the one or more MI interface elements comprise an overlay, a frame, or a pop-up interface element within a website.

Example 72. An apparatus according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 73. An apparatus according to any of the foregoing examples, wherein the one or more first, second, and third prompt data objects are generated based at least in part on a content outline associated with the website and comprising logical positioning of components within webpages of the website.

Example 74. An apparatus according to any of the foregoing examples, wherein the one or more content objects comprise one or more of text or images.

Example 75. An apparatus according to any of the foregoing examples, wherein the images are received from an external image generation entity.

Example 76. An apparatus according to any of the foregoing examples, wherein the at least one non-transitory computer-readable storage medium comprises instructions that, when executed by the one or more processors, further cause the apparatus to: generate an input map data structure based at least in part on the structural content and the theme content; and input the input map data structure to the trained website editing ML model.

Example 77. An apparatus according to any of the foregoing examples, wherein the one or more first prompt data objects comprise a plurality of sections and corresponding natural language descriptions of sections of the plurality of sections.

Example 78. An apparatus according to any of the foregoing examples, wherein the one or more second prompt data objects comprise a plurality of themes and corresponding natural language descriptions of themes of the plurality of themes.

Example 79. An apparatus according to any of the foregoing examples, wherein the at least one non-transitory computer-readable storage medium comprises instructions that, when executed by the one or more processors, further cause the apparatus to: perform quality assurance operations prior to transmitting the website to the client computing entity.

Example 80. An apparatus according to any of the foregoing examples, wherein the quality assurance operations comprise confirming output from the trained website editing ML model conforms to a format in accordance with the input map data structure.

Example 81. An apparatus according to any of the foregoing examples, wherein the quality assurance operations further comprise verifying content in sections of the website meet one or more length thresholds.

Example 82. An apparatus according to any of the foregoing examples, wherein the quality assurance operations comprise generating one or more fourth prompt data objects to obtain corrected output from the trained website editing ML model.

Example 83. At least one non-transitory computer-readable storage medium comprising instructions that, when executed by one or more processors, cause the one or more processors to: receive, via one or more model interaction (MI) interface elements integrated into a website building system accessed using a client computing entity associated with an editing user identifier, a natural language content object and one or more content selections; input, to a trained website editing machine learning (ML) model, one or more first prompt data objects, the natural language content object, and the one or more content selections, wherein the trained website editing ML model is configured to output, responsive to the one or more first prompt data objects, structural content for inclusion in a website under assembly using the website building system; responsive to receiving the structural content, input, to the trained website editing ML model, one or more second prompt data objects, wherein the trained website editing ML model is configured to output, responsive to the one or more second prompt data objects, theme content for inclusion in the website; responsive to receiving the theme content, input, to the trained website editing ML model, one or more third prompt data objects, wherein the trained website editing ML model is configured to output, responsive to the one or more third prompt data objects, one or more content objects for inclusion in the website; responsive to receiving the one or more content objects, generate the website based at least in part on the structural content and the one or more content objects; and transmit the website to the client computing entity, wherein the website is configured for rendering via a display device of the client computing entity.

Example 84. At least one non-transitory computer-readable storage medium according to the foregoing example, wherein the natural language content object and the one or more content selections are received via an application programming interface (API).

Example 85. At least one non-transitory computer-readable storage medium according to any of the foregoing examples, wherein the natural language content object is processed prior to being included with the one or more first prompt data objects.

Example 86. At least one non-transitory computer-readable storage medium according to any of the foregoing examples, wherein the one or more content selections comprise a business type and a business name.

Example 87. At least one non-transitory computer-readable storage medium according to any of the foregoing examples, wherein the one or more MI interface elements comprise an overlay, a frame, or a pop-up interface element within a website.

Example 88. At least one non-transitory computer-readable storage medium according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 89. At least one non-transitory computer-readable storage medium according to any of the foregoing examples, wherein the one or more first, second, and third prompt data objects are generated based at least in part on a content outline associated with the website and comprising logical positioning of components within webpages of the website.

Example 90. At least one non-transitory computer-readable storage medium according to any of the foregoing examples, wherein the one or more content objects comprise one or more of text or images.

Example 91. At least one non-transitory computer-readable storage medium according to any of the foregoing examples, wherein the images are received from an external image generation entity.

Example 92. At least one non-transitory computer-readable storage medium according to any of the foregoing examples, wherein the at least one non-transitory computer-readable storage medium comprises instructions that, when executed by the one or more processors, further cause the apparatus to: generate an input map data structure based at least in part on the structural content and the theme content; and input the input map data structure to the trained website editing ML model.

Example 93. At least one non-transitory computer-readable storage medium according to any of the foregoing examples, wherein the one or more first prompt data objects comprise a plurality of sections and corresponding natural language descriptions of sections of the plurality of sections.

Example 94. At least one non-transitory computer-readable storage medium according to any of the foregoing examples, wherein the one or more second prompt data objects comprise a plurality of themes and corresponding natural language descriptions of themes of the plurality of themes.

Example 95. At least one non-transitory computer-readable storage medium according to any of the foregoing examples, wherein the at least one non-transitory computer-readable storage medium comprises instructions that, when executed by the one or more processors, further cause the one or more processors to: perform quality assurance operations prior to transmitting the website to the client computing entity.

Example 96. At least one non-transitory computer-readable storage medium according to any of the foregoing examples, wherein the quality assurance operations comprise confirming output from the trained website editing ML model conforms to a format in accordance with the input map data structure.

Example 97. At least one non-transitory computer-readable storage medium according to any of the foregoing examples, wherein the quality assurance operations further comprise verifying content in sections of the website meet one or more length thresholds.

Example 98. At least one non-transitory computer-readable storage medium according to any of the foregoing examples, wherein the quality assurance operations comprise generating one or more fourth prompt data objects to obtain corrected output from the trained website editing ML model.

Example 99. A computer-implemented method, comprising: receiving, via one or more model interaction (MI) interface elements integrated into a website building system accessed using a client computing entity associated with an editing user identifier, a natural language content object and one or more content selections; inputting, to a trained website editing machine learning (ML) model, one or more first prompt data objects, the natural language content object, and the one or more content selections, wherein the trained website editing ML model is configured to output, responsive to the one or more first prompt data objects, structural content for inclusion in a website under assembly using the website building system; responsive to receiving the structural content, inputting, to the trained website editing ML model, one or more second prompt data objects, wherein the trained website editing ML model is configured to output, responsive to the one or more second prompt data objects, theme content for inclusion in the website; responsive to receiving the theme content, inputting, to the trained website editing ML model, one or more third prompt data objects, wherein the trained website editing ML model is configured to output, responsive to the one or more third prompt data objects, one or more content objects for inclusion in the website; responsive to receiving the one or more content objects, generating the website based at least in part on the structural content and the one or more content objects; and transmitting the website to the client computing entity, wherein the website is configured for rendering via a display device of the client computing entity.

Example 100. A computer-implemented method according to the foregoing example, wherein the natural language content object and the one or more content selections are received via an application programming interface (API).

Example 101. A computer-implemented method according to any of the foregoing examples, wherein the natural language content object is processed prior to being included with the one or more first prompt data objects.

Example 102. A computer-implemented method according to any of the foregoing examples, wherein the one or more content selections comprise a business type and a business name.

Example 103. A computer-implemented method according to any of the foregoing examples, wherein the one or more MI interface elements comprise an overlay, a frame, or a pop-up interface element within a website.

Example 104. A computer-implemented method according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 105. A computer-implemented method according to any of the foregoing examples, wherein the one or more first, second, and third prompt data objects are generated based at least in part on a content outline associated with the website and comprising logical positioning of components within webpages of the website.

Example 106. A computer-implemented method according to any of the foregoing examples, wherein the one or more content objects comprise one or more of text or images.

Example 107. A computer-implemented method according to any of the foregoing examples, wherein the images are received from an external image generation entity.

Example 108. A computer-implemented method according to any of the foregoing examples, further comprising: generating an input map data structure based at least in part on the structural content and the theme content; and inputting the input map data structure to the trained website editing ML model.

Example 109. A computer-implemented method according to any of the foregoing examples, wherein the one or more first prompt data objects comprise a plurality of sections and corresponding natural language descriptions of sections of the plurality of sections.

Example 110. A computer-implemented method according to any of the foregoing examples, wherein the one or more second prompt data objects comprise a plurality of themes and corresponding natural language descriptions of themes of the plurality of themes.

Example 111. A computer-implemented method according to any of the foregoing examples, further comprising: performing quality assurance operations prior to transmitting the website to the client computing entity.

Example 112. A computer-implemented method according to any of the foregoing examples, wherein the quality assurance operations comprise confirming output from the trained website editing ML model conforms to a format in accordance with the input map data structure.

Example 113. A computer-implemented method according to any of the foregoing examples, wherein the quality assurance operations further comprise verifying content in sections of the website meet one or more length thresholds.

Example 114. A computer-implemented method according to any of the foregoing examples, wherein the quality assurance operations comprise generating one or more fourth prompt data objects to obtain corrected output from the trained website editing ML model.

Example 115. An apparatus comprising one or more processors and at least one non-transitory computer-readable storage medium comprising instructions that, when executed by the one or more processors, cause the apparatus to: receive a natural language content object and one or more content selections; input, to a trained website editing machine learning (ML) model, one or more first prompt data objects, the natural language content object, and the one or more content selections; obtain, from the trained website editing ML model, structural content for inclusion in a website under assembly using the website building system, wherein the one or more first prompt data objects comprise a plurality of sections and corresponding natural language descriptions of sections of the plurality of sections; input, to the trained website editing ML model, one or more second prompt data objects comprising a plurality of themes and corresponding natural language descriptions of themes of the plurality of themes; obtain, from the trained website editing ML model, theme content for inclusion in the website; generate, based at least in part on the structural content and the theme content, an input map data structure; input, to the trained website editing ML model, one or more third prompt data objects and the input map data structure; obtain, from the trained website editing ML model, one or more content objects for inclusion in the website; perform one or more quality assurance operations on the one or more content objects; generate the website based at least in part on the structural content, the theme content, and the one or more content objects; and transmit the website to the client computing entity, wherein the website is configured for rendering via a display device of the client computing entity.

Example 116. An apparatus according to the foregoing example, wherein the quality assurance operations comprise confirming output from the trained website editing ML model conforms to a format in accordance with the input map data structure.

Example 117. An apparatus according to any of the foregoing examples, wherein the quality assurance operations further comprise verifying content in sections of the website meet one or more length thresholds.

Example 118. An apparatus according to any of the foregoing examples, wherein the quality assurance operations comprise generating one or more fourth prompt data objects to obtain corrected output from the trained website editing ML model.

Example 119. At least one non-transitory computer-readable storage medium comprising instructions that, when executed by one or more processors, cause the one or more processors to: receive a natural language content object and one or more content selections; input, to a trained website editing machine learning (ML) model, one or more first prompt data objects, the natural language content object, and the one or more content selections; obtain, from the trained website editing ML model, structural content for inclusion in a website under assembly using the website building system, wherein the one or more first prompt data objects comprise a plurality of sections and corresponding natural language descriptions of sections of the plurality of sections; input, to the trained website editing ML model, one or more second prompt data objects comprising a plurality of themes and corresponding natural language descriptions of themes of the plurality of themes; obtain, from the trained website editing ML model, theme content for inclusion in the website; generate, based at least in part on the structural content and the theme content, an input map data structure; input, to the trained website editing ML model, one or more third prompt data objects and the input map data structure; obtain, from the trained website editing ML model, one or more content objects for inclusion in the website; perform one or more quality assurance operations on the one or more content objects; generate the website based at least in part on the structural content, the theme content, and the one or more content objects; and transmit the website to the client computing entity, wherein the website is configured for rendering via a display device of the client computing entity.

Example 120. At least one non-transitory computer-readable storage medium according to the foregoing example, wherein the quality assurance operations comprise confirming output from the trained website editing ML model conforms to a format in accordance with the input map data structure.

Example 121. At least one non-transitory computer-readable storage medium according to any of the foregoing examples, wherein the quality assurance operations further comprise verifying content in sections of the website meet one or more length thresholds.

Example 122. At least one non-transitory computer-readable storage medium according to any of the foregoing examples, wherein the quality assurance operations comprise generating one or more fourth prompt data objects to obtain corrected output from the trained website editing ML model.

Example 123. A computer-implemented method, comprising: receiving a natural language content object and one or more content selections; inputting, to a trained website editing machine learning (ML) model, one or more first prompt data objects, the natural language content object, and the one or more content selections; obtaining, from the trained website editing ML model, structural content for inclusion in a website under assembly using the website building system, wherein the one or more first prompt data objects comprise a plurality of sections and corresponding natural language descriptions of sections of the plurality of sections; inputting, to the trained website editing ML model, one or more second prompt data objects comprising a plurality of themes and corresponding natural language descriptions of themes of the plurality of themes; obtaining, from the trained website editing ML model, theme content for inclusion in the website; generating, based at least in part on the structural content and the theme content, an input map data structure; inputting, to the trained website editing ML model, one or more third prompt data objects and the input map data structure; obtaining, from the trained website editing ML model, one or more content objects for inclusion in the website; performing one or more quality assurance operations on the one or more content objects; generating the website based at least in part on the structural content, the theme content, and the one or more content objects; and transmitting the website to the client computing entity, wherein the website is configured for rendering via a display device of the client computing entity.

Example 124. A computer-implemented method according to the foregoing example, wherein the quality assurance operations comprise confirming output from the trained website editing ML model conforms to a format in accordance with the input map data structure.

Example 125. A computer-implemented method according to any of the foregoing examples, wherein the quality assurance operations further comprise verifying content in sections of the website meet one or more length thresholds.

Example 126. A computer-implemented method according to any of the foregoing examples, wherein the quality assurance operations comprise generating one or more fourth prompt data objects to obtain corrected output from the trained website editing ML model.

Example 127. An apparatus comprising one or more processors and at least one non-transitory computer-readable storage medium comprising instructions that, when executed by the one or more processors, cause the apparatus to: receive, via a site modification interface element integrated into a website building system accessed using a client computing entity associated with an editing user identifier, a site modification selection representative of a first site modification; receive, via one or more model interaction (MI) interface elements integrated into the website building system accessed using the client computing entity associated with the editing user identifier, a natural language content object and one or more content selections; input, to a trained website editing machine learning (ML) model, one or more prompt data objects, the natural language content object, the one or more content selections, and the first site modification; generate, using output from the trained website editing ML model generated responsive to the one or more prompt data objects, a plurality of site modification objects comprising one or more new content objects generated based at least in part on the natural language content object, the one or more content selections, and the first site modification; transmit the plurality of site modification objects to the client computing entity, wherein the plurality of site modification objects is configured for rendering via the display device of the client computing entity; and responsive to receiving a selection of a site modification object, add the site modification object to a website under assembly using the website building system and associated with the editing user identifier.

Example 128. An apparatus according to the foregoing example, wherein the site modification selection is received via an application programming interface (API), the plurality of site modification objects is transmitted via the API, and the selection of the site modification object is received via the API.

Example 129. An apparatus according to any of the foregoing examples, wherein the natural language content object is processed prior to being included with the one or more prompt data objects.

Example 130. An apparatus according to any of the foregoing examples, wherein the one or more content selections comprise a business type and a business name.

Example 131. An apparatus according to any of the foregoing examples, wherein the one or more MI interface elements comprise an overlay, a frame, or a pop-up interface element within a website.

Example 132. An apparatus according to any of the foregoing examples, wherein the site modification interface element comprises a plurality of site modifications for selection.

Example 133. An apparatus according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 134. An apparatus according to any of the foregoing examples, wherein the one or more prompt data objects are generated based at least in part on a content outline associated with the website and comprising logical positioning of components within webpages of the website.

Example 135. An apparatus according to any of the foregoing examples, wherein the at least one non-transitory computer-readable storage medium comprises instructions that, when executed by the one or more processors, further cause the apparatus to: generate an input map data structure of a first website building component associated with the first site modification; and input the input map data structure to the trained website editing ML model.

Example 136. An apparatus according to any of the foregoing examples, wherein the one or more prompt data objects comprise a plurality of sections and corresponding natural language descriptions of sections of the plurality of sections.

Example 137. An apparatus according to any of the foregoing examples, wherein the at least one non-transitory computer-readable storage medium comprises instructions that, when executed by the one or more processors, further cause the apparatus to: perform quality assurance operations prior to transmitting the plurality of site modification objects to the client computing entity.

Example 138. An apparatus according to any of the foregoing examples, wherein the quality assurance operations comprise confirming output from the trained website editing ML model conforms to a format in accordance with the input map data structure.

Example 139. An apparatus according to any of the foregoing examples, wherein the quality assurance operations further comprise verifying content in the plurality of site modification objects meets one or more length thresholds.

Example 140. An apparatus according to any of the foregoing examples, wherein the quality assurance operations comprise generating one or more second prompt data objects to obtain corrected output from the trained website editing ML model.

Example 141. At least one non-transitory computer-readable storage medium comprising instructions that, when executed by one or more processors, cause the one or more processors to: receive, via a site modification interface element integrated into a website building system accessed using a client computing entity associated with an editing user identifier, a site modification selection representative of a first site modification; receive, via one or more model interaction (MI) interface elements integrated into the website building system accessed using the client computing entity associated with the editing user identifier, a natural language content object and one or more content selections; input, to a trained website editing machine learning (ML) model, one or more prompt data objects, the natural language content object, the one or more content selections, and the first site modification; generate, using output from the trained website editing ML model generated responsive to the one or more prompt data objects, a plurality of site modification objects comprising one or more new content objects generated based at least in part on the natural language content object, the one or more content selections, and the first site modification; transmit the plurality of site modification objects to the client computing entity, wherein the plurality of site modification objects is configured for rendering via the display device of the client computing entity; and responsive to receiving a selection of a site modification object, add the site modification object to a website under assembly using the website building system and associated with the editing user identifier.

Example 142. At least one non-transitory computer-readable storage medium according to the foregoing example, wherein the site modification selection is received via an application programming interface (API), the plurality of site modification objects is transmitted via the API, and the selection of the site modification object is received via the API.

Example 143. At least one non-transitory computer-readable storage medium according to any of the foregoing examples, wherein the natural language content object is processed prior to being included with the one or more prompt data objects.

Example 144. At least one non-transitory computer-readable storage medium according to any of the foregoing examples, wherein the one or more content selections comprise a business type and a business name.

Example 145. At least one non-transitory computer-readable storage medium according to any of the foregoing examples, wherein the one or more MI interface elements comprise an overlay, a frame, or a pop-up interface element within a website.

Example 146. At least one non-transitory computer-readable storage medium according to any of the foregoing examples, wherein the site modification interface element comprises a plurality of site modifications for selection.

Example 147. At least one non-transitory computer-readable storage medium according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 148. At least one non-transitory computer-readable storage medium according to any of the foregoing examples, wherein the one or more prompt data objects are generated based at least in part on a content outline associated with the website and comprising logical positioning of components within webpages of the website.

Example 149. At least one non-transitory computer-readable storage medium according to any of the foregoing examples, wherein the at least one non-transitory computer-readable storage medium comprises instructions that, when executed by the one or more processors, further cause the one or more processors to: generate an input map data structure of a first website building component associated with the first site modification; and input the input map data structure to the trained website editing ML model.

Example 150. At least one non-transitory computer-readable storage medium according to any of the foregoing examples, wherein the one or more prompt data objects comprise a plurality of sections and corresponding natural language descriptions of sections of the plurality of sections.

Example 151. At least one non-transitory computer-readable storage medium according to any of the foregoing examples, wherein the at least one non-transitory computer-readable storage medium comprises instructions that, when executed by the one or more processors, further cause the one or more processors to: perform quality assurance operations prior to transmitting the plurality of site modification objects to the client computing entity.

Example 152. At least one non-transitory computer-readable storage medium according to any of the foregoing examples, wherein the quality assurance operations comprise confirming output from the trained website editing ML model conforms to a format in accordance with the input map data structure.

Example 153. At least one non-transitory computer-readable storage medium according to any of the foregoing examples, wherein the quality assurance operations further comprise verifying content in the plurality of site modification objects meets one or more length thresholds.

Example 154. At least one non-transitory computer-readable storage medium according to any of the foregoing examples, wherein the quality assurance operations comprise generating one or more second prompt data objects to obtain corrected output from the trained website editing ML model.

Example 155. A computer-implemented method, comprising: receiving, via a site modification interface element integrated into a website building system accessed using a client computing entity associated with an editing user identifier, a site modification selection representative of a first site modification; receiving, via one or more model interaction (MI) interface elements integrated into the website building system accessed using the client computing entity associated with the editing user identifier, a natural language content object and one or more content selections; inputting, to a trained website editing machine learning (ML) model, one or more prompt data objects, the natural language content object, the one or more content selections, and the first site modification; generating, using output from the trained website editing ML model generated responsive to the one or more prompt data objects, a plurality of site modification objects comprising one or more new content objects generated based at least in part on the natural language content object, the one or more content selections, and the first site modification; transmitting the plurality of site modification objects to the client computing entity, wherein the plurality of site modification objects is configured for rendering via the display device of the client computing entity; and responsive to receiving a selection of a site modification object, adding the site modification object to a website under assembly using the website building system and associated with the editing user identifier.

Example 156. A computer-implemented method according to the foregoing example, wherein the site modification selection is received via an application programming interface (API), the plurality of site modification objects is transmitted via the API, and the selection of the site modification object is received via the API.

Example 157. A computer-implemented method according to any of the foregoing examples, wherein the natural language content object is processed prior to being included with the one or more prompt data objects.

Example 158. A computer-implemented method according to any of the foregoing examples, wherein the one or more content selections comprise a business type and a business name.

Example 159. A computer-implemented method according to any of the foregoing examples, wherein the one or more MI interface elements comprise an overlay, a frame, or a pop-up interface element within a website.

Example 160. A computer-implemented method according to any of the foregoing examples, wherein the site modification interface element comprises a plurality of site modifications for selection.

Example 161. A computer-implemented method according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 162. A computer-implemented method according to any of the foregoing examples, wherein the one or more prompt data objects are generated based at least in part on a content outline associated with the website and comprising logical positioning of components within webpages of the website.

Example 163. A computer-implemented method according to any of the foregoing examples, further comprising: generating an input map data structure of a first website building component associated with the first site modification; and inputting the input map data structure to the trained website editing ML model.

Example 164. A computer-implemented method according to any of the foregoing examples, wherein the one or more prompt data objects comprise a plurality of sections and corresponding natural language descriptions of sections of the plurality of sections.

Example 165. A computer-implemented method according to any of the foregoing examples, further comprising: performing quality assurance operations prior to transmitting the plurality of site modification objects to the client computing entity.

Example 166. A computer-implemented method according to any of the foregoing examples, wherein the quality assurance operations comprise confirming output from the trained website editing ML model conforms to a format in accordance with the input map data structure.

Example 167. A computer-implemented method according to any of the foregoing examples, wherein the quality assurance operations further comprise verifying content in the plurality of site modification objects meets one or more length thresholds.

Example 168. A computer-implemented method according to any of the foregoing examples, wherein the quality assurance operations comprise generating one or more second prompt data objects to obtain corrected output from the trained website editing ML model.

Example 169. An apparatus comprising one or more processors and at least one non-transitory computer-readable storage medium comprising instructions that, when executed by the one or more processors, cause the apparatus to: receive a site modification selection representative of a first site modification, a natural language content object, and one or more content selections; generate, based at least in part on the first site modification and an associated website building component, an input map data structure; input, to a trained website editing machine learning (ML) model, one or more prompt data objects and the input map data structure; obtain, from the trained website editing ML model, an output map data structure; perform one or more quality assurance operations based at least in part on the output map data structure; generate, based at least in part on the output map data structure, a plurality of site modification objects comprising one or more new content objects; transmit the plurality of site modification objects to the client computing entity for rendering via a display device of the client computing entity; and responsive to receiving a selection of a site modification object, add the site modification object to a website under assembly using the website building system and associated with the editing user identifier.

Example 170. An apparatus according to the foregoing example, wherein generating the one or more new content objects comprises: generating, based at least in part on a first content prompt and using the trained website editing ML model, a text description of one or more images; generating, based at least in part on the text description, an API request configured for transmission to an external image generation entity; and receiving, from the external image generation entity, a new content object comprising one or more images.

Example 171. An apparatus according to any of the foregoing examples, wherein the quality assurance operations comprise confirming output from the trained website editing ML model conforms to a format in accordance with the input map data structure.

Example 172. An apparatus according to any of the foregoing examples, wherein the quality assurance operations further comprise verifying content in the plurality of site modification objects meets one or more length thresholds.

Example 173. An apparatus according to any of the foregoing examples, wherein the quality assurance operations comprise generating one or more second prompt data objects to obtain corrected output from the trained website editing ML model.

Example 174. At least one non-transitory computer-readable storage medium comprising instructions that, when executed by one or more processors, cause the one or more processors to: receive a site modification selection representative of a first site modification, a natural language content object, and one or more content selections; generate, based at least in part on the first site modification and an associated website building component, an input map data structure; input, to a trained website editing machine learning (ML) model, one or more prompt data objects and the input map data structure; obtain, from the trained website editing ML model, an output map data structure; perform one or more quality assurance operations based at least in part on the output map data structure; generate, based at least in part on the output map data structure, a plurality of site modification objects comprising one or more new content objects; transmit the plurality of site modification objects to the client computing entity for rendering via a display device of the client computing entity; and responsive to receiving a selection of a site modification object, add the site modification object to a website under assembly using the website building system and associated with the editing user identifier.

Example 175. At least one non-transitory computer-readable storage medium according to the foregoing example, wherein generating the one or more new content objects comprises: generating, based at least in part on a first content prompt and using the trained website editing ML model, a text description of one or more images; generating, based at least in part on the text description, an API request configured for transmission to an external image generation entity; and receiving, from the external image generation entity, a new content object comprising one or more images.

Example 176. At least one non-transitory computer-readable storage medium according to any of the foregoing examples, wherein the quality assurance operations comprise confirming output from the trained website editing ML model conforms to a format in accordance with the input map data structure.

Example 177. At least one non-transitory computer-readable storage medium according to any of the foregoing examples, wherein the quality assurance operations further comprise verifying content in the plurality of site modification objects meets one or more length thresholds.

Example 178. At least one non-transitory computer-readable storage medium according to any of the foregoing examples, wherein the quality assurance operations comprise generating one or more second prompt data objects to obtain corrected output from the trained website editing ML model.

Example 179. A computer-implemented method, comprising: receiving a site modification selection representative of a first site modification, a natural language content object, and one or more content selections; generating, based at least in part on the first site modification and an associated website building component, an input map data structure; inputting, to a trained website editing machine learning (ML) model, one or more prompt data objects and the input map data structure; obtaining, from the trained website editing ML model, an output map data structure; performing one or more quality assurance operations based at least in part on the output map data structure; generating, based at least in part on the output map data structure, a plurality of site modification objects comprising one or more new content objects; transmitting the plurality of site modification objects to the client computing entity for rendering via a display device of the client computing entity; and responsive to receiving a selection of a site modification object, adding the site modification object to a website under assembly using the website building system and associated with the editing user identifier.

Example 180. A computer-implemented method according to the foregoing example, wherein generating the one or more new content objects comprises: generating, based at least in part on a first content prompt and using the trained website editing ML model, a text description of one or more images; generating, based at least in part on the text description, an API request configured for transmission to an external image generation entity; and receiving, from the external image generation entity, a new content object comprising one or more images.

Example 181. A computer-implemented method according to any of the foregoing examples, wherein the quality assurance operations comprise confirming output from the trained website editing ML model conforms to a format in accordance with the input map data structure.

Example 182. A computer-implemented method according to any of the foregoing examples, wherein the quality assurance operations further comprise verifying content in the plurality of site modification objects meets one or more length thresholds.

Example 183. A computer-implemented method according to any of the foregoing examples, wherein the quality assurance operations comprise generating one or more second prompt data objects to obtain corrected output from the trained website editing ML model.

Example 184. An apparatus comprising one or more processors and at least one non-transitory computer-readable storage medium comprising instructions that, when executed by the one or more processors, cause the apparatus to: receive, via a site modification interface element integrated into a website building system accessed using a client computing entity associated with an editing user identifier, a site modification selection representative of a first site modification comprising one or more target components; extract, from an existing website building component, one or more content objects, wherein the one or more content objects comprise one or more of natural language content objects or content selections; input, to a trained website editing machine learning (ML) model, one or more prompt data objects, the one or more content objects, and the first site modification; generate, using output from the trained website editing ML model generated responsive to the one or more prompt data objects, a new website building component comprising one or more new content objects generated based at least in part on the one or more content objects, the first site modification, and a structure of the one or more target components; transmit the new website building component to the client computing entity, wherein the new website building component is configured for rendering via the display device of the client computing entity; and responsive to receiving an indication of selection of the new website building component, add the new website building component to a website under assembly using the website building system and associated with the editing user identifier.

Example 185. An apparatus according to the foregoing example, wherein the site modification selection is received via an application programming interface (API), the new website building component is transmitted via the API, and the selection of the new website building component is received via the API.

Example 186. An apparatus according to any of the foregoing examples, wherein the natural language content objects are processed prior to being included with the one or more prompt data objects.

Example 187. An apparatus according to any of the foregoing examples, wherein the content selections comprise a business type and a business name.

Example 188. An apparatus according to any of the foregoing examples, wherein the site modification interface element comprises a plurality of site modifications for selection.

Example 189. An apparatus according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 190. An apparatus according to any of the foregoing examples, wherein the one or more prompt data objects are generated based at least in part on a content outline associated with the website and comprising logical positioning of components within webpages of the website.

Example 191. An apparatus according to any of the foregoing examples, wherein the new website building component comprises one or more content objects comprising one or more of text or images.

Example 192. An apparatus according to any of the foregoing examples, wherein the images are received from an external image generation entity.

Example 193. An apparatus according to any of the foregoing examples, wherein the at least one non-transitory computer-readable storage medium comprises instructions that, when executed by the one or more processors, further cause the apparatus to: generate an input map data structure based at least in part on the one or more target components; and input the input map data structure to the trained website editing ML model.

Example 194. An apparatus according to any of the foregoing examples, wherein the one or more first prompt data objects comprise a plurality of sections and a corresponding natural language description of sections of the plurality of sections.

Example 195. An apparatus according to any of the foregoing examples, wherein the at least one non-transitory computer-readable storage medium comprises instructions that, when executed by the one or more processors, further cause the apparatus to: perform quality assurance operations prior to transmitting the new website building component to the client computing entity.

Example 196. An apparatus according to any of the foregoing examples, wherein the quality assurance operations comprise confirming output from the trained website editing ML model conforms to a format in accordance with the input map data structure.

Example 197. An apparatus according to any of the foregoing examples, wherein the quality assurance operations further comprise verifying content in sections of the new website building component meets one or more length thresholds.

Example 198. An apparatus according to any of the foregoing examples, wherein the quality assurance operations comprise generating one or more second prompt data objects to obtain corrected output from the trained website editing ML model.

Example 199. At least one non-transitory computer-readable storage medium comprising instructions that, when executed by one or more processors, cause the one or more processors to: receive, via a site modification interface element integrated into a website building system accessed using a client computing entity associated with an editing user identifier, a site modification selection representative of a first site modification comprising one or more target components; extract, from an existing website building component, one or more content objects, wherein the one or more content objects comprise one or more of natural language content objects or content selections; input, to a trained website editing machine learning (ML) model, one or more prompt data objects, the one or more content objects, and the first site modification; generate, using output from the trained website editing ML model generated responsive to the one or more prompt data objects, a new website building component comprising one or more new content objects generated based at least in part on the one or more content objects, the first site modification, and a structure of the one or more target components; transmit the new website building component to the client computing entity, wherein the new website building component is configured for rendering via the display device of the client computing entity; and responsive to receiving an indication of selection of the new website building component, add the new website building component to a website under assembly using the website building system and associated with the editing user identifier.

Example 200. At least one non-transitory computer-readable medium according to the foregoing example, wherein the site modification selection is received via an application programming interface (API), the new website building component is transmitted via the API, and the selection of the new website building component is received via the API.

Example 201. At least one non-transitory computer-readable medium according to any of the foregoing examples, wherein the natural language content objects are processed prior to being included with the one or more prompt data objects.

Example 202. At least one non-transitory computer-readable medium according to any of the foregoing examples, wherein the content selections comprise a business type and a business name.

Example 203. At least one non-transitory computer-readable medium according to any of the foregoing examples, wherein the site modification interface element comprises a plurality of site modifications for selection.

Example 204. At least one non-transitory computer-readable medium according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 205. At least one non-transitory computer-readable medium according to any of the foregoing examples, wherein the one or more prompt data objects are generated based at least in part on a content outline associated with the website and comprising logical positioning of components within webpages of the website.

Example 206. At least one non-transitory computer-readable medium according to any of the foregoing examples, wherein the new website building component comprises one or more content objects comprising one or more of text or images.

Example 207. At least one non-transitory computer-readable medium according to any of the foregoing examples, wherein the images are received from an external image generation entity.

Example 208. At least one non-transitory computer-readable medium according to any of the foregoing examples, wherein the at least one non-transitory computer-readable storage medium comprises instructions that, when executed by the one or more processors, further cause the one or more processors to: generate an input map data structure based at least in part on the one or more target components; and input the input map data structure to the trained website editing ML model.

Example 209. At least one non-transitory computer-readable medium according to any of the foregoing examples, wherein the one or more first prompt data objects comprise a plurality of sections and a corresponding natural language description of sections of the plurality of sections.

Example 210. At least one non-transitory computer-readable medium according to any of the foregoing examples, wherein the at least one non-transitory computer-readable storage medium comprises instructions that, when executed by the one or more processors, further cause the one or more processors to: perform quality assurance operations prior to transmitting the new website building component to the client computing entity.

Example 211. At least one non-transitory computer-readable medium according to any of the foregoing examples, wherein the quality assurance operations comprise confirming output from the trained website editing ML model conforms to a format in accordance with the input map data structure.

Example 212. At least one non-transitory computer-readable medium according to any of the foregoing examples, wherein the quality assurance operations further comprise verifying content in sections of the new website building component meets one or more length thresholds.

Example 213. At least one non-transitory computer-readable medium according to any of the foregoing examples, wherein the quality assurance operations comprise generating one or more second prompt data objects to obtain corrected output from the trained website editing ML model.

Example 214. A computer-implemented method, comprising: receiving, via a site modification interface element integrated into a website building system accessed using a client computing entity associated with an editing user identifier, a site modification selection representative of a first site modification comprising one or more target components; extracting, from an existing website building component, one or more content objects, wherein the one or more content objects comprise one or more of natural language content objects or content selections; inputting, to a trained website editing machine learning (ML) model, one or more prompt data objects, the one or more content objects, and the first site modification; generating, using output from the trained website editing ML model generated responsive to the one or more prompt data objects, a new website building component comprising one or more new content objects generated based at least in part on the one or more content objects, the first site modification, and a structure of the one or more target components; transmitting the new website building component to the client computing entity, wherein the new website building component is configured for rendering via the display device of the client computing entity; and responsive to receiving an indication of selection of the new website building component, adding the new website building component to a website under assembly using the website building system and associated with the editing user identifier.

Example 215. A computer-implemented method according to the foregoing example, wherein the site modification selection is received via an application programming interface (API), the new website building component is transmitted via the API, and the selection of the new website building component is received via the API.

Example 216. A computer-implemented method according to any of the foregoing examples, wherein the natural language content objects are processed prior to being included with the one or more prompt data objects.

Example 217. A computer-implemented method according to any of the foregoing examples, wherein the content selections comprise a business type and a business name.

Example 218. A computer-implemented method according to any of the foregoing examples, wherein the site modification interface element comprises a plurality of site modifications for selection.

Example 219. A computer-implemented method according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 220. A computer-implemented method according to any of the foregoing examples, wherein the one or more prompt data objects are generated based at least in part on a content outline associated with the website and comprising logical positioning of components within webpages of the website.

Example 221. A computer-implemented method according to any of the foregoing examples, wherein the new website building component comprises one or more content objects comprising one or more of text or images.

Example 222. A computer-implemented method according to any of the foregoing examples, wherein the images are received from an external image generation entity.

Example 223. A computer-implemented method according to any of the foregoing examples, further comprising: generating an input map data structure based at least in part on the one or more target components; and inputting the input map data structure to the trained website editing ML model.

Example 224. A computer-implemented method according to any of the foregoing examples, wherein the one or more first prompt data objects comprise a plurality of sections and a corresponding natural language description of sections of the plurality of sections.

Example 225. A computer-implemented method according to any of the foregoing examples, further comprising: performing quality assurance operations prior to transmitting the new website building component to the client computing entity.

Example 226. A computer-implemented method according to any of the foregoing examples, wherein the quality assurance operations comprise confirming output from the trained website editing ML model conforms to a format in accordance with the input map data structure.

Example 227. A computer-implemented method according to any of the foregoing examples, wherein the quality assurance operations further comprise verifying content in sections of the new website building component meets one or more length thresholds.

Example 228. A computer-implemented method according to any of the foregoing examples, wherein the quality assurance operations comprise generating one or more second prompt data objects to obtain corrected output from the trained website editing ML model.

Example 229. An apparatus comprising one or more processors and at least one non-transitory computer-readable storage medium comprising instructions that, when executed by the one or more processors, cause the apparatus to: extract, from an existing website building component and based at least in part on a received site modification selection, one or more content objects, wherein the one or more content objects comprise one or more of natural language content objects or content selections; generate, based at least in part on the one or more target components, an input map data structure; input, to a trained website editing machine learning (ML) model, one or more prompt data objects, the one or more content objects, and the input map data structure, wherein the one or more prompt data objects comprise a plurality of sections and corresponding natural language descriptions of sections of the plurality of sections; obtain, from the trained website editing ML model, an output map data structure; perform one or more quality assurance operation based on the output map data structure; generate, based at least in part on the output map data structure and the one or more content objects, a new website building component comprising one or more new content objects; transmit the new website building component to the client computing entity, wherein the new website building component is configured for rendering via the display device of the client computing entity; and add the new website building component to a website under assembly using the website building system and associated with the editing user identifier.

Example 230. An apparatus according to the foregoing example, wherein the quality assurance operations comprise confirming output from the trained website editing ML model conforms to a format in accordance with the input map data structure.

Example 231. An apparatus according to any of the foregoing examples, wherein the quality assurance operations further comprise verifying content in sections of the new website building component meets one or more length thresholds.

Example 232. An apparatus according to any of the foregoing examples, wherein the quality assurance operations comprise generating one or more second prompt data objects to obtain corrected output from the trained website editing ML model.

Example 233. At least one non-transitory computer-readable storage medium comprising instructions that, when executed by one or more processors, cause the one or more processors to: extract, from an existing website building component and based at least in part on a received site modification selection, one or more content objects, wherein the one or more content objects comprise one or more of natural language content objects or content selections; generate, based at least in part on the one or more target components, an input map data structure; input, to a trained website editing machine learning (ML) model, one or more prompt data objects, the one or more content objects, and the input map data structure, wherein the one or more prompt data objects comprise a plurality of sections and corresponding natural language descriptions of sections of the plurality of sections; obtain, from the trained website editing ML model, an output map data structure; perform one or more quality assurance operation based on the output map data structure; generate, based at least in part on the output map data structure and the one or more content objects, a new website building component comprising one or more new content objects; transmit the new website building component to the client computing entity, wherein the new website building component is configured for rendering via the display device of the client computing entity; and add the new website building component to a website under assembly using the website building system and associated with the editing user identifier.

Example 234. At least one non-transitory computer-readable storage medium according to the foregoing example, wherein the quality assurance operations comprise confirming output from the trained website editing ML model conforms to a format in accordance with the input map data structure.

Example 235. At least one non-transitory computer-readable storage medium according to any of the foregoing examples, wherein the quality assurance operations further comprise verifying content in sections of the new website building component meets one or more length thresholds.

Example 236. At least one non-transitory computer-readable storage medium according to any of the foregoing examples, wherein the quality assurance operations comprise generating one or more second prompt data objects to obtain corrected output from the trained website editing ML model.

Example 237. A computer-implemented method, comprising: extracting, from an existing website building component and based at least in part on a received site modification selection, one or more content objects, wherein the one or more content objects comprise one or more of natural language content objects or content selections; generating, based at least in part on the one or more target components, an input map data structure; inputting, to a trained website editing machine learning (ML) model, one or more prompt data objects, the one or more content objects, and the input map data structure, wherein the one or more prompt data objects comprise a plurality of sections and corresponding natural language descriptions of sections of the plurality of sections; obtaining, from the trained website editing ML model, an output map data structure; performing one or more quality assurance operation based on the output map data structure; generating, based at least in part on the output map data structure and the one or more content objects, a new website building component comprising one or more new content objects; transmitting the new website building component to the client computing entity, wherein the new website building component is configured for rendering via the display device of the client computing entity; and adding the new website building component to a website under assembly using the website building system and associated with the editing user identifier.

Example 238. A computer-implemented method according to the foregoing example, wherein the quality assurance operations comprise confirming output from the trained website editing ML model conforms to a format in accordance with the input map data structure.

Example 239. A computer-implemented method according to any of the foregoing examples, wherein the quality assurance operations further comprise verifying content in sections of the new website building component meets one or more length thresholds.

Example 240. A computer-implemented method according to any of the foregoing examples, wherein the quality assurance operations comprise generating one or more second prompt data objects to obtain corrected output from the trained website editing ML model.

Example 241. An apparatus comprising one or more processors and at least one non-transitory computer-readable storage medium comprising instructions that, when executed by the one or more processors, cause the apparatus to: receive, via one or more extraction engine interaction (EEI) interface elements integrated into a website building system accessed using a client computing entity associated with an editing user identifier, one or more digital objects; generate, using a trained extraction model, a canonical representation of the one or more digital objects, wherein the canonical representation comprises one or more of visual components, functional components, or component properties of the one or more digital objects; generate, based at least in part on the canonical representation of the one or more digital objects, a website comprising one or more webpages comprising one or more content objects selected in accordance with the canonical representation of the one or more digital objects; and transmit the website to the client computing entity, wherein the website is configured for rendering via a display device of the client computing entity.

Example 242. An apparatus according to the foregoing example, wherein the one or more digital objects are received via an application programming interface (API).

Example 243. An apparatus according to any of the foregoing examples, wherein the trained extraction model applies feature extraction to generate the canonical representation of the one or more digital objects.

Example 244. An apparatus according to any of the foregoing examples, wherein the one or more digital objects comprise one or more text files, image files, video files, URLs, websites, portions of websites, or audio files.

Example 245. An apparatus according to any of the foregoing examples, wherein the EEI interface element is one of a frame within a webpage, an overlay, or a pop-up.

Example 246. An apparatus according to any of the foregoing examples, wherein generating the website comprises: inputting, to a trained website editing machine learning (ML) model, one or more second prompt data objects and a feature set generated based at least in part on the canonical representation, wherein the one or more second prompt data objects comprise a plurality of website building components and respective descriptions of the plurality of website building components; and responsive to confirming quality of an output of the trained website ML model, generating the website, based at least in part on the output of the trained website ML model.

Example 247. An apparatus according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 248. An apparatus according to any of the foregoing examples wherein the trained website editing ML model is configured to generate output responsive to one or more prompt data objects.

Example 249. An apparatus according to any of the foregoing examples, wherein the one or more prompt data objects are generated based at least in part on features extracted from the one or more digital objects.

Example 250. An apparatus according to any of the foregoing examples, wherein the one or more prompt data objects are further generated based at least in part on a plurality of website building components and respective descriptions of the plurality of website building components.

Example 251. An apparatus according to any of the foregoing examples, wherein the one or more content objects comprise one or more of text or images.

Example 252. An apparatus according to any of the foregoing examples, wherein the images are received from an external image generation entity.

Example 253. At least one non-transitory computer-readable storage medium comprising instructions that, when executed by one or more processors, cause the one or more processors to: receive, via one or more extraction engine interaction (EEI) interface elements integrated into a website building system accessed using a client computing entity associated with an editing user identifier, one or more digital objects; generate, using a trained extraction model, a canonical representation of the one or more digital objects, wherein the canonical representation comprises one or more of visual components, functional components, or component properties of the one or more digital objects; generate, based at least in part on the canonical representation of the one or more digital objects, a website comprising one or more webpages comprising one or more content objects selected in accordance with the canonical representation of the one or more digital objects; and transmit the website to the client computing entity, wherein the website is configured for rendering via a display device of the client computing entity.

Example 254. At least one non-transitory computer-readable storage medium according to the foregoing example, wherein the one or more digital objects are received via an application programming interface (API).

Example 255. At least one non-transitory computer-readable storage medium according to any of the foregoing examples, wherein the trained extraction model applies feature extraction to generate the canonical representation of the one or more digital objects.

Example 256. At least one non-transitory computer-readable storage medium according to any of the foregoing examples, wherein the one or more digital objects comprise one or more text files, image files, video files, URLs, websites, portions of websites, or audio files.

Example 257. At least one non-transitory computer-readable storage medium according to any of the foregoing examples, wherein the EEI interface element is one of a frame within a webpage, an overlay, or a pop-up.

Example 258. At least one non-transitory computer-readable storage medium according to any of the foregoing examples, wherein generating the website comprises: inputting, to a trained website editing machine learning (ML) model, one or more second prompt data objects and a feature set generated based at least in part on the canonical representation, wherein the one or more second prompt data objects comprise a plurality of website building components and respective descriptions of the plurality of website building components; and responsive to confirming quality of an output of the trained website ML model, generating the website, based at least in part on the output of the trained website ML model.

Example 259. At least one non-transitory computer-readable storage medium according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 260. At least one non-transitory computer-readable storage medium according to any of the foregoing examples, wherein the trained website editing ML model is configured to generate output responsive to one or more prompt data objects.

Example 261. At least one non-transitory computer-readable storage medium according to any of the foregoing examples, wherein the one or more prompt data objects are generated based at least in part on features extracted from the one or more digital objects.

Example 262. At least one non-transitory computer-readable storage medium according to any of the foregoing examples, wherein the one or more prompt data objects are further generated based at least in part on a plurality of website building components and respective descriptions of the plurality of website building components.

Example 263. At least one non-transitory computer-readable storage medium according to any of the foregoing examples, wherein the one or more content objects comprise one or more of text or images.

Example 264. At least one non-transitory computer-readable storage medium according to any of the foregoing examples, wherein the images are received from an external image generation entity.

Example 265. A computer-implemented method, comprising: receiving, via one or more extraction engine interaction (EEI) interface elements integrated into a website building system accessed using a client computing entity associated with an editing user identifier, one or more digital objects; generating, using a trained extraction model, a canonical representation of the one or more digital objects, wherein the canonical representation comprises one or more of visual components, functional components, or component properties of the one or more digital objects; generating, based at least in part on the canonical representation of the one or more digital objects, a website comprising one or more webpages comprising one or more content objects selected in accordance with the canonical representation of the one or more digital objects; and transmitting the website to the client computing entity, wherein the website is configured for rendering via a display device of the client computing entity.

Example 266. A computer-implemented method according to the foregoing example, wherein the one or more digital objects are received via an application programming interface (API).

Example 267. A computer-implemented method according to any of the foregoing examples, wherein the trained extraction model applies feature extraction to generate the canonical representation of the one or more digital objects.

Example 268. A computer-implemented method according to any of the foregoing examples, wherein the one or more digital objects comprise one or more text files, image files, video files, URLs, websites, portions of websites, or audio files.

Example 269. A computer-implemented method according to any of the foregoing examples, wherein the EEI interface element is one of a frame within a webpage, an overlay, or a pop-up.

Example 270. A computer-implemented method according to any of the foregoing examples, wherein generating the website comprises: inputting, to a trained website editing machine learning (ML) model, one or more second prompt data objects and a feature set generated based at least in part on the canonical representation, wherein the one or more second prompt data objects comprise a plurality of website building components and respective descriptions of the plurality of website building components; and responsive to confirming quality of an output of the trained website ML model, generating the website, based at least in part on the output of the trained website ML model.

Example 271. A computer-implemented method according to any of the foregoing examples, wherein the trained website editing ML model comprises one or more of a large language model (LLM) or generative AI (GAI) model and is trained using a corpus of historical website editing interaction data associated with a plurality of editing user identifiers.

Example 272. A computer-implemented method according to any of the foregoing examples, wherein the trained website editing ML model is configured to generate output responsive to one or more prompt data objects.

Example 273. A computer-implemented method according to any of the foregoing examples, wherein the one or more prompt data objects are generated based at least in part on features extracted from the one or more digital objects.

Example 274. A computer-implemented method according to any of the foregoing examples, wherein the one or more prompt data objects are further generated based at least in part on a plurality of website building components and respective descriptions of the plurality of website building components.

Example 275. A computer-implemented method according to any of the foregoing examples, wherein the one or more content objects comprise one or more of text or images.

Example 276. A computer-implemented method according to any of the foregoing examples, wherein the images are received from an external image generation entity.

Example 278. An apparatus comprising one or more processors and at least one non-transitory computer-readable storage medium comprising instructions that, when executed by the one or more processors, cause the apparatus to: receive one or more digital objects comprising one or more documents or files; extract, using a trained extraction model, components and properties of the one or more digital objects; generate, based at least in part on the components and properties and using the trained extraction model, a canonical representation of the one or more digital objects; generate, based at least in part on the canonical representation and using one of the trained extraction model or a trained website editing machine learning (ML) model, a feature set; input, to the trained website editing ML model, one or more second prompt data objects and the feature set; perform one or more quality assurance operations on an output of the trained website editing ML model; generate, based at least in part on the output of the trained website ML model, a website comprising one or more webpages each comprising one or more content objects selected in accordance with the canonical representation of the one or more digital objects; and transmit the website to the client computing entity, wherein the website is configured for rendering via a display device of the client computing entity.

Example 279. At least one non-transitory computer-readable storage medium comprising instructions that, when executed by one or more processors, cause the one or more processors to: receive one or more digital objects comprising one or more documents or files; extract, using a trained extraction model, components and properties of the one or more digital objects; generate, based at least in part on the components and properties and using the trained extraction model, a canonical representation of the one or more digital objects; generate, based at least in part on the canonical representation and using one of the trained extraction model or a trained website editing machine learning (ML) model, a feature set; input, to the trained website editing ML model, one or more second prompt data objects and the feature set; perform one or more quality assurance operations on an output of the trained website editing ML model; generate, based at least in part on the output of the trained website ML model, a website comprising one or more webpages each comprising one or more content objects selected in accordance with the canonical representation of the one or more digital objects; and transmit the website to the client computing entity, wherein the website is configured for rendering via a display device of the client computing entity.

Example 280. A computer-implemented method, comprising: receiving one or more digital objects comprising one or more documents or files; extracting, using a trained extraction model, components and properties of the one or more digital objects; generating, based at least in part on the components and properties and using the trained extraction model, a canonical representation of the one or more digital objects; generating, based at least in part on the canonical representation and using one of the trained extraction model or a trained website editing machine learning (ML) model, a feature set; inputting, to the trained website editing ML model, one or more second prompt data objects and the feature set; performing one or more quality assurance operations on an output of the trained website editing ML model; generating, based at least in part on the output of the trained website ML model, a website comprising one or more webpages each comprising one or more content objects selected in accordance with the canonical representation of the one or more digital objects; and transmitting the website to the client computing entity, wherein the website is configured for rendering via a display device of the client computing entity.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims.

1. An apparatus comprising one or more processors and at least one non-transitory computer-readable storage medium comprising instructions that, when executed by the one or more processors, cause the apparatus to:
receive, via a template selection interface element integrated into a website building system accessed using a client computing entity associated with an editing user identifier, a template selection representative of a first template;
receive, via one or more model interaction (MI) interface elements integrated into the website building system accessed using the client computing entity associated with the editing user identifier, a natural language content object and one or more content selections;
input, to a trained website editing machine learning (ML) model, one or more prompt data objects, the natural language content object, the one or more content selections, one or more website editing data objects, and corresponding descriptions of the one or more website editing data objects;
generate, using output from the trained website editing ML model generated responsive to the one or more prompt data objects, a second template representing the first template modified with one or more new content objects generated based at least in part on the natural language content object, the one or more content selections, and the one or more website editing data objects; and
transmit the second template to the client computing entity, wherein the second template is configured for rendering via a display device of the client computing entity.

2. The apparatus of claim 1, wherein the template selection is received via an application programming interface (API) and the second template is transmitted via the API.

3. The apparatus of claim 1, wherein the one or more website editing data objects comprise one or more website building components.

4. The apparatus of claim 1, wherein the natural language content object is processed prior to being included with the one or more prompt data objects.

5. The apparatus of claim 1, wherein the one or more content selections comprise a business type and a business name.

6. The apparatus of claim 1, wherein the one or more MI interface elements comprise an overlay, a frame, or a pop-up interface element within a website.

7. The apparatus of claim 1, wherein the template selection interface element comprises a plurality of templates for selection.

8. The apparatus of claim 1, wherein the trained website editing ML model comprises one or more of a large language model (LLM) or generative AI (GAI) model and is trained using a corpus of historical website editing interaction data associated with a plurality of editing user identifiers.

9. The apparatus of claim 1, wherein the one or more prompt data objects are generated based at least in part on a content outline associated with the website and comprising logical positioning of components within webpages of the website.

10. The apparatus of claim 1, wherein the one or more new content objects comprise one or more of text or images.

11. The apparatus of claim 10, wherein the images are received from an external image generation entity.

12. The apparatus of claim 1, wherein the at least one non-transitory computer-readable storage medium comprises instructions that, when executed by the one or more processors, further cause the apparatus to:
generate an input map data structure of the first template; and
input the input map data structure to the trained website editing ML model.

13. The apparatus of claim 1, wherein the one or more prompt data objects comprise a plurality of sections and a corresponding natural language description of sections of the plurality of sections.

14. The apparatus of claim 1, wherein the at least one non-transitory computer-readable storage medium comprises instructions that, when executed by the one or more processors, further cause the apparatus to:
perform quality assurance operations prior to transmitting the second template to the client computing entity.

15. The apparatus of claim 14, wherein the quality assurance operations comprise confirming output from the trained website editing ML model conforms to a format in accordance with the first template.

16. The apparatus of claim 15, wherein the quality assurance operations further comprise verifying content in sections of the first template meet one or more length thresholds.

17. The apparatus of claim 15, wherein the quality assurance operations comprise generating one or more second prompt data objects to obtain corrected output from the trained website editing ML model.

18. At least one non-transitory computer-readable storage medium comprising instructions that, when executed by one or more processors, cause the one or more processors to:
receive, via a template selection interface element integrated into a website building system accessed using a client computing entity associated with an editing user identifier, a template selection representative of a first template;
receive, via one or more model interaction (MI) interface elements integrated into the website building system accessed using the client computing entity associated with the editing user identifier, a natural language content object and one or more content selections;
input, to a trained website editing machine learning (ML) model, one or more prompt data objects, the natural language content object, the one or more content selections, one or more website editing data objects, and corresponding descriptions of the one or more website editing data objects;
generate, using output from the trained website editing ML model generated responsive to the one or more prompt data objects, a second template representing the first template modified with one or more new content objects generated based at least in part on the natural language content object, the one or more content selections, and the one or more website editing data objects; and
transmit the second template to the client computing entity, wherein the second template is configured for rendering via a display device of the client computing entity.

19-34. (canceled)

35. A computer-implemented method, comprising:
receiving, via a template selection interface element integrated into a website building system accessed using a client computing entity associated with an editing user identifier, a template selection representative of a first template;
receiving, via one or more model interaction (MI) interface elements integrated into the website building system accessed using the client computing entity associated with the editing user identifier, a natural language content object and one or more content selections;
inputting, to a trained website editing machine learning (ML) model, one or more prompt data objects, the natural language content object, the one or more content selections, one or more website editing data objects, and corresponding descriptions of the one or more website editing data objects;
generating, using output from the trained website editing ML model generated responsive to the one or more prompt data objects, a second template representing the first template modified with one or more new content objects generated based at least in part on the natural language content object, the one or more content selections, and the one or more website editing data objects; and
transmitting the second template to the client computing entity, wherein the second template is configured for rendering via a display device of the client computing entity.

36-51. (canceled)

52. An apparatus comprising one or more processors and at least one non-transitory computer-readable storage medium comprising instructions that, when executed by the one or more processors, cause the apparatus to:
receive a template selection, a natural language content object, and one or more content selections;
generate, based at least in part on the template selection and temporary content of the template selection, an input map data structure;
input, to a trained website editing machine learning (ML) model, one or more prompt data objects, the input map data structure, and website editing data;
obtain, from the trained website editing ML model, an output map data structure and one or more new content objects;
perform one or more quality assurance operations based at least in part on the output map data structure and the one or more new content objects;
generate a second template by replacing the temporary content of the template selection with the one or more new content objects; and
transmit the second template to the client computing entity, wherein the second template is configured for rendering via a display device of the client computing entity.

53-280. (canceled)
